(19) United States
(12) Patent Application Publication
(10) Pub. No.: US 2018/0326834 A1
(43) Pub. Date: Nov. 15, 2018

(54) COMPOUND SPLIT HYBRID ELECTRIC POWERTRAIN CONFIGURATIONS WITH A BALL VARIATOR CONTINUOUSLY VARIABLE TRANSMISSION WITH ONE OR MORE MODES

(71) Applicant: DANA LIMITED, MAUMEE, OH (US)

(72) Inventor: KRISHNA KUMAR, HOLLAND, OH (US)

(73) Assignee: DANA LIMITED, MAUMEE, OH (US)

(21) Appl. No.: 15/774,625

(22) PCT Filed: Nov. 10, 2016
(86) PCT No.: PCT/US16/61339

§ 371 Date: May 9, 2018

Related U.S. Application Data
(60) Provisional application No. 62/254,544, filed on Nov. 12, 2015.
(60) Provisional application No. 62/280,564, filed on Jan. 19, 2016.
(60) Provisional application No. 62/320,118, filed on Apr. 8, 2016.

(51) Int. Cl. B60K 6/543; F16H 15/52; B60K 6/48; B60W 10/08; B60W 10/06; F16H 37/08

(52) U.S. Cl. CPC B60K 6/543; F16H 15/52; B60K 6/48; B60K 6/547; B60W 10/06; F16H 37/086; F16H 37/0846; B60W 10/08

(57) ABSTRACT

Regular torque split planetary gear trains for automotive hybrid powertrains are limited by the fixed ratio of the planetary gear train. A powertrain incorporating a continuously variable transmission using a torque split with variable ratios enables the powertrain to use the ideal operating lines (IOL) of the engine, electric motor-generator along with the high voltage battery charge/discharge paths, depending upon the mode of operation (charge sustain or charge deplete modes) of the hybrid powertrain. A powertrain further equipped with a hybrid supervisory controller that chooses the torque split and path of highest efficiency from engine to wheel, optionally operate at the best potential overall efficiency point in any mode and also provide torque variability, thereby leading to the best combination of powertrain performance and fuel efficiency. Embodiments of powertrain configurations that optionally improve the efficiency of hybrid vehicles are discussed herein.

### CROSS-REFERENCE

The present application claims the benefit of U.S. Provisional Application No. 62/254,544, filed Nov. 12, 2015, and U.S. Provisional Application No. 62/280,564, filed Jan. 19, 2016, and U.S. Provisional Application No. 62/320,118, filed Apr. 8, 2016, all of which are incorporated herein by reference in their entireties.

### BACKGROUND OF THE INVENTION

Hybrid vehicles are enjoying increased popularity and acceptance due in large part to the cost of fuel for internal combustion engine vehicles. Such hybrid vehicles include both an internal combustion engine as well as an electric motor to propel the vehicle.

### SUMMARY OF THE INVENTION

In current designs for both consuming as well as storing electrical energy, the rotary shaft from a combination electric motor/generator is coupled by a gear train or planetary gear set to the main shaft of an internal combustion engine. As such, the rotary shaft for the electric motor/generator unit rotates in unison with the internal combustion engine main shaft at the fixed gear ratio of the hybrid vehicle design. These hybrid vehicle designs, however, have encountered several disadvantages. One disadvantage is that, since the ratio between the electric motor/generator rotary shaft and the internal combustion engine main shaft is fixed, e.g. 3 to 1, the electric motor/generator is rotatably driven at high speeds during a high speed revolution of the internal combustion engine. For example, in the situations where the ratio between the electric motor/generator rotary shaft and the internal combustion engine main shaft is 3 to 1; if the internal combustion engine is driven at high revolutions per minute of, e.g. 5,000 rpm, the electric motor/generator unit is driven at a rotation three times that amount, or 15,000 rpm. Such high speed revolution of the electric motor/generator thus necessitates the use of expensive components, e.g., bearings and brushes, to be employed to prevent damage to the electric motor/generator during such high speed operation.

A still further disadvantage of these hybrid vehicles is that the electric motor/generator unit achieves its most efficient operation, both in the sense of generating electricity and also providing additional power to the main shaft of the internal combustion engine, only within a relatively narrow range of revolutions per minute of the motor/generator unit. However, since the previously known hybrid vehicles utilized a fixed ratio between the motor/generator unit and the internal combustion engine main shaft, the motor/generator unit oftentimes operates outside its optimal speed range. As such, the overall hybrid vehicle operates at less than optimal efficiency. Therefore, there is a need for powertrain configurations that will improve the efficiency of hybrid vehicles.

Provided herein is a hybrid powertrain comprising a first rotatable shaft operably coupleable to a source of rotational power; a second rotatable shaft aligned substantially coaxial to the first rotatable shaft, the first rotatable shaft and the second rotatable shaft forming a main axis; a third rotatable shaft aligned substantially parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; wherein the second traction ring is operably coupled to the third rotatable shaft; wherein the sun assembly is coupled to the second rotatable shaft; a planetary gearset having a planet carrier, a sun gear, and a ring gear, the planetary gearset coaxial with the third rotatable shaft, the third rotatable shaft coupled to the planet carrier; a first motor-generator positioned coaxially with the third rotatable shaft, the first motor/generator operably coupled to the sun gear; a second motor-generator positioned coaxially with the third rotatable shaft, the second motor-generator coupled to the ring gear; a first clutch operably coupled to the first rotatable shaft, the first clutch coupled to the first traction ring; a second clutch arranged coaxially with the third rotatable shaft, the second clutch coupled to the first motor-generator; and a brake clutch operably coupled to the carrier assembly. In some embodiments of the hybrid powertrain, a gear set is configured to couple the second traction ring to the third rotatable shaft. In some embodiments of the hybrid powertrain, a chain is configured to couple the second rotatable shaft to the second clutch. In some embodiments of the hybrid powertrain, a first inverter is in electrical communication with the first motor-generator. In some embodiments of the hybrid powertrain, a second inverter is in electrical communication with the second motor-generator. In some embodiments of the hybrid powertrain, a battery is in electrical communication with the first inverter and the second inverter. In some embodiments of the hybrid powertrain, a step gear connection is configured to couple the second rotatable shaft to the second clutch. In some embodiments of the hybrid powertrain, the second clutch is configured to selectively engage the sun assembly and the second traction ring.

Provided herein is a hybrid powertrain comprising a first rotatable shaft operably coupleable to a source of rotational power; a second rotatable shaft coaxial to the first rotatable shaft, the first rotatable shaft and the second rotatable shaft forming a main axis; a third rotatable shaft parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; wherein the second traction ring is operably coupled to the third rotatable shaft; wherein the sun assembly is coupled to the second rotatable shaft; a planetary gearset having a planet carrier, a sun gear, and a ring gear, the planetary gearset coaxial with the third rotatable shaft, the third rotatable shaft coupled to the planet carrier; a first motor-generator positioned coaxially with the third rotatable shaft, the first motor/generator operably coupled to the sun gear; a second motor-generator positioned coaxially with the third rotatable shaft, the second motor-generator coupled to the ring gear; a first clutch operably coupled to the first rotatable shaft, the first clutch coupled to the first traction ring; a second clutch arranged coaxially with the third rotatable shaft, the second clutch coupled to the first motor-generator; and a brake clutch operably coupled to the carrier assembly. In some embodiments of the hybrid powertrain, a gear set is configured to couple the second traction ring to the third rotatable shaft. In some embodiments of the hybrid powertrain, a chain is configured to couple the second rotatable shaft to the second clutch. In some embodiments of the hybrid powertrain, a first inverter is in electrical communication with the first motor-generator. In some embodiments of the hybrid powertrain, a second inverter is in electrical communication with the second motor-generator. In some embodiments of the hybrid powertrain, a battery is in electrical communication with the first inverter and the second inverter. In some embodiments of the hybrid powertrain, a step gear connection is configured to couple the second rotatable shaft to the second clutch. In some embodiments of the hybrid powertrain, the second clutch is configured to selectively engage the sun assembly and the second traction ring.

Provided herein is a hybrid powertrain comprising a first rotatable shaft operably coupleable to a source of rotational power; a second rotatable shaft aligned substantially coaxial to the first rotatable shaft, the first rotatable shaft and the second rotatable shaft forming a main axis; a third rotatable shaft aligned substantially parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; wherein the second traction ring is operably coupled to the third rotatable shaft; wherein the carrier assembly is coupled to the second rotatable shaft; a planetary gearset having a planet carrier, a sun gear, and a ring gear, the planetary gearset coaxial with the third rotatable shaft, the third rotatable shaft coupled to the planet carrier; a first motor-generator positioned coaxially with the third rotatable shaft, the first motor/generator operably coupled to the sun gear; a second motor-generator positioned coaxially with the third rotatable shaft, the second motor-generator coupled to the ring gear; a first clutch operably coupled to the first rotatable shaft, the first clutch coupled to the first traction ring; a second clutch coupled to the third rotatable shaft, the second clutch coupled to the first motor-generator; and a brake clutch operably coupled to the second rotatable shaft. In some embodiments of the hybrid powertrain, a gear set is configured to couple the second traction ring to the third rotatable shaft. In some embodiments of the hybrid powertrain, a chain connection is configured to couple the second rotatable shaft to the second clutch. In some embodiments of the hybrid powertrain, a step gear connection is configured to couple the second rotatable shaft to the second clutch. In some embodiments of the hybrid powertrain, a first inverter is in electrical communication with the first motor-generator. In some embodiments of the hybrid powertrain, a second inverter is in electrical communication with the second motor-generator. In some embodiments of the hybrid powertrain, a battery is in electrical communication with the first inverter and the second inverter. In some embodiments of the hybrid powertrain, the second clutch is configured to selectively engage the sun assembly and the second traction ring.

Provided herein is a hybrid powertrain comprising a first rotatable shaft operably coupleable to a source of rotational power; a second rotatable shaft coaxial to the first rotatable shaft, the first rotatable shaft and the second rotatable shaft forming a main axis; a third rotatable shaft parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; wherein the second traction ring is operably coupled to the third rotatable shaft; wherein the carrier assembly is coupled to the second rotatable shaft; a planetary gearset having a planet carrier, a sun gear, and a ring gear, the planetary gearset coaxial with the third rotatable shaft, the third rotatable shaft coupled to the planet carrier; a first motor-generator positioned coaxially with the third rotatable shaft, the first motor/generator operably coupled to the sun gear; a second motor-generator positioned coaxially with the third rotatable shaft, the second motor-generator coupled to the ring gear; a first clutch operably coupled to the first rotatable shaft, the first clutch coupled to the first traction ring; a second clutch coupled to the third rotatable shaft, the second clutch coupled to the first motor-generator; and a brake clutch operably coupled to the second rotatable shaft. In some embodiments of the hybrid powertrain, a gear set is configured to couple the second traction ring to the third rotatable shaft. In some embodiments of the hybrid powertrain, a chain connection is configured to couple the second rotatable shaft to the second clutch. In some embodiments of the hybrid powertrain, a step gear connection is configured to couple the second rotatable shaft to the second clutch. In some embodiments of the hybrid powertrain, a first inverter is in electrical communication with the first motor-generator. In some embodiments of the hybrid powertrain, a second inverter is in electrical communication with the second motor-generator. In some embodiments of the hybrid powertrain, a battery is in electrical communication with the first inverter and the second inverter. In some embodiments of the hybrid powertrain, the second clutch is configured to selectively engage the sun assembly and the second traction ring.

Provided herein is a hybrid powertrain comprising a first rotatable shaft operably coupleable to a source of rotational power; a second rotatable shaft aligned substantially coaxial to the first rotatable shaft, the first rotatable shaft and the second rotatable shaft forming a main axis; a third rotatable shaft aligned substantially parallel to the main axis; a fourth rotatable shaft aligned coaxially with the third rotatable shaft; a fifth rotatable shaft aligned substantially parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the third rotatable shaft; wherein the first traction ring is operably coupled to the third rotatable shaft; wherein the sun assembly is coupled to the fourth rotatable shaft; a planetary gearset having a planet carrier, a sun gear, and a ring gear, the planetary gearset coaxial with the second rotatable shaft, the second rotatable shaft coupled to the sun gear; a first motor-generator positioned coaxially with the second rotatable shaft; a second motor-generator positioned coaxially with the fifth rotatable shaft, the second motor-generator operably coupled to the second traction ring; a first clutch operably coupled to the first rotatable shaft, the first clutch coupled to the ring gear; a second clutch coupled to the fourth rotatable shaft, the second clutch operably coupled to the first motor-generator; and a brake clutch operably coupled to the carrier assembly. In some embodiments of the hybrid powertrain, a first gear set is configured to couple the planet carrier to the third rotatable shaft. In some embodiments of the hybrid powertrain, a second gear set is configured to couple the first motor-generator to the second clutch. In some embodiments of the hybrid powertrain, a third gear set is configured to couple the second traction ring to the fifth rotatable shaft. In some embodiments of the hybrid powertrain, a first inverter is in electrical communication with the first motor-generator. In some embodiments of the hybrid powertrain, a second inverter is in electrical communication with the second motor-generator. In some embodiments of the hybrid powertrain, a battery is in electrical communication with the first inverter and the second inverter. In some embodiments of the hybrid powertrain, a final drive gear is operably coupled to the second motor-generator.

Provided herein is a hybrid powertrain comprising a first rotatable shaft operably coupleable to a source of rotational power; a second rotatable shaft coaxial to the first rotatable shaft, the first rotatable shaft and the second rotatable shaft forming a main axis; a third rotatable shaft parallel to the main axis; a fourth rotatable shaft coaxial with the third rotatable shaft; a fifth rotatable shaft parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the third rotatable shaft; wherein the first traction ring is operably coupled to the third rotatable shaft; wherein the sun assembly is coupled to the fourth rotatable shaft; a planetary gearset having a planet carrier, a sun gear, and a ring gear, the planetary gearset coaxial with the second rotatable shaft, the second rotatable shaft coupled to the sun gear; a first motor-generator positioned coaxially with the second rotatable shaft; a second motor-generator positioned coaxially with the fifth rotatable shaft, the second motor-generator operably coupled to the second traction ring; a first clutch operably coupled to the first rotatable shaft, the first clutch coupled to the ring gear; a second clutch coupled to the fourth rotatable shaft, the second clutch operably coupled to the first motor-generator; and a brake clutch operably coupled to the carrier assembly. In some embodiments of the hybrid powertrain, a first gear set is configured to couple the planet carrier to the third rotatable shaft. In some embodiments of the hybrid powertrain, a second gear set is configured to couple the first motor-generator to the second clutch. In some embodiments of the hybrid powertrain, a third gear set is configured to couple the second traction ring to the fifth rotatable shaft. In some embodiments of the hybrid powertrain, a first inverter is in electrical communication with the first motor-generator. In some embodiments of the hybrid powertrain, a second inverter is in electrical communication with the second motor-generator. In some embodiments of the hybrid powertrain, a battery is in electrical communication with the first inverter and the second inverter. In some embodiments of the hybrid powertrain, a final drive gear is operably coupled to the second motor-generator.

Provided herein is a hybrid powertrain comprising a first rotatable shaft operably coupleable to a source of rotational power; a second rotatable shaft aligned substantially coaxial to the first rotatable shaft, the first rotatable shaft and the second rotatable shaft forming a main axis; a third rotatable shaft aligned substantially parallel to the main axis; a fourth rotatable shaft aligned coaxially with the third rotatable shaft; a fifth rotatable shaft aligned substantially parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the third rotatable shaft; wherein the first traction ring is operably coupled to the third rotatable shaft; wherein the carrier assembly is coupled to the fourth rotatable shaft; a planetary gearset having a planet carrier, a sun gear, and a ring gear, the planetary gearset coaxial with the second rotatable shaft, the second rotatable shaft coupled to the sun gear; a first motor-generator positioned coaxially with the second rotatable shaft; a second motor-generator positioned coaxially with the fifth rotatable shaft, the second motor-generator operably coupled to the second traction ring; a first clutch operably coupled to the first rotatable shaft, the first clutch coupled to the ring gear; a second clutch coupled to the fourth rotatable shaft, the second clutch operably coupled to the first motor-generator; and a brake clutch operably coupled to the carrier assembly. In some embodiments of the hybrid powertrain, a first gear set is configured to couple the planet carrier to the third rotatable shaft. In some embodiments of the hybrid powertrain, a second gear set is configured to couple the second rotatable shaft to the second clutch. In some embodiments of the hybrid powertrain, a third gear set is configured to couple the second traction ring to the fifth rotatable shaft. In some embodiments of the hybrid powertrain, a first inverter is in electrical communication with the first motor-generator. In some embodiments of the hybrid powertrain, a second inverter is in electrical communication with the second motor-generator. In some embodiments of the hybrid powertrain, a battery is in electrical communication with the first inverter and the second inverter. In some embodiments of the hybrid powertrain, a final drive gear is operably coupled to the second motor-generator.

Provided herein is a hybrid powertrain comprising a first rotatable shaft operably coupleable to a source of rotational power; a second rotatable shaft coaxial to the first rotatable shaft, the first rotatable shaft and the second rotatable shaft forming a main axis; a third rotatable shaft parallel to the main axis; a fourth rotatable shaft coaxial with the third rotatable shaft; a fifth rotatable shaft parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the third rotatable shaft; wherein the first traction ring is operably coupled to the third rotatable shaft; wherein the carrier assembly is coupled to the fourth rotatable shaft; a planetary gearset having a planet carrier, a sun gear, and a ring gear, the planetary gearset coaxial with the second rotatable shaft, the second rotatable shaft coupled to the sun gear; a first motor-generator positioned coaxially with the second rotatable shaft; a second motor-generator positioned coaxially with the fifth rotatable shaft, the second motor-generator operably coupled to the second traction ring; a first clutch operably coupled to the first rotatable shaft, the first clutch coupled to the ring gear; a second clutch coupled to the fourth rotatable shaft, the second clutch operably coupled to the first motor-generator; and a brake clutch operably coupled to the carrier assembly. In some embodiments of the hybrid powertrain, a first gear set is configured to couple the planet carrier to the third rotatable shaft. In some embodiments of the hybrid powertrain, a second gear set is configured to couple the second rotatable shaft to the second clutch. In some embodiments of the hybrid powertrain, a third gear set is configured to couple the second traction ring to the fifth rotatable shaft. In some embodiments of the hybrid powertrain, a first inverter is in electrical communication with the first motor-generator. In some embodiments of the hybrid powertrain, a second inverter is in electrical communication with the second motor-generator. In some embodiments of the hybrid powertrain, a battery is in electrical communication with the first inverter and the second inverter. In some embodiments of the hybrid powertrain, a final drive gear is operably coupled to the second motor-generator.

Provided herein is a hybrid powertrain comprising a first rotatable shaft operably coupleable to a source of rotational power; a second rotatable shaft aligned substantially coaxial to the first rotatable shaft, the first rotatable shaft and the second rotatable shaft forming a main axis; a third rotatable shaft aligned substantially parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; wherein the second traction ring is operably coupled to the third rotatable shaft; wherein the sun assembly is coupled to the second rotatable shaft; a first motor-generator positioned coaxially with the second rotatable shaft; a second motor-generator positioned coaxially with the third rotatable shaft; a first clutch operably coupled to the first rotatable shaft, the first clutch coupled to the first traction ring; a second clutch coupled to the second rotatable shaft, the second clutch coupled to the first motor-generator; and a first brake clutch operably coupled to the carrier assembly. In some embodiments of the hybrid powertrain, a gear set configured is to couple the second traction ring to the third rotatable shaft. In some embodiments of the hybrid powertrain, a first inverter is in electrical communication with the first motor-generator. In some embodiments of the hybrid powertrain, a second inverter is in electrical communication with the second motor-generator. In some embodiments of the hybrid powertrain, a battery is in electrical communication with the first inverter and the second inverter. In some embodiments of the hybrid powertrain, a final drive gear is operably coupled to the second motor-generator. In some embodiments of the hybrid powertrain, a one-way clutch is configured to couple the first traction ring and the carrier assembly. In some embodiments of the hybrid powertrain, the second clutch is a two position clutch configured to selectively couple to the carrier assembly and the sun assembly to the second rotatable shaft. In some embodiments of the hybrid powertrain, a second brake operably coupled to the second rotatable shaft. In some embodiments of the hybrid powertrain, a one-way clutch configured to couple the first traction ring to the sun assembly. In some embodiments of the hybrid powertrain, a one-way clutch is configured to couple the first traction ring to the carrier assembly. In some embodiments of the hybrid powertrain, a one-way clutch is a one-way clutch configured to couple the first traction ring to the sun assembly.

Provided herein is a hybrid powertrain comprising a first rotatable shaft operably coupleable to a source of rotational power; a second rotatable shaft coaxial to the first rotatable shaft, the first rotatable shaft and the second rotatable shaft forming a main axis; a third rotatable shaft parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; wherein the second traction ring is operably coupled to the third rotatable shaft; wherein the sun assembly is coupled to the second rotatable shaft; a first motor-generator positioned coaxially with the second rotatable shaft; a second motor-generator positioned coaxially with the third rotatable shaft; a first clutch operably coupled to the first rotatable shaft, the first clutch coupled to the first traction ring; a second clutch coupled to the second rotatable shaft, the second clutch coupled to the first motor-generator; and a first brake clutch operably coupled to the carrier assembly. In some embodiments of the hybrid powertrain, a gear set configured is to couple the second traction ring to the third rotatable shaft. In some embodiments of the hybrid powertrain, a first inverter is in electrical communication with the first motor-generator. In some embodiments of the hybrid powertrain, a second inverter is in electrical communication with the second motor-generator. In some embodiments of the hybrid powertrain, a battery is in electrical communication with the first inverter and the second inverter. In some embodiments of the hybrid powertrain, a final drive gear is operably coupled to the second motor-generator. In some embodiments of the hybrid powertrain, a one-way clutch is configured to couple the first traction ring and the carrier assembly. In some embodiments of the hybrid powertrain, the second clutch is a two position clutch configured to selectively couple to the carrier assembly and the sun assembly to the second rotatable shaft. In some embodiments of the hybrid powertrain, a second brake operably coupled to the second rotatable shaft. In some embodiments of the hybrid powertrain, a one-way clutch configured to couple the first traction ring to the sun assembly. In some embodiments of the hybrid powertrain, a one-way clutch is configured to couple the first traction ring to the carrier assembly. In some embodiments of the hybrid powertrain, a one-way clutch is a one-way clutch configured to couple the first traction ring to the sun assembly.

Provided herein is a hybrid powertrain comprising: a first rotatable shaft operably coupleable to a source of rotational power, the first rotatable shaft forming a main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; a planetary gearset having a planet carrier, a sun gear, and a ring gear, the planetary gearset coaxial with the main axis; wherein the second traction ring is operably coupled to the sun gear; a first motor-generator positioned coaxially with the main axis, the first motor/generator operably coupled to the planet carrier; a second motor-generator positioned coaxially with the main axis, the second motor-generator coupled to the ring gear; a first clutch operably coupled to the first rotatable shaft, the first clutch coupled to the first traction ring; and a brake clutch operably coupled to the carrier assembly. In some embodiments of the hybrid powertrain, the brake clutch is configured to selectively couple the carrier assembly to a grounded member. In some embodiments of the hybrid powertrain, a first mode of operation corresponds to a disengaged position of the brake clutch. In some embodiments of the hybrid powertrain, a second mode of operation corresponds to an engaged position of the brake clutch.

Provided herein is a hybrid powertrain comprising: a first rotatable shaft operably coupleable to a source of rotational power, the first rotatable shaft forming a main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; a planetary gearset having a planet carrier, a sun gear, and a ring gear, the planetary gearset coaxial with the main axis; wherein the carrier assembly is operably coupled to the sun gear; a first motor-generator positioned coaxially with the main axis, the first motor/generator operably coupled to the planet carrier; a second motor-generator positioned coaxially with the main axis, the second motor-generator coupled to the ring gear; a first clutch operably coupled to the first rotatable shaft, the first clutch coupled to the first traction ring; and a brake clutch operably coupled to the second traction ring. In some embodiments of the hybrid powertrain, the brake clutch is configured to selectively couple the carrier assembly to a grounded member. In some embodiments of the hybrid powertrain, a first mode of operation corresponds to a disengaged position of the brake clutch. In some embodiments of the hybrid powertrain, a second mode of operation corresponds to an engaged position of the brake clutch.

Provided herein is a hybrid powertrain comprising: a first rotatable shaft operably coupleable to a source of rotational power, the first rotatable shaft forming a main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; a planetary gearset having a planet carrier, a sun gear, and a ring gear, the planetary gearset coaxial with the main axis; wherein the carrier assembly is operably coupled to the sun gear; a first motor-generator positioned coaxially with the main axis, the first motor/generator operably coupled to the planet carrier; a second motor-generator positioned coaxially with the main axis, the second motor-generator coupled to the ring gear; a first clutch operably coupled to the first rotatable shaft, the first clutch coupled to the first traction ring; a second clutch operably coupled to the sun gear; a first brake clutch operably coupled to the second traction ring; and a second brake clutch operably coupled to the carrier assembly. In some embodiments of the hybrid powertrain, the second clutch is configured to selectively engage the second traction ring and the carrier assembly.

Provided herein is any configuration of hybrid powertrain described herein, wherein the variator comprises a traction fluid.

Provided herein is a vehicle comprising any configuration of hybrid powertrain described herein.

Provided herein is a method comprising providing a hybrid powertrain of any of the configurations described herein.

Provided herein is a method of providing a vehicle comprising any configuration of hybrid powertrain described herein.

Provided herein is a hybrid powertrain comprising: a first rotatable shaft operably coupleable to a source of rotational power, the first rotatable shaft forming a main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; a first motor-generator positioned coaxially with the main axis, the first motor/generator operably coupled to the sun assembly; a second rotatable shaft aligned substantially parallel to the main axis; a second motor-generator positioned coaxially with the second rotatable shaft, the second motor-generator operably coupled to the second traction ring; a first clutch operably coupled to the first motor-generator; a second clutch operably coupled to the second motor-generator; a final drive gear having a first gear, a second gear, and a third gear; wherein the first clutch is operably coupled to the first gear, the second clutch is operably coupled to the second gear; and a brake clutch operably coupled to the carrier assembly.

Provided herein is a hybrid powertrain comprising: a first rotatable shaft operably coupleable to a source of rotational power, the first rotatable shaft forming a main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; a first motor-generator positioned coaxially with the main axis, the first motor/generator operably coupled to the sun assembly; a second rotatable shaft parallel to the main axis; a second motor-generator positioned coaxially with the second rotatable shaft, the second motor-generator operably coupled to the second traction ring; a first clutch operably coupled to the first motor-generator; a second clutch operably coupled to the second motor-generator; a final drive gear having a first gear, a second gear, and a third gear; wherein the first clutch is operably coupled to the first gear, the second clutch is operably coupled to the second gear; and a brake clutch operably coupled to the carrier assembly.

Provided herein is a hybrid powertrain comprising: a first rotatable shaft operably coupleable to a source of rotational power, the first rotatable shaft forming a main axis; a second rotatable shaft aligned substantially parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; a first gear set operably coupled to the first rotatable shaft and the second rotatable shaft; a second gear set operably coupled to the second traction ring and the second rotatable shaft; a first motor-generator positioned coaxially with the main axis, the first motor/generator operably coupled to the sun assembly; a second motor-generator positioned coaxially with the second rotatable shaft, the second motor-generator operably coupled to the second traction ring; a first clutch operably coupled to the source of rotational power and the first traction ring; a second clutch operably coupled to the second rotatable shaft, the second clutch arranged between the first gear set and the second gear set; a third clutch operably coupled to the first motor-generator; a fourth clutch operably coupled to the second motor-generator; a final drive gear having a first gear, a second gear, and a third gear; wherein the third clutch is operably coupled to the first gear, the fourth clutch is operably coupled to the second gear; and a brake clutch operably coupled to the carrier assembly.

Provided herein is a hybrid powertrain comprising: a first rotatable shaft operably coupleable to a source of rotational power, the first rotatable shaft forming a main axis; a second rotatable shaft parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; a first gear set operably coupled to the first rotatable shaft and the second rotatable shaft; a second gear set operably coupled to the second traction ring and the second rotatable shaft; a first motor-generator positioned coaxially with the main axis, the first motor/generator operably coupled to the sun assembly; a second motor-generator positioned coaxially with the second rotatable shaft, the second motor-generator operably coupled to the second traction ring; a first clutch operably coupled to the source of rotational power and the first traction ring; a second clutch operably coupled to the second rotatable shaft, the second clutch arranged between the first gear set and the second gear set; a third clutch operably coupled to the first motor-generator; a fourth clutch operably coupled to the second motor-generator; a final drive gear having a first gear, a second gear, and a third gear; wherein the third clutch is operably coupled to the first gear, the fourth clutch is operably coupled to the second gear; and a brake clutch operably coupled to the carrier assembly.

Provided herein is a hybrid powertrain comprising: a first rotatable shaft operably coupleable to a source of rotational power, the first rotatable shaft forming a main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; a planetary gear set having a ring gear, a planet carrier, and a sun gear; wherein the planetary gear set is coaxial with the main axis; a first motor-generator operably coupled to the planetary gear set; a second motor-generator operably coupled to the variator; a first clutch operably coupled to the first rotatable shaft and the planetary gear set; and a brake operably coupled to the carrier assembly. In some embodiments, the hybrid powertrain further comprises a second clutch operably coupled to the planetary gear set and the first traction ring. In some embodiments of the hybrid powertrain, the second motor-generator is operably coupled to the second traction ring. In some embodiments of the hybrid powertrain, the first clutch is coupled to the sun gear, the ring gear is coupled to the first traction ring, the first motor-generator is coupled to the planet carrier, and the second motor-generator is operably coupled to the second traction ring. In some embodiments of the hybrid powertrain, the first clutch is coupled to the sun gear, the ring gear is coupled to the first traction ring, the first motor-generator is coupled to the planet carrier, and the second motor-generator is operably coupled to the second traction ring. In some embodiments of the hybrid powertrain, the first clutch is coupled to the ring gear, the planet carrier is coupled to the second clutch, the first motor-generator is coupled to the sun gear, and the second motor-generator is operably coupled to the second traction ring. In some embodiments of the hybrid powertrain, the first clutch is coupled to the planet carrier, the second clutch is coupled to the ring gear, the first motor-generator is coupled to the sun gear, and the second motor-generator is operably coupled to the second traction ring. In some embodiments of the hybrid powertrain, the first clutch is coupled to the ring gear, the second clutch is coupled to the sun gear, the first motor-generator is coupled to the planet carrier, and the second motor-generator is operably coupled to the second traction ring. In some embodiments of the hybrid powertrain, the first clutch is coupled to the planet carrier, the second clutch is coupled to the sun gear, the first motor-generator is coupled to the ring gear, and the second motor-generator is operably coupled to the second traction ring.

Provided herein is a hybrid powertrain comprising: a first rotatable shaft operably coupleable to a source of rotational power, the first rotatable shaft forming a main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; a first motor-generator operably coupled to the variator assembly; a second motor-generator operably coupled to the second traction ring; a brake operably coupled to the carrier assembly; and a final drive assembly operably coupled to the first motor-generator. In some embodiments of the hybrid powertrain, the first motor-generator is coupled to the sun assembly. In some embodiments of the hybrid powertrain, the second motor-generator is coupled to the carrier assembly.

Provided herein is a hybrid powertrain comprising: a first rotatable shaft operably coupleable to a source of rotational power, the first rotatable shaft forming a main axis; a second rotatable shaft aligned substantially parallel to the first rotatable shaft; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis;

a first motor-generator coaxial with the second rotatable shaft; a second motor-generator operably coupled to the sun assembly; a first gear set operably coupled to the second traction ring and the second rotatable shaft; a first clutch operably coupled to the first traction ring and the source of rotational power; a second clutch operably coupled to the second motor-generator assembly; and a brake operably coupled to the carrier assembly. In some embodiments, the hybrid powertrain further comprises a final drive gear set operably coupled to the second clutch.

Provided herein is a hybrid powertrain comprising: a first rotatable shaft operably coupleable to a source of rotational power, the first rotatable shaft forming a main axis; a second rotatable shaft parallel to the first rotatable shaft; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; a first motor-generator coaxial with the second rotatable shaft; a second motor-generator operably coupled to the sun assembly; a first gear set operably coupled to the second traction ring and the second rotatable shaft; a first clutch operably coupled to the first traction ring and the source of rotational power; a second clutch operably coupled to the second motor-generator assembly; and a brake operably coupled to the carrier assembly. In some embodiments, the hybrid powertrain further comprises a final drive gear set operably coupled to the second clutch.

Provided herein is a hybrid powertrain comprising: a source of rotational power; a first planetary gear set having a first ring gear, a first planet carrier operably coupled to the source of rotational power, and a first sun gear; a variator assembly having a first traction ring and a second traction ring in contact with a plurality of traction planets, each traction planet having a tiltable axis of rotation, each traction planet supported in a carrier assembly, each traction planet in contact with a sun assembly; wherein the first traction ring is operably coupled to the first ring gear; a first motor-generator operably coupled to the first sun gear; a second planetary gear set having a second ring gear, a second planet carrier, and a second sun gear operably coupled to the second traction ring; a second motor-generator operably coupled to the second sun gear; a first clutch operably coupled to the first sun gear and the second ring gear; and a second clutch operably coupled to the second ring gear. In some embodiments of the hybrid powertrain, a first step gear is arranged to operably couple the first clutch to the first sun gear. In some embodiments of the hybrid powertrain, a second step gear is arranged to operably couple the second traction ring to the second sun gear. In some embodiments of the hybrid powertrain, the second planet carrier is configured to transmit a power output. In some embodiments of the hybrid powertrain, the carrier assembly is selectively grounded.

Provided herein is a hybrid powertrain comprising: a source of rotational power; a first planetary gear set having a first ring gear, a first planet carrier, and a first sun gear; a variator assembly having a first traction ring and a second traction ring in contact with a plurality of traction planets, each traction planet having a tiltable axis of rotation, each traction planet supported in a carrier assembly, each traction planet in contact with a sun assembly; wherein the first traction ring is operably coupled to the first ring gear and the source of rotational power; wherein the second traction ring is operably coupled to the first sun gear; a first motor-generator operably coupled to the second traction ring; a second planetary gear set having a second ring gear, a second planet carrier, and a second sun gear operably coupled to the first ring gear; a second motor-generator operably coupled to the second sun gear; a first clutch operably coupled to the first sun gear and the second ring gear; and a second clutch operably coupled to the second ring gear. In some embodiments of the hybrid powertrain, the first planet carrier is operably coupled to the second planet carrier.

Provided herein is a hybrid powertrain comprising: a source of rotational power; a first planetary gear set having a first ring gear, a first planet carrier, and a first sun gear; a variator assembly having a first traction ring and a second traction ring in contact with a plurality of traction planets, each traction planet having a tiltable axis of rotation, each traction planet supported in a carrier assembly, each traction planet in contact with a sun assembly; wherein the first traction ring is operably coupled to the first sun gear and the source of rotational power; wherein the second traction ring is operably coupled to the first ring gear; a first motor-generator operably coupled to the second traction ring; a second planetary gear set having a second ring gear, a second planet carrier, and a second sun gear operably coupled to the first ring gear; a second motor-generator operably coupled to the second sun gear; a first clutch operably coupled to the first sun gear and the second ring gear; and a second clutch operably coupled to the second ring gear. In some embodiments of the hybrid powertrain, the first planet carrier is operably coupled to the second planet carrier.

Provided herein is a hybrid powertrain comprising: a source of rotational power; a first planetary gear set having a first ring gear, a first planet carrier operably coupled to the source of rotational power, and a first sun gear; a variator assembly having a first traction ring and a second traction ring in contact with a plurality of traction planets, each traction planet having a tiltable axis of rotation, each traction planet supported in a carrier assembly, each traction planet in contact with a sun assembly; wherein the first traction ring is operably coupled to the first ring gear; wherein the second traction ring is operably coupled to the first sun gear; a first motor-generator operably coupled to the first sun gear; a second planetary gear set having a second ring gear, a second planet carrier, and a second sun gear operably coupled to the first traction ring; a second motor-generator operably coupled to the second sun gear; a first clutch operably coupled to the first sun gear and the second ring gear; and a second clutch operably coupled to the second ring gear. In some embodiments of the hybrid powertrain, a reverse clutch is operably coupled to the second sun gear and the sun assembly. In some embodiments of the hybrid powertrain, a reverse clutch is operably coupled to the second planet carrier and the sun assembly.

Provided herein is a hybrid powertrain comprising: a source of rotational power; a first planetary gear set having a first ring gear, a first planet carrier operably coupled to the source of rotational power, and a first sun gear; a variator assembly having a first traction ring and a second traction ring in contact with a plurality of traction planets, each traction planet having a tiltable axis of rotation, each traction planet supported in a carrier assembly, each traction planet in contact with a sun assembly; wherein the first traction ring is operably coupled to the first ring gear; wherein the second traction ring is operably coupled to the first sun gear; a first motor-generator operably coupled to the first sun gear; a second planetary gear set having a second ring gear, a second planet carrier, and a second sun gear operably coupled to the first traction ring; and a second motor-generator operably coupled to the second sun gear.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a side sectional view of a ball-type variator.

FIG. 2 is a plan view of a carrier member that is optionally used in the variator of FIG. 1.

FIG. 3 is an illustrative view of different tilt positions of the ball-type variator of FIG. 1.

FIG. 4 is a schematic diagram of a hybrid powerpath having a planetary gear system.

FIG. 5 is another schematic diagram of a hybrid powerpath having a planetary gear system.

FIG. 6 is another schematic diagram of a hybrid powerpath having a planetary gear system.

FIG. 7 is a schematic diagram of a hybrid powertrain having a ball planetary continuously variable transmission, two motor-generators, a clutch, and a brake.

FIG. 8 is another schematic diagram of a hybrid powertrain having a ball planetary continuously variable transmission, two motor-generators, a clutch, and a brake.

FIG. 9 is another schematic diagram of a hybrid powertrain having a ball planetary continuously variable transmission, two motor-generators, a clutch, and a brake.

FIG. 10 is another schematic diagram of a hybrid powertrain having a ball planetary continuously variable transmission, two motor-generators, a clutch, and a brake.

FIG. 11 is a schematic diagram of a hybrid powertrain having a ball planetary continuously variable transmission, two motor-generators, a brake, and a clutch.

FIG. 12 is another schematic diagram of a hybrid powertrain having a ball planetary continuously variable transmission, two motor-generators, and a one-way clutch.

FIG. 13 is another schematic diagram of a hybrid powertrain having a ball planetary continuously variable transmission, two motor-generators, a clutch, and a brake.

FIG. 14 is another schematic diagram of a hybrid powertrain having a ball planetary continuously variable transmission, two motor-generators, a clutch, and a brake.

FIG. 15 is another schematic diagram of a hybrid powertrain having a ball planetary continuously variable transmission, two motor-generators, and two brakes.

FIG. 16 is another schematic diagram of a hybrid powertrain having a ball planetary continuously variable transmission, two motor-generators, and a one-way clutch.

FIG. 17 is another schematic diagram of a hybrid powertrain having a ball planetary continuously variable transmission, two motor-generators, and a one-way clutch.

FIG. 18 is a schematic diagram of a hybrid powertrain having a ball planetary continuously variable transmission, two motor-generators.

FIG. 19 is another schematic diagram of a hybrid powertrain having a ball planetary continuously variable transmission, two motor-generators.

FIG. 20 is another schematic diagram of a hybrid powertrain having a ball planetary continuously variable transmission, two motor-generators.

FIG. 21 is another schematic diagram of a hybrid powertrain having a ball planetary continuously variable transmission, two motor-generators, two clutches, and a brake.

FIG. 22 is another schematic diagram of a hybrid powertrain having a ball planetary continuously variable transmission, two motor-generators, four clutches, and a brake.

FIG. 23 is another schematic diagram of a hybrid powertrain having a ball planetary continuously variable transmission, two motor-generators, a clutch, and a brake.

FIG. 24 is another schematic diagram of a hybrid powertrain having a ball planetary continuously variable transmission, two motor-generators, two clutches, and a brake.

FIG. 25 is another schematic diagram of a hybrid powertrain having a ball planetary continuously variable transmission, two motor-generators, two clutches, and a brake.

FIG. 26 is another schematic diagram of a hybrid powertrain having a ball planetary continuously variable transmission, two motor-generators, two clutches, and a brake.

FIG. 27 is another schematic diagram of a hybrid powertrain having a ball planetary continuously variable transmission, two motor-generators, two clutches, and a brake.

FIG. 28 is another schematic diagram of a hybrid powertrain having a ball planetary continuously variable transmission, two motor-generators, two clutches, and a brake.

FIG. 29 is a table depicting a hybrid powertrain configurations having a ball planetary continuously variable transmission and a fixed ratio planetary gear set.

FIG. 30 is a table depicting a number of hybrid powertrain configurations having a ball planetary continuously variable transmission and a fixed ratio planetary gear set.

FIG. 31 is another schematic diagram of a hybrid powertrain having a ball planetary continuously variable transmission and two motor-generators.

FIG. 32 is another schematic diagram of a hybrid powertrain having a ball planetary continuously variable transmission and two motor-generators.

FIG. 33 is another schematic diagram of a hybrid powertrain having a ball planetary continuously variable transmission, two motor-generators, two clutches, and a brake.

FIG. 34 is a schematic diagram of another hybrid powertrain having a ball planetary continuously variable transmission, two motor-generators, two clutches, and two planetary gear sets.

FIG. 35 is a lever diagram depicting the hybrid powertrain of FIG. 34.

FIG. 36 is a lever diagram depicting a hybrid powertrain having a ball planetary continuously variable transmission, two planetary gear sets, two motor-generators, and four clutches.

FIG. 37 is a lever diagram depicting an operating mode of the hybrid powertrain of FIG. 36.

FIG. 38 is a lever diagram depicting a hybrid powertrain having a ball planetary continuously variable transmission, two planetary gear sets, two motor-generators, and four clutches.

FIG. 39 is a lever diagram depicting an operating mode of the hybrid powertrain of FIG. 38.

FIG. 40 is a lever diagram depicting a hybrid powertrain having a ball planetary continuously variable transmission, two planetary gear sets, two motor-generators, and four clutches.

FIG. 41 is a lever diagram depicting an operating mode of the hybrid powertrain of FIG. 40.

FIG. 42 is a lever diagram depicting a hybrid powertrain having a ball planetary continuously variable transmission, two planetary gear sets, two motor-generators, and two clutches.

FIG. 43 is a lever diagram depicting another hybrid powertrain having a ball planetary continuously variable transmission, two planetary gear sets, two motor-generators, and two clutches.

FIG. 44 is a lever diagram depicting another hybrid powertrain having a ball planetary continuously variable transmission, two planetary gear sets, two motor-generators, and two clutches.

FIG. 45 is a lever diagram depicting yet another hybrid powertrain having a ball planetary continuously variable transmission, two planetary gear sets, two motor-generators, and two clutches.

FIG. 46 is a lever diagram depicting yet another hybrid powertrain having a ball planetary continuously variable transmission, two planetary gear sets, two motor-generators, and two clutches.

FIG. 47 is a lever diagram depicting a hybrid powertrain having a ball planetary continuously variable transmission, two planetary gear sets, two motor-generators, and three clutches.

FIG. 48 is a lever diagram depicting another hybrid powertrain having a ball planetary continuously variable transmission, two planetary gear sets, two motor-generators, and three clutches.

FIG. 49 is a lever diagram depicting another hybrid powertrain having a ball planetary continuously variable transmission, two planetary gear sets, and two motor-generators.

### DETAILED DESCRIPTION OF THE INVENTION

In current designs for both consuming as well as storing electrical energy, the rotary shaft from a combination electric motor/generator is coupled by a gear train or planetary gear set to the main shaft of an internal combustion engine. As such, the rotary shaft for the electric motor/generator unit rotates in unison with the internal combustion engine main shaft at the fixed gear ratio of the hybrid vehicle design. These hybrid vehicle designs, however, have encountered several disadvantages. One disadvantage is that, since the ratio between the electric motor/generator rotary shaft and the internal combustion engine main shaft is fixed, e.g. 3 to 1, the electric motor/generator is rotatably driven at high speeds during a high speed revolution of the internal combustion engine. For example, in the situations where the ratio between the electric motor/generator rotary shaft and the internal combustion engine main shaft is 3 to 1; if the internal combustion engine is driven at high revolutions per minute of, e.g. 5,000 rpm, the electric motor/generator unit is driven at a rotation three times that amount, or 15,000 rpm. Such high speed revolution of the electric motor/generator thus necessitates the use of expensive components, e.g., bearings and brushes, to be employed to prevent damage to the electric motor/generator during such high speed operation.

A still further disadvantage of these hybrid vehicles is that the electric motor/generator unit achieves its most efficient operation, both in the sense of generating electricity and also providing additional power to the main shaft of the internal combustion engine, only within a relatively narrow range of revolutions per minute of the motor/generator unit. However, since the previously known hybrid vehicles utilized a fixed ratio between the motor/generator unit and the internal combustion engine main shaft, the motor/generator unit oftentimes operates outside its optimal speed range. As such, the overall hybrid vehicle operates at less than optimal efficiency. Therefore, there is a need for powertrain configurations that will improve the efficiency of hybrid vehicles.

Therefore, this invention relates to powertrain configurations and architectures that are optionally used in hybrid vehicles. The powertrain and/or drivetrain configurations used a ball planetary style continuously variable transmission, such as the VariGlide®, in order to couple power sources used in a hybrid vehicle, for example, combustion engines (internal or external), motors, generators, batteries, and gearing.

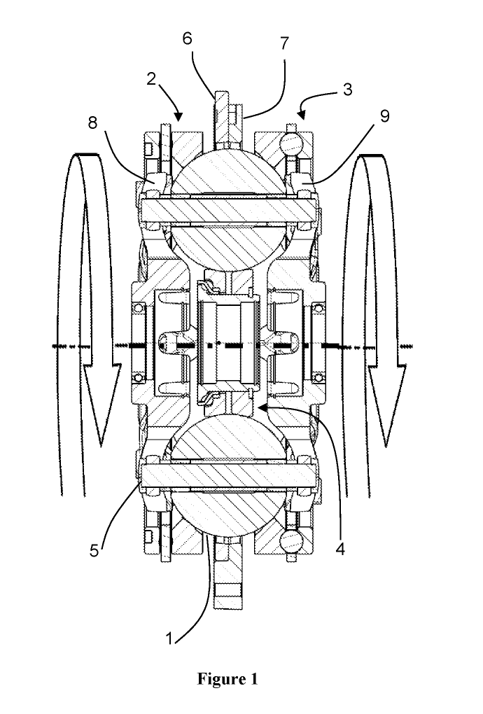

A typical ball planetary variator CVT design, such as that described in U.S. Pat. No. 8,066,614 and in U.S. Pat. No. 8,469,856, both incorporated herein by reference, represents a rolling traction drive system, transmitting forces between the input and output rolling surfaces through shearing of a thin fluid film. The technology is called Continuously Variable Planetary (CVP) due to its analogous operation to a planetary gear system. The system consists of an input disc (ring) driven by the power source, an output disc (ring) driving the CVP output, a set of balls fitted between these two discs and a central sun, as illustrated in FIG. 1. The balls are able to rotate around their own respective axle by the rotation of two carrier disks at each end of the set of ball axles. The system is also referred to as the Ball-Type Variator.

The preferred embodiments will now be described with reference to the accompanying figures, wherein like numerals refer to like elements throughout. The terminology used in the descriptions below is not to be interpreted in any limited or restrictive manner simply because it is used in conjunction with detailed descriptions of certain specific embodiments of the invention. Furthermore, embodiments of the invention optionally include several novel features, no single one of which is solely responsible for its desirable attributes or which is essential to practicing the inventions described.

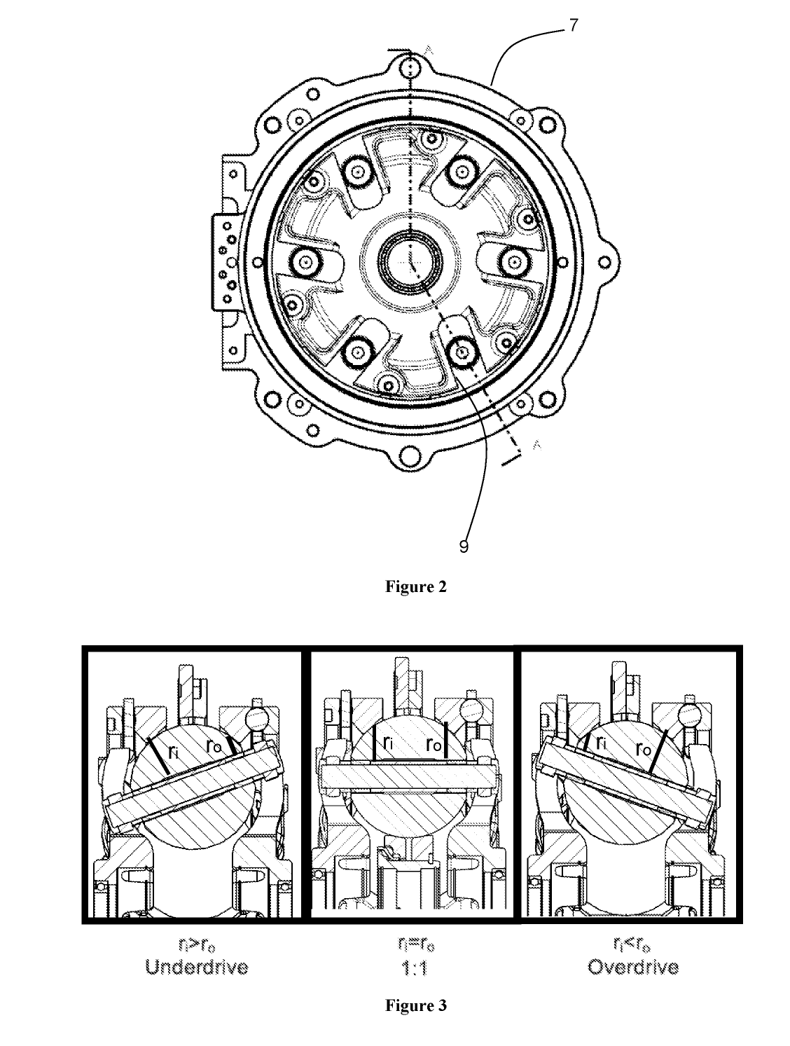

Provided herein are configurations of CVTs based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, comprises a number of balls (planets, spheres) 1, depending on the application, two ring (disc) assemblies with a conical surface contact with the balls, as first traction ring 2 and second traction ring 3, and an idler (sun) assembly 4 as shown on FIG. 1. Sometimes, the first traction ring 2 is referred to in illustrations and referred to in text by the label “R1”. The second traction ring 3 is referred to in illustrations and referred to in text by the label “R2”. The idler (sun) assembly is referred to in illustrations and referred to in text by the label “S”, and in some instances “S1” and “S2” denoting two elements in the sun assembly. The balls are mounted on tiltable axles 5, themselves held in a carrier (stator, cage) assembly having a first carrier member 6 operably coupled to a second carrier member 7 (FIG. 2). Sometimes, the carrier assembly is denoted in illustrations and referred to in text by the label “C”. These labels are collectively referred to as nodes (“R1”, “R2”, “S”, “C”). The first carrier member 6 optionally rotates with respect to the second carrier member 7, and vice versa. In some embodiments, the first carrier member 6 is optionally substantially fixed from rotation while the second carrier member 7 is configured to rotate with respect to the first carrier member, and vice versa. In some embodiments, the first carrier member 6 is optionally provided with a number of radial guide slots 8. The second carrier member 7 is optionally provided with a number of radially offset guide slots 9 (FIG. 2). The radial guide slots 8 and the radially offset guide slots 9 are adapted to guide the tiltable axles 5. The axle 5 is optionally adjusted to achieve a desired ratio of input speed to output speed during operation of the CVT. In some embodiments, adjustment of the axles 5 involves control of the position of the first and second carrier members to impart a tilting of the axles 5 and thereby adjusts the speed ratio of the variator. Other types of ball CVTs also exist, like the one produced by Milner, but are slightly different.

The working principle of such a CVP of FIG. 1 is shown on FIG. 3. The CVP itself works with a traction fluid. The lubricant between the ball and the conical rings acts as a solid at high pressure, transferring the power from the input ring, through the balls, to the output ring. By tilting the balls' axes, the ratio is changed between input and output. When the axis is horizontal the ratio is one, illustrated in FIG. 3, when the axis is tilted the distance between the axis and the contact point change, modifying the overall ratio. All the balls' axes are tilted at the same time with a mechanism included in the carrier and/or idler. Embodiments of the invention disclosed here are related to the control of a variator and/or a CVT using generally spherical planets each having a tiltable axis of rotation that is adjusted to achieve a desired ratio of input speed to output speed during operation. In some embodiments, adjustment of said axis of rotation involves angular misalignment of the planet axis in a first plane in order to achieve an angular adjustment of the planet axis in a second plane that is substantially perpendicular to the first plane, thereby adjusting the speed ratio of the variator. The angular misalignment in the first plane is referred to here as “skew”, “skew angle”, and/or “skew condition”. In some embodiments, a control system coordinates the use of a skew angle to generate forces between certain contacting components in the variator that will tilt the planet axis of rotation. The tilting of the planet axis of rotation adjusts the speed ratio of the variator.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling optionally take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, a control piston 123A and a control piston 123B) will be referred to collectively by a single label (for example, control pistons 123).

It should be noted that reference herein to “traction” does not exclude applications where the dominant or exclusive mode of power transfer is through “friction.” Without attempting to establish a categorical difference between traction and friction drives here, generally these are optionally understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction force which would be available at the interfaces of the contacting components and is the ratio of the maximum available drive torque per contact force. Typically, friction drives generally relate to transferring power between two elements by frictional forces between the elements. For the purposes of this disclosure, it should be understood that the CVTs described herein optionally operate in both tractive and frictional applications. For example, in the embodiment where a CVT is used for a bicycle application, the CVT optionally operates at times as a friction drive and at other times as a traction drive, depending on the torque and speed conditions present during operation.

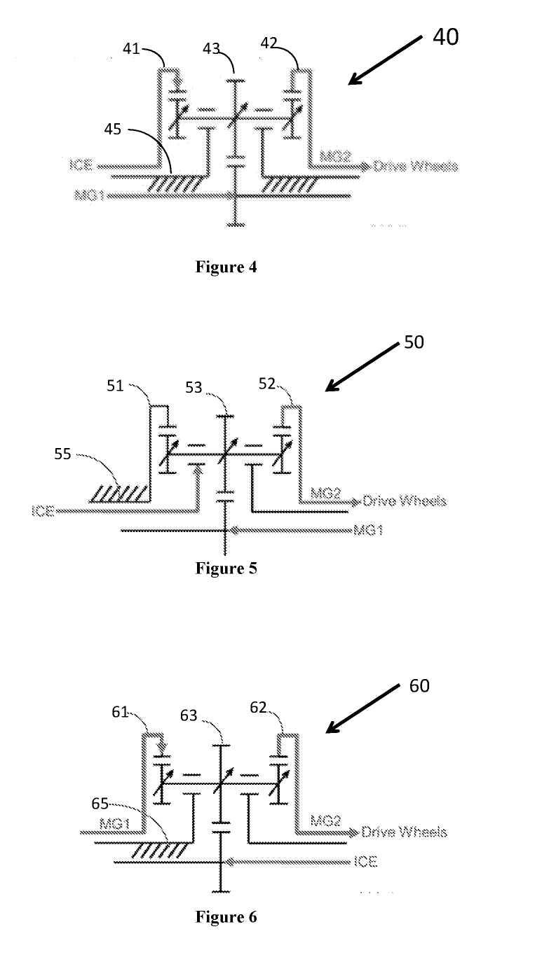

Referring now to FIG. 4, in some embodiments using a continuously variable CVP 100 as described previously in FIGS. 1-3, a hybrid powertrain architecture is shown with a fixed ratio planetary powertrain 40, comprising a first ring (R1) 41, a second ring (R2) 42, a sun (S) 43, and a carrier (C) 45, wherein an internal combustion engine (ICE) is coupled to a fixed carrier 45 planetary. A first motor/generator MG1 is configured to control speed/power. The first motor/generator MG1 in the embodiment of FIG. 4 is inside the CVP 100 cam drivers, sometimes referred to as axial force generators operably coupled to the first traction ring 41 and the second traction ring 43. In some embodiments, the first motor/generator MG1 operates at speeds as high as 30,000 rpm to 40,000 rpm. One of skill in the art will recognize that the first motor/generator, MG1, is optionally configured to be small in size for its relative power. A second motor/generator, MG2, is configured to control torque. The second motor/generator MG2 drive layout of FIG. 4 may not take advantage of the CVP 100 multiplication in some embodiments, although in some embodiments it may optionally do so.

Passing to FIG. 5, in some embodiments using a CVP 100 as described previously, a hybrid vehicle is shown with a fixed ratio planetary powertrain 50, comprising a first ring (R1) 51, a second ring (R2) 52, a sun (S) 53, and a carrier (C) 55, having an ICE arranged on a high inertia powerpath. The embodiment of FIG. 5 comprises a fixed carrier. In some embodiments, an infinitely variable transmission having a rotatable carrier is coupled to the ICE to enable reverse operation and vehicle launch. The first motor/generator, MG1, is configured to control speed/power. The second motor/generator, MG2, is configured to control torque. The ICE is configured to operate in a high inertia powerpath. The ICE is arranged to react inertias of the first motor/generator MG1 and the second motor/generator MG2 under driving conditions of the vehicle. In some embodiments, the ICE operates at high speeds similar to those speeds typical of a gas turbine. In some embodiments, a step up gear is coupled to the ICE to provide a high speed input to the system.

Turning now to FIG. 6, in some embodiments using a CVP, a hybrid vehicle is shown with a fixed ratio planetary powertrain 60, comprising a first ring (R1) 61, a second ring (R2) 62, a sun (S) 63, and a carrier (C) 65, having an ICE arranged on a high speed powerpath and configured to react with the first motor/generator, MG1, and the second motor/generator, MG2, during operation. The embodiment of FIG. 6 comprises a fixed carrier. The ICE is configured to operate in a high speed powerpath. The ICE is arranged to react the first motor/generator MG1 and the second motor/generator MG2 during driving conditions. The ICE can optionally be a very high speed input, such as a gas turbine, or the ICE is optionally coupled to a step up gear.

Embodiments disclosed herein are directed to hybrid vehicle powertrain architectures and/or configurations that incorporate a CVP as a power split system in place of a regular planetary leading to a continuously variable power split system where series, parallel or series-parallel, hybrid electric vehicle (HEV) or electric vehicle (EV) modes are optionally obtained. The core element of the power flow is a CVP, which functions in a first mode as a continuously variable planetary gear split differential with all four of its nodes (R1, R2, C, and S) being variable, and functions in a second mode as a mechanical continuously variable transmission. When the variator speed ratio is 1:1, the machine connected to R2 will receive a specific fraction of input torque. In overdrive or underdrive (speed ratio <1) the machine connected to R2 will receive a different fraction of input torque. In some applications, the amount of input torque delivered to R2 is greater than 100% and the system will be regenerative. It should be noted that hydro-mechanical components such as hydromotors, pumps, accumulators, among others, are optionally used in place of the electric machines indicated in the figures and accompanying textual description. Furthermore, it should be noted that embodiments of hybrid architectures disclosed herein incorporate a hybrid supervisory controller that chooses the path of highest efficiency from engine to wheel, leading to the creation of a hybrid powertrain that will operate at the best potential overall efficiency point in any mode and also provide torque variability, thereby leading to the optimal combination of powertrain performance and fuel efficiency. It should be understood that hybrid vehicles incorporating embodiments of the hybrid architectures disclosed herein optionally include a number of other powertrain components, such as, but not limited to, high-voltage battery pack with a battery management system or ultracapacitor, on-board charger, DC-DC converters, a variety of sensors, actuators, and controllers, among others.

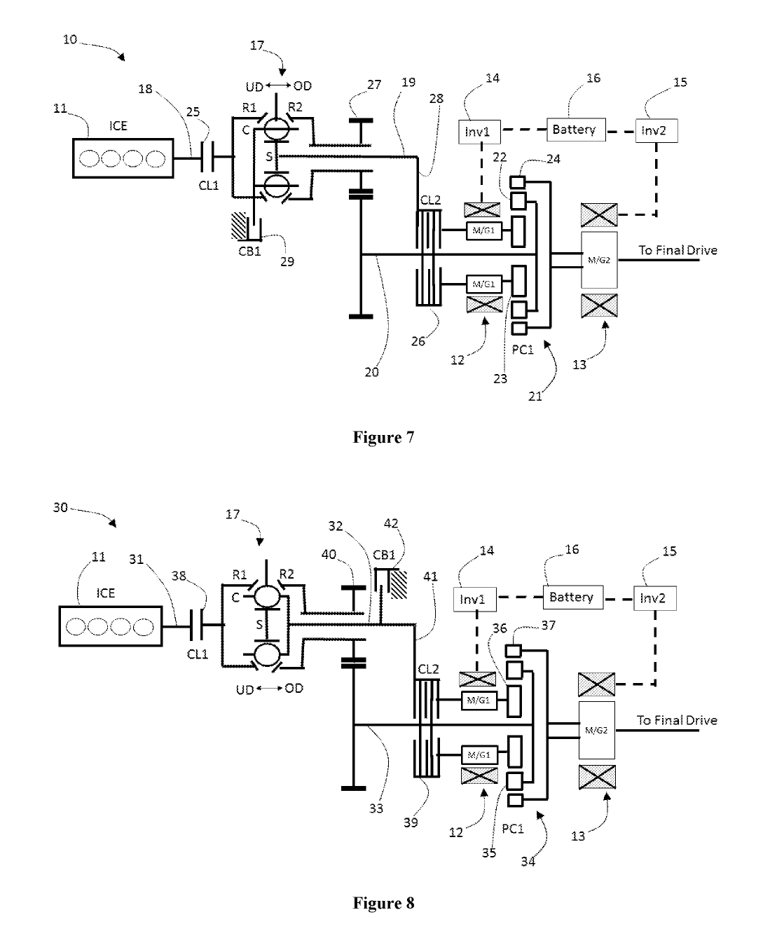

Referring now to FIG. 7; in some embodiments a hybrid powertrain 10 includes a source of rotational power, for example an internal combustion engine (ICE) 11, a first motor-generator 12, and a second motor-generator 13. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16, for example. In some embodiments, the hybrid powertrain 10 includes a variator assembly 17. In some embodiments, the variator assembly 17 is substantially similar to the CVP depicted in FIGS. 1-3. The variator assembly 17 has a first traction ring (R1), a second traction ring (R2), a carrier assembly (C), and a sun assembly (S). For descriptive purposes and conciseness, common components depicted in FIGS. 7-20 have common labels.

Still referring to FIG. 7; in some embodiments, the hybrid powertrain 10 has a first rotatable shaft 18 configured to couple to the ICE 11. The hybrid powertrain 10 includes a second rotatable shaft 19 coaxial with the first rotatable shaft 18. The second rotatable shaft 19 is coupled to the sun assembly (S). The hybrid powertrain 10 includes a third rotatable shaft 20 configured to be substantially parallel to the second rotatable shaft 19. The first motor generator 12 and the second motor generator 13 are arranged coaxially on the third rotatable shaft 20. The second motor generator 13 is configured to couple to a final drive gear (not shown). In some embodiments, the hybrid powertrain 10 includes a planetary gear set 21 (PC1) arranged coaxially on the third rotatable shaft 20. In some embodiments, the planetary gear set 21 (PC1) is a simple planetary. In some embodiments, the planetary gear set 21 (PC1) is a compound planetary. The planetary gear set 21 (PC1) includes a planet carrier 22, a sun gear 23, and a ring gear 24. The sun gear 23 is operably coupled to the first motor-generator 12. The planet carrier 22 is coupled to the third rotatable shaft 20. The ring gear 24 is operably coupled to the second motor-generator 13. In some embodiments, the hybrid powertrain 10 includes a first clutch 25 (CL1) coupled to the first rotatable shaft 18. The first clutch 25 is coupled to the first traction ring (R1). The hybrid powertrain 10 includes a second clutch 26 (CL2) coupled to the third rotatable shaft 20. The second clutch 26 is coupled to the first motor-generator 12. In some embodiments, a gear set 27 is configured to couple the second traction ring (R2) to the third rotatable shaft 20. The second rotatable shaft 19 is coupled to the second clutch 26 with a coupling 28. In some embodiments, the coupling 28 is a belt coupling. In some embodiments, the coupling 28 is a chain coupling. In other embodiments, the coupling 28 is a step gear. The hybrid powertrain 10 is provided with a brake clutch 29 (CB1) coupled to the carrier assembly (C). In some embodiments, the brake clutch 29 is optionally provided to couple to the planetary gear set 21 (PC1) to facilitate the coupling of any element of the planetary gear set 21 (PC1) to a ground member or to couple two elements of the planetary gear set 21 (PC1) to each other.

During operation of the hybrid powertrain 10, power is transmitted in at least two modes of operation. A first mode of operation is established as the variator 17 is used as a differential element as is the planetary gear set 21 when the carrier assembly (C) is free to rotate. In other words, the first mode of operation corresponds to a disengaged position of the brake clutch 29. A second mode of operation is established as the variator 17 is used as a mechanical transmission when the brake clutch 29 is applied to ground the carrier assembly (C).

Provided herein is a hybrid powertrain comprising a first rotatable shaft operably coupleable to a source of rotational power; a second rotatable shaft aligned substantially coaxial to the first rotatable shaft, the first rotatable shaft and the second rotatable shaft forming a main axis; a third rotatable shaft aligned substantially parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; wherein the second traction ring is operably coupled to the third rotatable shaft; wherein the sun assembly is coupled to the second rotatable shaft; a planetary gearset having a planet carrier, a sun gear, and a ring gear, the planetary gearset coaxial with the third rotatable shaft, the third rotatable shaft coupled to the planet carrier; a first motor-generator positioned coaxially with the third rotatable shaft, the first motor/generator operably coupled to the sun gear; a second motor-generator positioned coaxially with the third rotatable shaft, the second motor-generator coupled to the ring gear; a first clutch operably coupled to the first rotatable shaft, the first clutch coupled to the first traction ring; a second clutch arranged coaxially with the third rotatable shaft, the second clutch coupled to the first motor-generator; and a brake clutch operably coupled to the carrier assembly.

In some embodiments of the hybrid powertrain, a gear set is configured to couple the second traction ring to the third rotatable shaft.

In some embodiments of the hybrid powertrain, a chain is configured to couple the second rotatable shaft to the second clutch.

In some embodiments of the hybrid powertrain, a first inverter is in electrical communication with the first motor-generator.

In some embodiments of the hybrid powertrain, a second inverter is in electrical communication with the second motor-generator.

In some embodiments of the hybrid powertrain, a battery is in electrical communication with the first inverter and the second inverter.

In some embodiments of the hybrid powertrain, a step gear connection is configured to couple the second rotatable shaft to the second clutch.

In some embodiments of the hybrid powertrain, the second clutch is configured to selectively engage the sun assembly and the second traction ring.

Referring now to FIG. 8; in some embodiments a hybrid powertrain 30 includes the ICE 11, the first motor-generator 12, the second motor generator 13, and the variator assembly 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 30 has a first rotatable shaft 31 configured to couple to the ICE 11. The hybrid powertrain 30 has a second rotatable shaft 32 arranged coaxially with the first rotatable shaft 31. The second rotatable shaft 32 is coupled to the carrier assembly (C). The hybrid powertrain 30 includes a third rotatable shaft 33 arranged substantially parallel to the second rotatable shaft 32. The first motor generator 12 and the second motor generator 13 are coaxial with the third rotatable shaft 33. In some embodiments, a planetary gear set 34 (PC1) is arranged coaxially with the third rotatable shaft 33. In some embodiments, the planetary gear set 34 (PC1) is a simple planetary. In some embodiments, the planetary gear set 34 (PC1) is a compound planetary. The planetary gear set 34 includes a planet carrier 35, a sun gear 36, and a ring gear 37. The first motor generator 12 is coupled to the sun gear 36. The second motor generator 13 is coupled to the ring gear 37. In some embodiments, the hybrid powertrain 30 is provided with a first clutch 38 (CL1) coupled to the first rotatable shaft 31. The first clutch 38 is coupled to the first traction ring (R1). The hybrid powertrain 30 is provided with a second clutch 39 (CL2) arranged coaxially with the third rotatable shaft 33. The second clutch 39 is operably coupled to the first motor-generator 12. In some embodiments, a gear set 40 couples the second rotatable shaft 32 to the third rotatable shaft 33. A coupling 41 is configured to connect the second rotatable shaft 32 to the second clutch 39. In some embodiments, the coupling 41 is a belt coupling. In some embodiments, the coupling 41 is a chain coupling. In other embodiments, the coupling 41 is a step gear. The hybrid powertrain 30 is provided with a brake clutch 42 (CB1) coupled to the sun assembly (S). In some embodiments, the brake clutch 42 is optionally provided to couple to the planetary gear set 34 (PC1) to facilitate the coupling of any element of the planetary gear set 34 (PC1) to a ground member or to couple two elements of the planetary gear set 34 (PC1) to each other.

During operation of the hybrid powertrain 30, power is transmitted in at least two modes of operation. A first mode of operation is established as the variator 17 is used as a differential element when the brake clutch 42 (CB1) is disengaged and the carrier assembly (C) is free to rotate. A second mode of operation is established as the variator 17 is used as a mechanical transmission when the brake clutch 42 (CB1) is applied to ground the carrier assembly (C).

Provided herein is a hybrid powertrain comprising a first rotatable shaft operably coupleable to a source of rotational power; a second rotatable shaft aligned substantially coaxial to the first rotatable shaft, the first rotatable shaft and the second rotatable shaft forming a main axis; a third rotatable shaft aligned substantially parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; wherein the second traction ring is operably coupled to the third rotatable shaft; wherein the carrier assembly is coupled to the second rotatable shaft; a planetary gearset having a planet carrier, a sun gear, and a ring gear, the planetary gearset coaxial with the third rotatable shaft, the third rotatable shaft coupled to the planet carrier; a first motor-generator positioned coaxially with the third rotatable shaft, the first motor/generator operably coupled to the sun gear; a second motor-generator positioned coaxially with the third rotatable shaft, the second motor-generator coupled to the ring gear; a first clutch operably coupled to the first rotatable shaft, the first clutch coupled to the first traction ring; a second clutch coupled to the third rotatable shaft, the second clutch coupled to the first motor-generator; and a brake clutch operably coupled to the second rotatable shaft.

In some embodiments of the hybrid powertrain, a gear set is configured to couple the second traction ring to the third rotatable shaft.

In some embodiments of the hybrid powertrain, a chain connection is configured to couple the second rotatable shaft to the second clutch.

In some embodiments of the hybrid powertrain, a step gear connection is configured to couple the second rotatable shaft to the second clutch.

In some embodiments of the hybrid powertrain, a first inverter is in electrical communication with the first motor-generator.

In some embodiments of the hybrid powertrain, a second inverter is in electrical communication with the second motor-generator.

In some embodiments of the hybrid powertrain, a battery is in electrical communication with the first inverter and the second inverter.

In some embodiments of the hybrid powertrain, the second clutch is configured to selectively engage the sun assembly and the second traction ring.

Turning now to FIG. 9; in some embodiments a hybrid powertrain 50 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 50 has a first rotatable shaft 51 operably coupled to the ICE 11. A planetary gear set 52 (PC) is arranged coaxially with the first rotatable shaft 51. The planetary gear set 52 has a planetary carrier 53, a sun gear 54, and a ring gear 55. In some embodiments, a first clutch 56 (CL1) is configured to couple to the first rotatable shaft 51. The first clutch 56 is coupled to the ring gear 55. The hybrid powertrain 50 includes a second rotatable shaft 57 coupled to the sun gear 54. The second rotatable shaft 57 is coaxial with the first rotatable shaft 51. The first motor-generator 12 is coupled to the second rotatable shaft 57.

In some embodiments, the hybrid powertrain 50 is provided with a third rotatable shaft 58 coaxial with a fourth rotatable shaft 59. The third rotatable shaft 58 and the fourth rotatable shaft 59 are substantially parallel to the second rotatable shaft 57. The variator 17 is coaxial with the third rotatable shaft 58 and the fourth rotatable shaft 59. The third rotatable shaft 58 is coupled to the first traction ring (R1). The fourth rotatable shaft 59 is coupled to the sun assembly (S). A second clutch 60 (CL2) is arranged coaxially on the fourth rotatable shaft 59. In some embodiments, a first gear set 61 is configured to couple the planet carrier 53 to the third rotatable shaft 58. The hybrid powertrain 50 has a second gear set 62. The second gear set 62 is coupled to the second rotatable shaft 57 and the second clutch 60. A third gear set 63 is operably coupled to the second traction ring (R2). The third gear set 63 is coupled to a fifth rotatable shaft 64. The fifth rotatable shaft 64 is aligned substantially parallel to the fourth rotatable shaft 59. The second motor-generator 13 is coupled to the fifth rotatable shaft 64. The second motor-generator 13 is operably coupled to a final drive gear 65. A brake clutch 66 (CB1) is coupled to the carrier assembly (C).

During operation of the hybrid powertrain 50, power is transmitted in at least two modes of operation. A first mode of operation is established when the second clutch 60 is engaged and the brake clutch 66 is not applied, in other words, the carrier assembly (C) is free to rotate. In the first mode of operation the variator 17 functions as a differential element. Disengagement of the first clutch 56 and the second clutch 60 in unison with the application of the brake clutch 66 to ground the carrier assembly (C) provides a transition to a second mode of operation. In the second mode of operation, the first clutch 56 is engaged and the variator 17 functions as a mechanical transmission.

Provided herein is a hybrid powertrain comprising a first rotatable shaft operably coupleable to a source of rotational power; a second rotatable shaft aligned substantially coaxial to the first rotatable shaft, the first rotatable shaft and the second rotatable shaft forming a main axis; a third rotatable shaft aligned substantially parallel to the main axis; a fourth rotatable shaft aligned coaxially with the third rotatable shaft; a fifth rotatable shaft aligned substantially parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the third rotatable shaft; wherein the first traction ring is operably coupled to the third rotatable shaft; wherein the sun assembly is coupled to the fourth rotatable shaft; a planetary gearset having a planet carrier, a sun gear, and a ring gear, the planetary gearset coaxial with the second rotatable shaft, the second rotatable shaft coupled to the sun gear; a first motor-generator positioned coaxially with the second rotatable shaft; a second motor-generator positioned coaxially with the fifth rotatable shaft, the second motor-generator operably coupled to the second traction ring; a first clutch operably coupled to the first rotatable shaft, the first clutch coupled to the ring gear; a second clutch coupled to the fourth rotatable shaft, the second clutch operably coupled to the first motor-generator; and a brake clutch operably coupled to the carrier assembly. In some embodiments of the hybrid powertrain, a first gear set is configured to couple the planet carrier to the third rotatable shaft. In some embodiments of the hybrid powertrain, a second gear set is configured to couple the first motor-generator to the second clutch. In some embodiments of the hybrid powertrain, a third gear set is configured to couple the second traction ring to the fifth rotatable shaft. In some embodiments of the hybrid powertrain, a first inverter is in electrical communication with the first motor-generator. In some embodiments of the hybrid powertrain, a second inverter is in electrical communication with the second motor-generator. In some embodiments of the hybrid powertrain, a battery is in electrical communication with the first inverter and the second inverter. In some embodiments of the hybrid powertrain, a final drive gear is operably coupled to the second motor-generator.

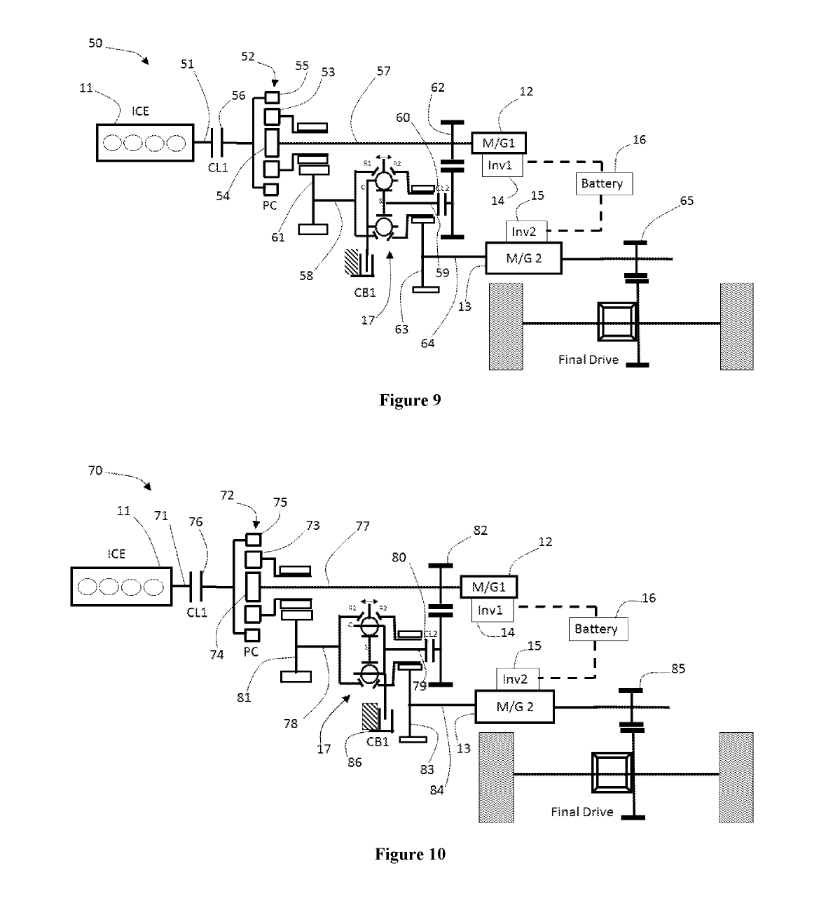

Referring now to FIG. 10; in some embodiments, a hybrid powertrain 70 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 70 has a first rotatable shaft 71 operably coupled to the ICE 11. A planetary gear set 72 is arranged coaxially with the first rotatable shaft 71. The planetary gear set 72 has a planetary carrier 73, a sun gear 74, and a ring gear 75. In some embodiments, a first clutch 76 (CL1) is configured to couple to the first rotatable shaft 71. The first clutch 76 is coupled to the ring gear 75. The hybrid powertrain 70 includes a second rotatable shaft 77 coupled to the sun gear 74. The second rotatable shaft 77 is coaxial with the first rotatable shaft 71. The first motor-generator 12 is coupled to the second rotatable shaft 77.

In some embodiments, the hybrid powertrain 70 is provided with a third rotatable shaft 78 coaxial with a fourth rotatable shaft 79. The third rotatable shaft 78 and the fourth rotatable shaft 79 are substantially parallel to the second rotatable shaft 77. The variator 17 is coaxial with the third rotatable shaft 78 and the fourth rotatable shaft 79. The third rotatable shaft 78 is coupled to the first traction ring (R1). The fourth rotatable shaft 79 is coupled to the carrier assembly (C). A second clutch 80 (CL2) is arranged coaxially on the fourth rotatable shaft 79. In some embodiments, a first gear set 81 is configured to couple the planet carrier 73 to the third rotatable shaft 78. The hybrid powertrain 70 has a second gear set 82. The second gear set 82 is coupled to the second rotatable shaft 77 and the second clutch 80. A third gear set 83 is operably coupled to the second traction ring (R2). The third gear set 83 is coupled to a fifth rotatable shaft 84. The fifth rotatable shaft 84 is aligned substantially parallel to the fourth rotatable shaft 79. The second motor-generator 13 is coupled to the fifth rotatable shaft 84. The second motor-generator 13 is operably coupled to a final drive gear 85. A brake clutch 86 (CB1) is coupled to the carrier assembly (C).

During operation of the hybrid powertrain 70, power is transmitted in at least two modes of operation. A first mode of operation is established when the brake clutch 86 is not applied, in other words, the carrier assembly (C) is free to rotate. In the first mode of operation the variator 17 functions as a differential element. Disengagement of the first clutch 76 and the second clutch 80 in unison with the application of the brake clutch 86 to ground the carrier assembly (C) provides a transition to a second mode of operation. In the second mode of operation, the first clutch 76 is engaged, the brake clutch 86 is applied, and the variator 17 functions as a mechanical transmission.

Provided herein is a hybrid powertrain comprising a first rotatable shaft operably coupleable to a source of rotational power; a second rotatable shaft aligned substantially coaxial to the first rotatable shaft, the first rotatable shaft and the second rotatable shaft forming a main axis; a third rotatable shaft aligned substantially parallel to the main axis; a fourth rotatable shaft aligned coaxially with the third rotatable shaft; a fifth rotatable shaft aligned substantially parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the third rotatable shaft; wherein the first traction ring is operably coupled to the third rotatable shaft; wherein the carrier assembly is coupled to the fourth rotatable shaft; a planetary gearset having a planet carrier, a sun gear, and a ring gear, the planetary gearset coaxial with the second rotatable shaft, the second rotatable shaft coupled to the sun gear; a first motor-generator positioned coaxially with the second rotatable shaft; a second motor-generator positioned coaxially with the fifth rotatable shaft, the second motor-generator operably coupled to the second traction ring; a first clutch operably coupled to the first rotatable shaft, the first clutch coupled to the ring gear; a second clutch coupled to the fourth rotatable shaft, the second clutch operably coupled to the first motor-generator; and a brake clutch operably coupled to the carrier assembly. In some embodiments of the hybrid powertrain, a first gear set is configured to couple the planet carrier to the third rotatable shaft. In some embodiments of the hybrid powertrain, a second gear set is configured to couple the second rotatable shaft to the second clutch. In some embodiments of the hybrid powertrain, a third gear set is configured to couple the second traction ring to the fifth rotatable shaft. In some embodiments of the hybrid powertrain, a first inverter is in electrical communication with the first motor-generator. In some embodiments of the hybrid powertrain, a second inverter is in electrical communication with the second motor-generator. In some embodiments of the hybrid powertrain, a battery is in electrical communication with the first inverter and the second inverter. In some embodiments of the hybrid powertrain, a final drive gear is operably coupled to the second motor-generator.

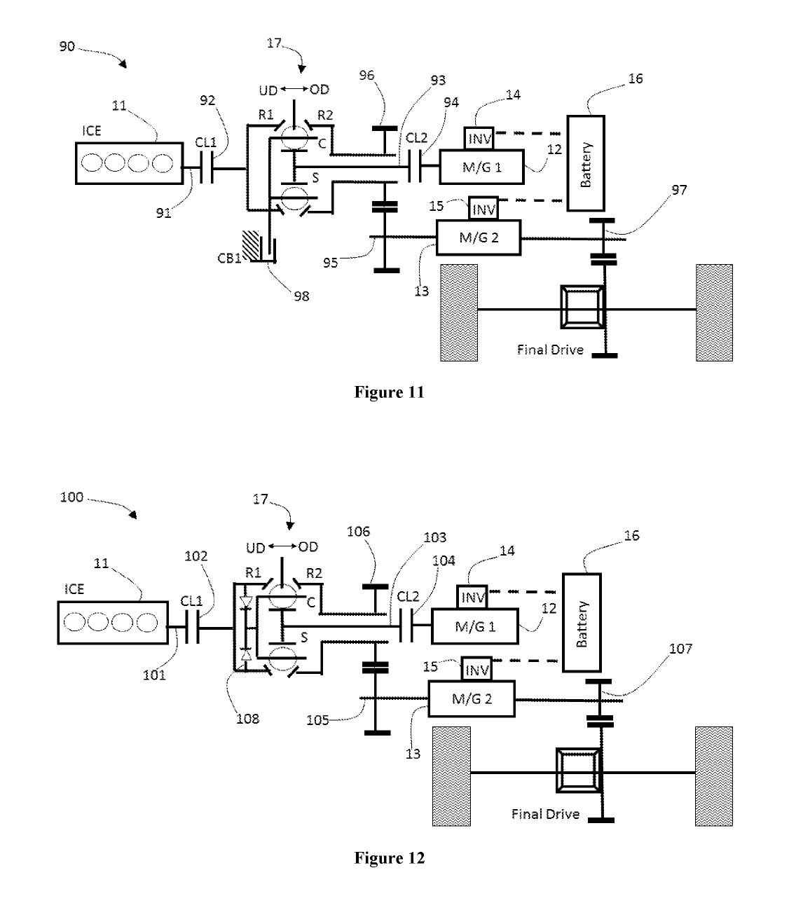

Turning now to FIG. 11; in some embodiments, a hybrid powertrain 90 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 90 has a first rotatable shaft 91 operably coupled to the ICE 11. A first clutch 92 (CL1) is coupled to the first rotatable shaft 91. The first clutch 92 is coupled to the first traction ring (R1). The variator 17 is arranged coaxially with the first rotatable shaft 91. The hybrid powertrain 90 includes a second rotatable shaft 93 coupled to the sun assembly (S). The second rotatable shaft 93 is coaxial with the first rotatable shaft 91. A second clutch 94 (CL2) is coupled to the second rotatable shaft 93. The second clutch 94 is operably coupled to the first motor-generator 12. In some embodiments, the hybrid powertrain 90 includes a third rotatable shaft 95 arranged substantially parallel to the second rotatable shaft 93. A gear set 96 couples the second rotatable shaft 93 to the third rotatable shaft 95. The third rotatable shaft 95 is coupled to the second motor-generator 13. The second motor-generator 13 is coupled to a final drive gear 97. A first brake clutch 98 (CB1) is provided to selectively couple the carrier assembly (C) to ground.

During operation of the hybrid powertrain 90, power is transmitted in at least two modes of operation. A first mode of operation is established when the second clutch 94 is engaged and the brake 98 is not applied, in other words, the carrier assembly (C) is free to rotate. In the first mode of operation the variator 17 functions as a differential element. Disengagement of the first clutch 92 and the second clutch 94 in unison with the application of the first brake clutch 98, to thereby ground the carrier assembly (C), provides a transition to a second mode of operation. In the second mode of operation, the first clutch 92 is engaged, the brake clutch 98 (CB1) is applied to the carrier assembly (C), and the variator 17 functions as a mechanical transmission.

Referring now to FIG. 12; in some embodiments, a hybrid powertrain 100 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 100 has a first rotatable shaft 101 operably coupled to the ICE 11. A first clutch 102 (CL1) is coupled to the first rotatable shaft 101. The first clutch 102 is coupled to the first traction ring (R1). The variator 17 is arranged coaxially with the first rotatable shaft 101. The hybrid powertrain 100 includes a second rotatable shaft 103 coupled to the sun assembly (S). The second rotatable shaft 103 is coaxial with the first rotatable shaft 101. A second clutch 104 (CL2) is coupled to the second rotatable shaft 103. The second clutch 104 is operably coupled to the first motor-generator 12. In some embodiments, the hybrid powertrain 100 includes a third rotatable shaft 105 arranged substantially parallel to the second rotatable shaft 103. A gear set 106 couples the second traction ring (R2) to the third rotatable shaft 105. The third rotatable shaft 105 is coupled to the second motor-generator 13. The second motor-generator 13 is coupled to a final drive gear 107. A one-way clutch 108 is provided to couple the first traction ring (R1) to the carrier assembly (C).

During operation of the hybrid powertrain 100, power is transmitted in at least two modes of operation. A first mode of operation is established when the first clutch 102 and the second clutch 104 are engaged. In the first mode of operation the variator 17 functions as a differential element. In the second mode of operation, the first clutch 102 is engaged and the variator 17 functions as a mechanical transmission. The one-way clutch 108 is configured to maintain a speed relationship between the first traction ring (R1) and the carrier assembly (C). In some embodiments, the one-way clutch 108 is configured so that the speed of the first traction ring (R1) is always greater than or equal to the speed of the carrier assembly (C). In some embodiments, the one-way clutch 108 is configured so that the speed of the first traction ring (R1) is always less than or equal to the speed of the carrier assembly (C).

Passing now to FIG. 13; in some embodiments a hybrid powertrain 110 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 110 has a first rotatable shaft 111 operably coupled to the ICE 11. A first clutch 112 (CL1) is coupled to the first rotatable shaft 111. The first clutch 112 is coupled to the first traction ring (R1). The variator 17 is arranged coaxially with the first rotatable shaft 111. The hybrid powertrain 110 includes a second rotatable shaft 113 coupled to the first motor-generator 12. The second rotatable shaft 113 is coaxial with the first rotatable shaft 111. A second clutch 114 (CL2) is coupled to the second rotatable shaft 113. The second clutch 114 is configured to selectively engage the carrier assembly (C) and the sun assembly (S). In some embodiments, the second clutch 114 is configured to provide a brake to the disengaged element. For example, when the sun assembly (S) is engaged by the second clutch 114, the carrier assembly (C) is grounded. When the carrier assembly (C) is engaged by the second clutch 114, the sun assembly (S) is grounded. In some embodiments, the hybrid powertrain 110 includes a third rotatable shaft 115 arranged substantially parallel to the second rotatable shaft 113. A gear set 116 couples the second traction ring (R2) to the third rotatable shaft 115. The third rotatable shaft 115 is coupled to the second motor-generator 13. The second motor-generator 13 is coupled to a final drive gear 117. A first brake clutch 118 (CB1) is provided to selectively ground the carrier assembly (C).

During operation of the hybrid powertrain 110, power is transmitted in at least two modes of operation. A first mode of operation is established when the first brake clutch 118 is not applied, in other words, the carrier assembly (C) is free to rotate. In the first mode of operation the variator 17 functions as a differential element. Disengagement of the first clutch 112 and the second clutch 114 in unison with the application of the brake 118, to thereby ground the carrier assembly (C), provides a transition to a second mode of operation. In the second mode of operation, the first brake clutch 118 is applied, and the variator 17 functions as a mechanical transmission. The second clutch 114 can be controlled to modulate the selectively coupled carrier assembly (C) and the sun assembly (S) to provide the desired operating conditions for the first motor-generator 12.

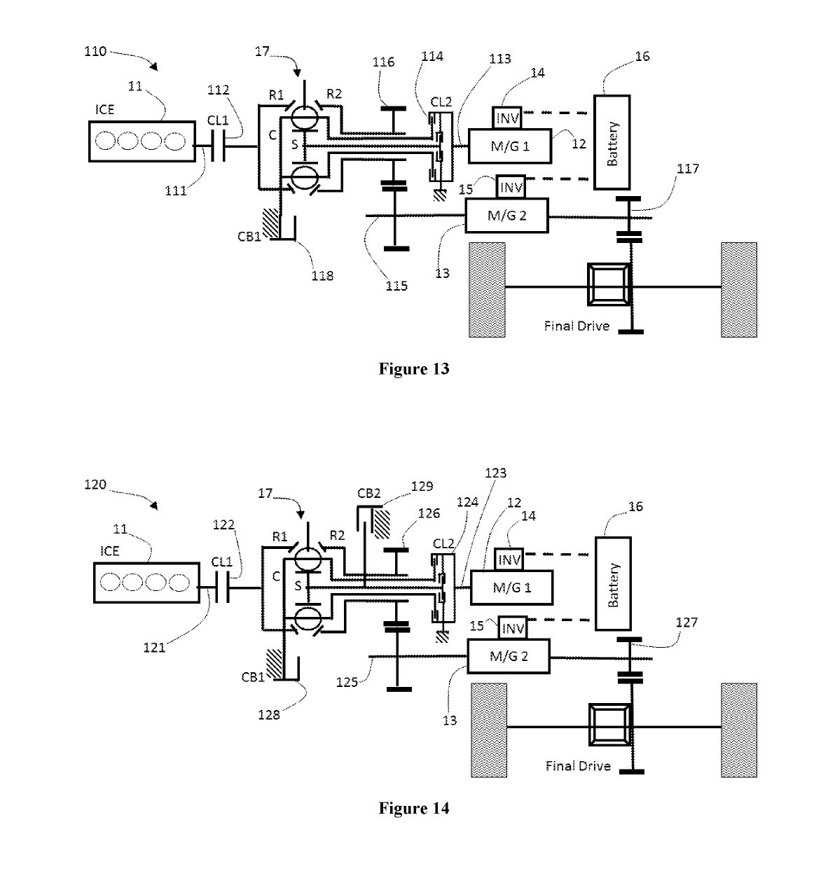

Referring now to FIG. 14; in some embodiments a hybrid powertrain 120 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 120 has a first rotatable shaft 121 operably coupled to the ICE 11. A first clutch 122 (CL1) is coupled to the first rotatable shaft 121. The first clutch 122 is coupled to the first traction ring (R1). The variator 17 is arranged coaxially with the first rotatable shaft 121. The hybrid powertrain 120 includes a second rotatable shaft 123 coupled to the first motor-generator 12. The second rotatable shaft 123 is coaxial with the first rotatable shaft 121. A second clutch 124 (CL2) is coupled to the second rotatable shaft 123. The second clutch 124 is configured to selectively engage the carrier assembly (C) and the sun assembly (S).). In some embodiments, the second clutch 124 is configured to provide a brake to the disengaged element. For example, when the sun assembly (S) is engaged by the second clutch 124, the carrier assembly (C) is grounded. When the carrier assembly (C) is engaged by the second clutch 124, the sun assembly (S) is grounded. In some embodiments, the hybrid powertrain 120 includes a third rotatable shaft 125 arranged substantially parallel to the second rotatable shaft 123. A gear set 126 couples the second traction ring (R2) to the third rotatable shaft 125. The third rotatable shaft 125 is coupled to the second motor-generator 13. The second motor-generator 13 is coupled to a final drive gear 127. A first brake clutch 128 (CB1) is provided to selectively ground the carrier assembly (C). A second brake clutch 129 (CB2) is provided to selectively ground the sun assembly (S).

During operation of the hybrid powertrain 120, power is transmitted in at least two modes of operation. A first mode of operation is established when the first brake clutch 128 is not applied, in other words, the carrier assembly (C) is free to rotate, and the second brake clutch 129 is applied to the sun assembly (S). In the first mode of operation the variator 17 functions as a differential element. Disengagement of the first clutch 122 and the second clutch 124 in unison with the application of the first brake clutch 128, to thereby ground the carrier assembly (C), and the release of the second brake clutch 129, provides a transition to a second mode of operation. In the second mode of operation, the first clutch 122 is engaged, the second clutch 124 is engaged to the sun assembly (S), the first brake clutch 128 is applied, and the variator 17 functions as a mechanical transmission.

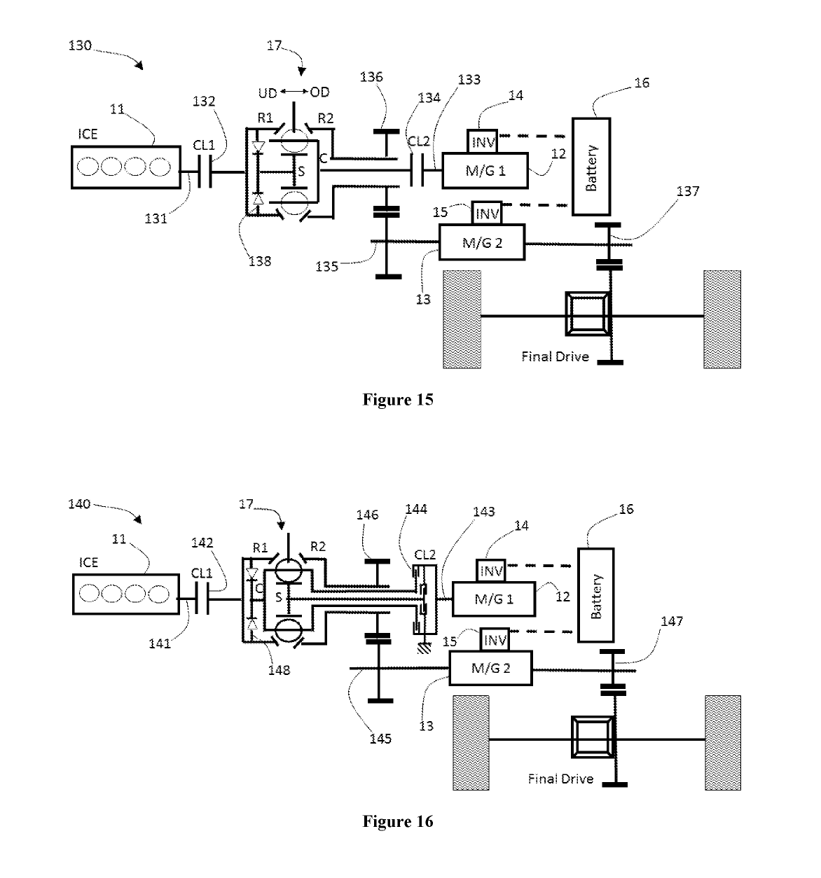

Referring now to FIG. 15; in some embodiments, a hybrid powertrain 130 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 130 has a first rotatable shaft 131 operably coupled to the ICE 11. A first clutch 132 is coupled to the first rotatable shaft 131. The first clutch 132 (CL1) is coupled to the first traction ring (R1). The variator 17 is arranged coaxially with the first rotatable shaft 131. The hybrid powertrain 130 includes a second rotatable shaft 133 coupled to a second clutch 134 (CL2). The second rotatable shaft 133 is coaxial with the first rotatable shaft 131. The second clutch 134 is configured to selectively engage the carrier assembly (C). The second clutch 134 is operably coupled to the first motor-generator 12. In some embodiments, the hybrid powertrain 130 includes a third rotatable shaft 135 arranged substantially parallel to the second rotatable shaft 133. A gear set 136 couples the second traction ring (R2) to the third rotatable shaft 135. The third rotatable shaft 135 is coupled to the second motor-generator 13. The second motor-generator 13 is coupled to a final drive gear 137. A one-way clutch 138 is provided to couple the first traction ring (R1) to the sun assembly (S).

During operation of the hybrid powertrain 130, power is transmitted in at least two modes of operation. A first mode of operation is established when the first clutch 132 and the second clutch 134 are engaged. In the first mode of operation the variator 17 functions as a differential element. In the second mode of operation, the first clutch 132 is engaged and the variator 17 functions as a mechanical transmission. The one-way clutch 138 is configured to maintain a speed relationship between the first traction ring (R1) and the sun assembly (S). In some embodiments, the one-way clutch 138 is configured so that the speed of the first traction ring (R1) is always greater than or equal to the speed of the sun assembly (S). In some embodiments, the one-way clutch 138 is configured so that the speed of the first traction ring (R2) is always less than or equal to the speed of the sun assembly (S).

Referring now to FIG. 16; in some embodiments, a hybrid powertrain 140 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 140 has a first rotatable shaft 141 operably coupled to the ICE 11. A first clutch 142 is coupled to the first rotatable shaft 141.

The first clutch 142 (CL1) is coupled to the first traction ring (R1). The variator 17 is arranged coaxially with the first rotatable shaft 141. The hybrid powertrain 140 includes a second rotatable shaft 143 coupled to a second clutch 144 (CL2). The second rotatable shaft 143 is coaxial with the first rotatable shaft 141. The second clutch 144 is configured to selectively engage the carrier assembly (C) and the sun assembly (S). The second clutch 144 is operably coupled to the first motor-generator 12. In some embodiments, the second clutch 144 is configured to provide a brake to the disengaged element. For example, when the sun assembly (S) is engaged by the second clutch 144, the carrier assembly (C) is grounded. When the carrier assembly (C) is engaged by the second clutch 144, the sun assembly (S) is grounded. In some embodiments, the hybrid powertrain 140 includes a third rotatable shaft 145 arranged substantially parallel to the second rotatable shaft 143. A gear set 146 couples the second traction ring (R2) to the third rotatable shaft 145. The third rotatable shaft 145 is coupled to the second motor-generator 13. The second motor-generator 13 is coupled to a final drive gear 147. A one-way clutch 148 is provided to couple the first traction ring (R1) to the carrier assembly (C).

During operation of the hybrid powertrain 140, power is transmitted in at least two modes of operation. A first mode of operation is established when the first clutch 142 and the second clutch 144 are engaged. In the first mode of operation the variator 17 functions as a differential element. In the second mode of operation, the first clutch 142 is engaged and the variator 17 functions as a mechanical transmission. The one-way clutch 148 is configured to maintain a speed relationship between the first traction ring (R1) and the carrier assembly (C). In some embodiments, the one-way clutch 148 is configured so that the speed of the first traction ring (R1) is always greater than or equal to the speed of the carrier assembly (C). In some embodiments, the one-way clutch 148 is configured so that the speed of the first traction ring (R2) is always less than or equal to the speed of the carrier assembly (C).

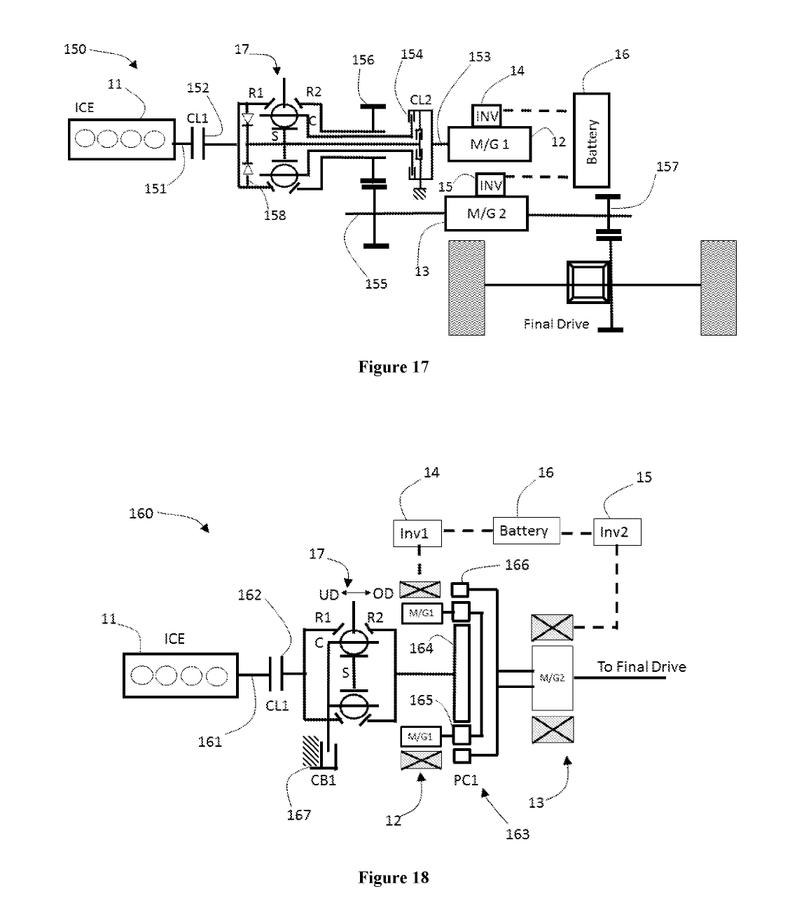

Referring now to FIG. 17; in some embodiments, a hybrid powertrain 150 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 150 has a first rotatable shaft 151 operably coupled to the ICE 11. A first clutch 152 is coupled to the first rotatable shaft 151. The first clutch 152 (CL1) is coupled to the first traction ring (R1). The variator 17 is arranged coaxially with the first rotatable shaft 151. The hybrid powertrain 150 includes a second rotatable shaft 153 coupled to a second clutch 154 (CL2). The second rotatable shaft 153 is coaxial with the first rotatable shaft 151. The second clutch 154 is configured to selectively engage the carrier assembly (C) and the sun assembly (S). The second clutch 154 is operably coupled to the first motor-generator 12. In some embodiments, the second clutch 154 is configured to provide a brake to the disengaged element. For example, when the sun assembly (S) is engaged by the second clutch 154, the carrier assembly (C) is grounded. When the carrier assembly (C) is engaged by the second clutch 154, the sun assembly (S) is grounded. In some embodiments, the hybrid powertrain 150 includes a third rotatable shaft 155 arranged substantially parallel to the second rotatable shaft 153. A gear set 156 couples the second traction ring (R2) to the third rotatable shaft 155. The third rotatable shaft 155 is coupled to the second motor-generator 13. The second motor-generator 13 is coupled to a final drive gear 157. A one-way clutch 158 is provided to couple the first traction ring (R1) to the sun assembly (S).

During operation of the hybrid powertrain 150, power is transmitted in at least two modes of operation. A first mode of operation is established when the first clutch 152 and the second clutch 154 is engaged. In the first mode of operation the variator 17 functions as a differential element. In the second mode of operation, the first clutch 152 is engaged and the variator 17 functions as a mechanical transmission. The one-way clutch 158 is configured to maintain a speed relationship between the first traction ring (R1) and the carrier assembly (C). In some embodiments, the one-way clutch 158 is configured so that the speed of the first traction ring (R1) is always greater than or equal to the speed of the sun assembly (S). In some embodiments, the one-way clutch 158 is configured so that the speed of the first traction ring (R2) is always less than or equal to the speed of the sun assembly (S).

Provided herein is a hybrid powertrain comprising a first rotatable shaft operably coupleable to a source of rotational power; a second rotatable shaft aligned substantially coaxial to the first rotatable shaft, the first rotatable shaft and the second rotatable shaft forming a main axis; a third rotatable shaft aligned substantially parallel to the main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; wherein the second traction ring is operably coupled to the third rotatable shaft; wherein the sun assembly is coupled to the second rotatable shaft; a first motor-generator positioned coaxially with the second rotatable shaft; a second motor-generator positioned coaxially with the third rotatable shaft; a first clutch operably coupled to the first rotatable shaft, the first clutch coupled to the first traction ring; a second clutch coupled to the second rotatable shaft, the second clutch coupled to the first motor-generator; and a first brake clutch operably coupled to the carrier assembly. In some embodiments of the hybrid powertrain, a gear set configured is to couple the second traction ring to the third rotatable shaft. In some embodiments of the hybrid powertrain, a first inverter is in electrical communication with the first motor-generator. In some embodiments of the hybrid powertrain, a second inverter is in electrical communication with the second motor-generator. In some embodiments of the hybrid powertrain, a battery is in electrical communication with the first inverter and the second inverter. In some embodiments of the hybrid powertrain, a final drive gear is operably coupled to the second motor-generator. In some embodiments of the hybrid powertrain, a one-way clutch is configured to couple the first traction ring and the carrier assembly. In some embodiments of the hybrid powertrain, the second clutch is a two position clutch configured to selectively couple to the carrier assembly and the sun assembly to the second rotatable shaft. In some embodiments of the hybrid powertrain, a second brake operably coupled to the second rotatable shaft. In some embodiments of the hybrid powertrain, a one-way clutch configured to couple the first traction ring to the sun assembly. In some embodiments of the hybrid powertrain, a one-way clutch is configured to couple the first traction ring to the carrier assembly. In some embodiments of the hybrid powertrain, a one-way clutch is a one-way clutch configured to couple the first traction ring to the sun assembly.

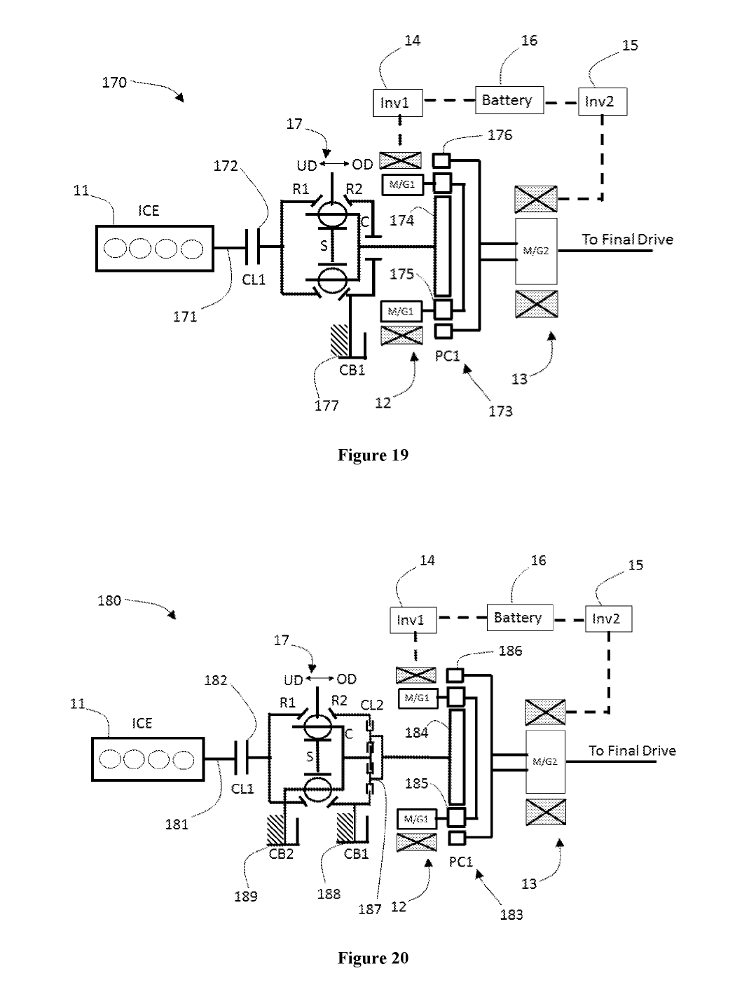

Turning now to FIG. 18; in some embodiments a hybrid powertrain 160 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 160 has a first rotatable shaft 161 operably coupled to the ICE 11. A first clutch 162 is coupled to the first rotatable shaft 161. The first clutch 162 (CL1) is coupled to the first traction ring (R1). The variator 17 is arranged coaxially with the first rotatable shaft 161. In some embodiments, the hybrid powertrain 160 includes a planetary gear set 163 (PC1) arranged coaxially with the first rotatable shaft 161. In some embodiments, the planetary gear set 163 (PC1) is a simple planetary. In some embodiments, the planetary gear set 163 (PC1) is a compound planetary. The planetary gear set 163 includes a sun gear 164, a planet carrier 165, and a ring gear 166. The sun gear 164 is operably coupled to the second traction ring (R2). The planet carrier 165 is operably coupled to the first motor-generator 12. The ring gear 166 is operably coupled to the second motor-generator 13. In some embodiments, the hybrid powertrain 160 is provided with a brake clutch 167 (CB1) operably coupled to the carrier assembly (C). In some embodiments, the brake clutch 167 is optionally provided to couple to the planetary gear set 163 (PC1) to facilitate the coupling of any element of the planetary gear set 163 (PC1) to a ground member or to couple two elements of the planetary gear set 163 (PC1) to each other. In some embodiments, the sun assembly (S) is configured to rotate freely without transferring power. In other embodiments, the sun assembly (S) is configured to transfer rotational power to component of the hybrid powertrain 160.

During operation of the hybrid powertrain 160, power is transmitted in at least two modes of operation. A first mode of operation is established as the variator 17 is used as a differential element as is the planetary gear set 163 (PC1) when the carrier assembly (C) is free to rotate. In other words, the first mode of operation corresponds to a disengaged position of the brake clutch 167. A second mode of operation is established as the variator 17 is used as a mechanical transmission when the brake clutch 167 is applied to ground the carrier assembly (C).

Provided herein is a hybrid powertrain comprising: a first rotatable shaft operably coupleable to a source of rotational power, the first rotatable shaft forming a main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; a planetary gearset having a planet carrier, a sun gear, and a ring gear, the planetary gearset coaxial with the main axis; wherein the second traction ring is operably coupled to the sun gear; a first motor-generator positioned coaxially with the main axis, the first motor/generator operably coupled to the planet carrier; a second motor-generator positioned coaxially with the main axis, the second motor-generator coupled to the ring gear; a first clutch operably coupled to the first rotatable shaft, the first clutch coupled to the first traction ring; and a brake clutch operably coupled to the carrier assembly. In some embodiments of the hybrid powertrain, the brake clutch is configured to selectively couple the carrier assembly to a grounded member. In some embodiments of the hybrid powertrain, a first mode of operation corresponds to a disengaged position of the brake clutch. In some embodiments of the hybrid powertrain, a second mode of operation corresponds to an engaged position of the brake clutch.

Referring now to FIG. 19; in some embodiments a hybrid powertrain 170 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 170 has a first rotatable shaft 171 operably coupled to the ICE 11. A first clutch 172 is coupled to the first rotatable shaft 171.

The first clutch 172 (CL1) is coupled to the first traction ring (R1). The variator 17 is arranged coaxially with the first rotatable shaft 171. In some embodiments, the hybrid powertrain 170 includes a planetary gear set 173 (PC1) arranged coaxially with the first rotatable shaft 171. In some embodiments, the planetary gear set 173 (PC1) is a simple planetary. In some embodiments, the planetary gear set 173 (PC1) is a compound planetary. The planetary gear set 173 (PC1) includes a sun gear 174, a planet carrier 175, and a ring gear 176. The sun gear 174 is operably coupled to the carrier assembly (C). The planet carrier 175 is operably coupled to the first motor-generator 12. The ring gear 176 is operably coupled to the second motor-generator 13. In some embodiments, the hybrid powertrain 170 is provided with a brake clutch 177 (CB1) operably coupled to the second traction ring (R2). In some embodiments, the brake clutch 177 is optionally provided to couple to the planetary gear set 173 (PC1) to facilitate the coupling of any element of the planetary gear set 173 (PC1) to a ground member or to couple two elements of the planetary gear set 173 (PC1) to each other. In some embodiments, the sun assembly (S) is configured to rotate freely without transferring power. In other embodiments, the sun assembly (S) is configured to transfer rotational power to component of the hybrid powertrain 170.

During operation of the hybrid powertrain 170, power is transmitted in at least two modes of operation. A first mode of operation is established as the variator 17 is used as a differential element as is the planetary gear set 173 when the carrier assembly (C) is free to rotate. In other words, the first mode of operation corresponds to a disengaged position of the brake clutch 177. A second mode of operation is established as the variator 17 is used as a mechanical transmission when the brake clutch 177 is applied to ground the carrier assembly (C).

Provided herein is a hybrid powertrain comprising: a first rotatable shaft operably coupleable to a source of rotational power, the first rotatable shaft forming a main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; a planetary gearset having a planet carrier, a sun gear, and a ring gear, the planetary gearset coaxial with the main axis; wherein the carrier assembly is operably coupled to the sun gear; a first motor-generator positioned coaxially with the main axis, the first motor/generator operably coupled to the planet carrier; a second motor-generator positioned coaxially with the main axis, the second motor-generator coupled to the ring gear; a first clutch operably coupled to the first rotatable shaft, the first clutch coupled to the first traction ring; and a brake clutch operably coupled to the second traction ring. In some embodiments of the hybrid powertrain, the brake clutch is configured to selectively couple the carrier assembly to a grounded member. In some embodiments of the hybrid powertrain, a first mode of operation corresponds to a disengaged position of the brake clutch. In some embodiments of the hybrid powertrain, a second mode of operation corresponds to an engaged position of the brake clutch.

Referring now to FIG. 20; in some embodiments a hybrid powertrain 180 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 180 has a first rotatable shaft 181 operably coupled to the ICE 11. A first clutch 182 is coupled to the first rotatable shaft 181. The first clutch 182 (CL1) is coupled to the first traction ring (R1). The variator 17 is arranged coaxially with the first rotatable shaft 181. In some embodiments, the hybrid powertrain 180 includes a planetary gear set 183 (PC1) arranged coaxially with the first rotatable shaft 181. In some embodiments, the planetary gear set 183 (PC1) is a simple planetary. In some embodiments, the planetary gear set 183 (PC1) is a compound planetary. The planetary gear set 183 (PC1) includes a sun gear 184, a planet carrier 185, and a ring gear 186. The sun gear 184 is operably coupled to a second clutch 187 (CL2). In some embodiments, the second clutch 187 is configured to selectively engage the carrier assembly (C) and the second traction ring (R2). The planet carrier 185 is operably coupled to the first motor-generator 12. The ring gear 186 is operably coupled to the second motor-generator 13. In some embodiments, the hybrid powertrain 180 is provided with a first brake clutch 188 (CB1) operably coupled to the second traction ring (R2). A second brake clutch 189 (CB2) is operably coupled to the carrier assembly (C). In some embodiments, the first brake clutch 188 is optionally provided to couple to the planetary gear set 183 (PC1) to facilitate the coupling of any element of the planetary gear set 183 (PC1) to a ground member or to couple two elements of the planetary gear set 183 (PC1) to each other. In some embodiments, the sun assembly (S) is configured to rotate freely without transferring power. In other embodiments, the sun assembly (S) is configured to transfer rotational power to component of the hybrid powertrain 180.

During operation of the hybrid powertrain 180, power is transmitted in at least two modes of operation. A first mode of operation is established as the variator 17 is used as a differential element as is the planetary gear set 183. In the first mode of operation, the second clutch 187 (CL2) is engaged to the second traction ring, the first brake clutch 188 (CB1) is not applied, the second brake clutch 189 (CB2) is applied to the carrier assembly (C). A second mode of operation is established when the second brake clutch 189 (CB2) is not applied, the first brake clutch 188 (CB1) is applied to ground the second traction ring (R2), and the second clutch 187 is engaged to the carrier assembly (C).

Provided herein is a hybrid powertrain comprising: a first rotatable shaft operably coupleable to a source of rotational power, the first rotatable shaft forming a main axis; a variator assembly having a first traction ring and a second traction ring in contact with a plurality of traction planets, each traction planet having a tiltable axis of rotation, each traction planet supported in a carrier assembly, each traction planet in contact with a sun assembly; wherein the variator assembly is coaxial with the main axis; a planetary gearset having a planet carrier, a sun gear, and a ring gear, the planetary gearset coaxial with the main axis; wherein the carrier assembly is operably coupled to the sun gear; a first motor-generator positioned coaxially with the main axis, the first motor/generator operably coupled to the planet carrier; a second motor-generator positioned coaxially with the main axis, the second motor-generator coupled to the ring gear; a first clutch operably coupled to the first rotatable shaft, the first clutch coupled to the first traction ring; a second clutch operably coupled to the sun gear; a first brake clutch operably coupled to the second traction ring; and a second brake clutch operably coupled to the carrier assembly. In some embodiments of the hybrid powertrain, the second clutch is configured to selectively engage the second traction ring and the carrier assembly.

Provided herein is any configuration of hybrid powertrain described herein, wherein the variator comprises a traction fluid.

Provided herein is a vehicle comprising any configuration of hybrid powertrain described herein.

Provided herein is a method comprising providing a hybrid powertrain of any of the configurations described herein.

Provided herein is a method of providing a vehicle comprising any configuration of hybrid powertrain described herein.

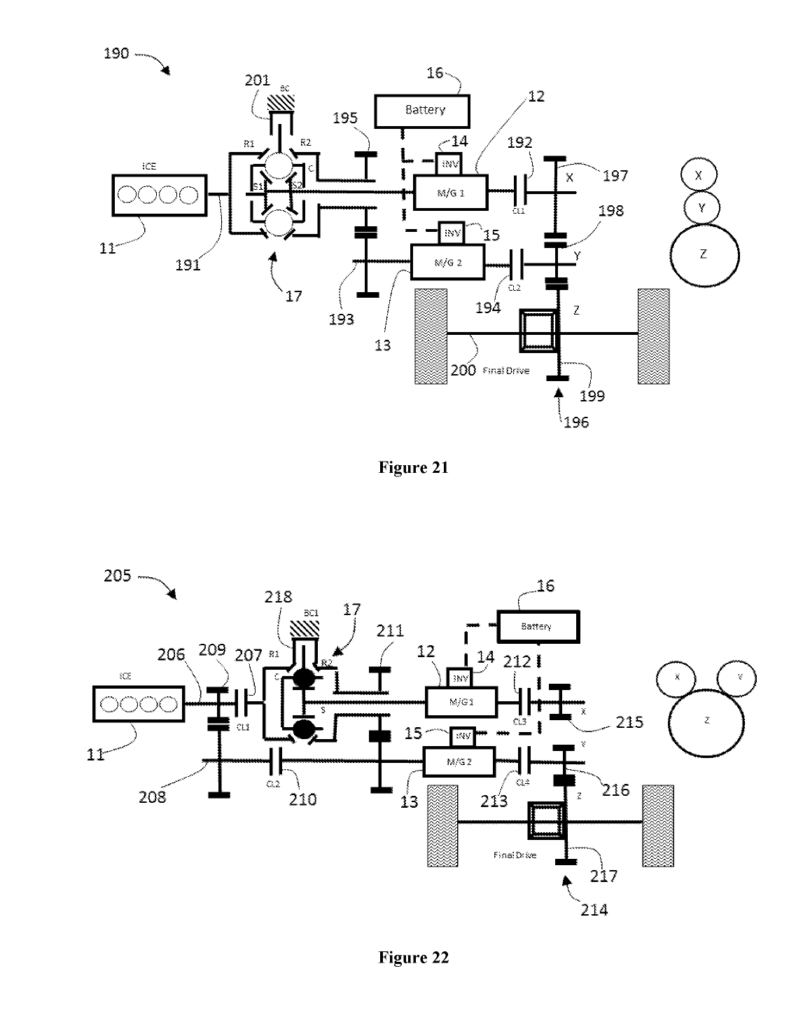

Referring now to FIG. 21; in some embodiments a hybrid powertrain 190 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 190 has a first rotatable shaft 191 operably coupled to the ICE 11. The first rotatable shaft 191 forms a main axis of the hybrid powertrain 190. The variator 17 and the first motor-generator 12 are arranged along the main axis and are coaxial with the first rotatable shaft 191. The ICE 11 is operably coupled to the first traction ring (R1). A first clutch 192 is coupled to the first motor-generator 12. The hybrid powertrain 190 includes a second rotatable shaft 193 arranged substantially parallel to the first rotatable shaft 191. The second rotatable shaft 193 forms a counter axis of the hybrid powertrain 190. The second motor-generator 13 is positioned on the second rotatable shaft 193. The hybrid powertrain 190 includes a second clutch 194. The second clutch 194 is coupled to the second motor-generator 13. A first gear set 195 is configured to operably couple the second rotatable shaft 193 to the second traction ring (R2). A final drive gear set 196 is configured to operably couple to the main axis and the counter axis. The final drive gear 196 includes a first gear 197 (X), a second gear 198 (Y), and a third gear 199 (Z). The first gear 197 (X) is operably coupled to the first clutch 192. The second gear 198 (Y) is operably coupled to the second clutch 198 (Y). The third gear 199 (Z) is operably coupled to a drive axle 200. In some embodiments, the first gear 197 (X) is coupled to the second gear 198 (Y), and the second gear 198 (Y) is coupled to the third gear 199 (Z). The hybrid powertrain 190 includes a brake 201 operably coupled to the carrier assembly (C).

During operation of the hybrid powertrain 190, power is transmitted in at least two modes of operation. A first mode of operation is established as the variator 17 is used as a differential element when the carrier assembly (C) is free to rotate. In other words, the first mode of operation corresponds to a disengaged position of the brake 201. A second mode of operation is established as the variator 17 is used as a mechanical transmission when the brake 201 is applied to ground the carrier assembly (C).

Referring now to FIG. 22; in some embodiments, a hybrid powertrain 205 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 205 has a first rotatable shaft 206 operably coupled to the ICE 11. The first rotatable shaft 206 forms a main axis of the hybrid powertrain 205. The variator 17 and the first motor-generator 12 are arranged along the main axis and are coaxial with the first rotatable shaft 206. The hybrid powertrain 205 includes a first clutch 207 (CL1) arranged on the first rotatable shaft 206. The first clutch 207 is coupled to the first traction ring (R1). The hybrid powertrain 205 includes a second rotatable shaft 208 arranged substantially parallel to the main axis. The second rotatable shaft 208 forms a counter axis of the hybrid powertrain 205. The second motor-generator 13 is arranged coaxial with the second rotatable shaft 208 along the counter axis. A first gear set 209 couples the first rotatable shaft 206 to the second rotatable shaft 208. The hybrid powertrain 205 includes a second clutch 210 coaxial with and coupled to the second rotatable shaft 208. A second gear set 211 is operably coupled to the counter axis and the second traction ring (R2). In some embodiments, the hybrid powertrain 205 includes a third clutch 212 arranged along the main axis. The third clutch 212 is operably coupled to the first motor-generator 12. The hybrid powertrain 205 includes a fourth clutch 213 arranged along the counter axis. The fourth clutch 213 is operably coupled to the second motor-generator 12. In some embodiments, the hybrid powertrain 205 includes a final gear set 214. The final gear set 214 includes a first gear 215, a second gear 216, and third gear 217. The first gear 215 is arranged along the main axis. The first gear 215 is operably coupled to the third clutch 212. The second gear 216 is arranged along the counter axis. The second gear 216 is operably coupled to the fourth clutch 213. The third gear 217 is operably coupled to a final drive shaft. In some embodiments, the first gear 215 is coupled to the third gear 217. The second gear 216 is coupled to the third gear 217. The hybrid powertrain 2015 is provided with a brake 218 operably coupled to the carrier assembly (C).

During operation of the hybrid powertrain 205, power is transmitted in at least two modes of operation. A first mode of operation is established as the variator 17 is used as a differential element when the carrier assembly (C) is free to rotate. In other words, the first mode of operation corresponds to a disengaged position of the brake. A second mode of operation is established as the variator 17 is used as a mechanical transmission when the brake is applied to ground the carrier assembly (C). The second clutch 210, the third clutch 212, and the fourth clutch 213 are selectively engaged to provide extended speed range to the driven devices and wheels. In some embodiments, selective engagement of the second clutch 210, the third clutch 212, and the fourth clutch 213 are optionally controlled to provide independent control of engine speed and motor/generator speed from vehicle speed.

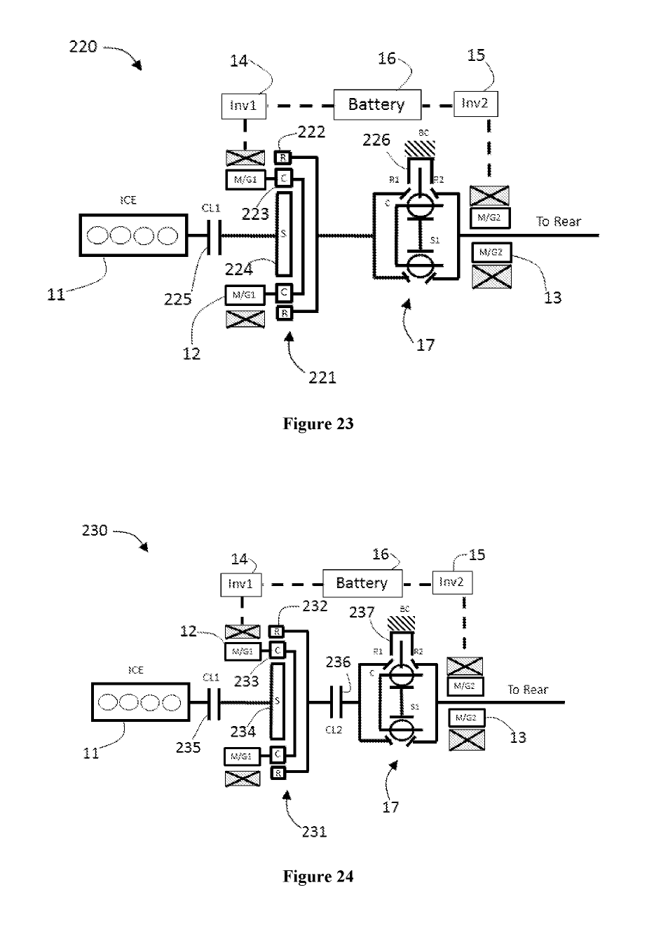

Turning now to FIG. 23; in some embodiments, a hybrid powertrain 220 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 220 include a planetary gear set 221 arranged coaxially with the ICE 11. The planetary gear set 221 includes a ring gear 222, a planet carrier 223, and a sun gear 224. In some embodiments, the hybrid powertrain 220 includes a first clutch 225 operably coupled to the ICE 11 and the sun gear 224. The first motor-generator 12 is operably coupled to the planet carrier 223. The ring gear 222 is coupled to the first traction ring (R1). The second motor-generator 13 is coupled to the second traction (R2).

In some embodiments, the hybrid powertrain 220 includes a brake 226 operably coupled to the carrier assembly (C).

During operation of the hybrid powertrain 220, power is transmitted in at least two modes of operation. A first mode of operation is established as the variator 17 is used as a differential element as is the planetary gear set 221 when the carrier assembly (C) is free to rotate. In other words, the first mode of operation corresponds to a disengaged position of the brake 226. A second mode of operation is established as the variator 17 is used as a mechanical transmission when the brake 226 is applied to ground the carrier assembly (C).

Referring now to FIG. 24; in some embodiments, a hybrid powertrain 230 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 230 include a planetary gear set 231 arranged coaxially with the ICE 11. The planetary gear set 231 includes a ring gear 232, a planet carrier 233, and a sun gear 234. In some embodiments, the hybrid powertrain 230 includes a first clutch 235 operably coupled to the ICE 11 and the sun gear 234. The first motor-generator 12 is operably coupled to the planet carrier 233. The ring gear 232 is coupled to a second clutch 236. The second clutch 236 is coupled to the first traction ring (R1). The second motor-generator 13 is coupled to the second traction (R2). In some embodiments, the hybrid powertrain 230 includes a brake 237 operably coupled to the carrier assembly (C).

During operation of the hybrid powertrain 230, power is transmitted in at least two modes of operation. A first mode of operation is established as the variator 17 is used as a differential element as is the planetary gear set 231 when the carrier assembly (C) is free to rotate. In other words, the first mode of operation corresponds to a disengaged position of the brake 237. A second mode of operation is established as the variator 17 is used as a mechanical transmission when the brake 237 is applied to ground the carrier assembly (C).

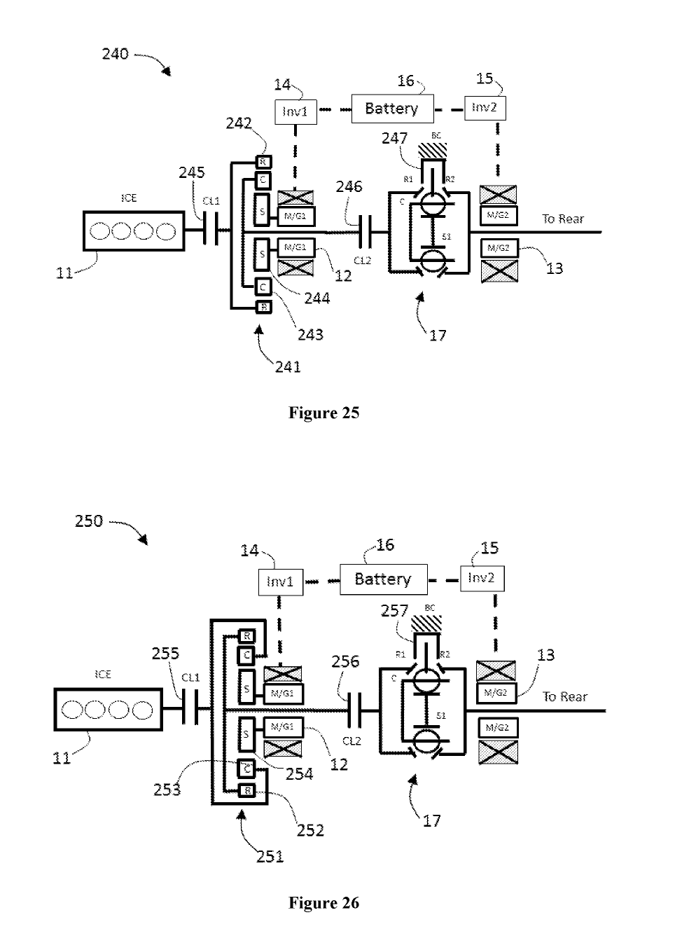

Passing now to FIG. 25; in some embodiments, a hybrid powertrain 240 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 240 include a planetary gear set 241 arranged coaxially with the ICE 11. The planetary gear set 241 includes a ring gear 242, a planet carrier 243, and a sun gear 244. In some embodiments, the hybrid powertrain 240 includes a first clutch 245 operably coupled to the ICE 11 and the ring gear 242. The first motor-generator 12 is operably coupled to the sun gear 244. The planet carrier 243 is coupled to a second clutch 246. The second clutch 246 is coupled to the first traction ring (R1). The second motor-generator 13 is coupled to the second traction (R2). In some embodiments, the hybrid powertrain 240 includes a brake 247 operably coupled to the carrier assembly (C).

During operation of the hybrid powertrain 240, power is transmitted in at least two modes of operation. A first mode of operation is established as the variator 17 is used as a differential element as is the planetary gear set 241 when the carrier assembly (C) is free to rotate. In other words, the first mode of operation corresponds to a disengaged position of the brake 247. A second mode of operation is established as the variator 17 is used as a mechanical transmission when the brake 247 is applied to ground the carrier assembly (C).

Referring now to FIG. 26; in some embodiments, a hybrid powertrain 250 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 250 include a planetary gear set 251 arranged coaxially with the ICE 11. The planetary gear set 251 includes a ring gear 252, a planet carrier 253, and a sun gear 254. In some embodiments, the hybrid powertrain 250 includes a first clutch 255 operably coupled to the ICE 11 and the planet carrier 253. The first motor-generator 12 is operably coupled to the sun gear 254. The ring gear 252 is coupled to a second clutch 256. The second clutch 256 is coupled to the first traction ring (R1). The second motor-generator 13 is coupled to the second traction (R2). In some embodiments, the hybrid powertrain 250 includes a brake 257 operably coupled to the carrier assembly (C).

During operation of the hybrid powertrain 250, power is transmitted in at least two modes of operation. A first mode of operation is established as the variator 17 is used as a differential element as is the planetary gear set 251 when the carrier assembly (C) is free to rotate. In other words, the first mode of operation corresponds to a disengaged position of the brake 257. A second mode of operation is established as the variator 17 is used as a mechanical transmission when the brake 257 is applied to ground the carrier assembly (C).

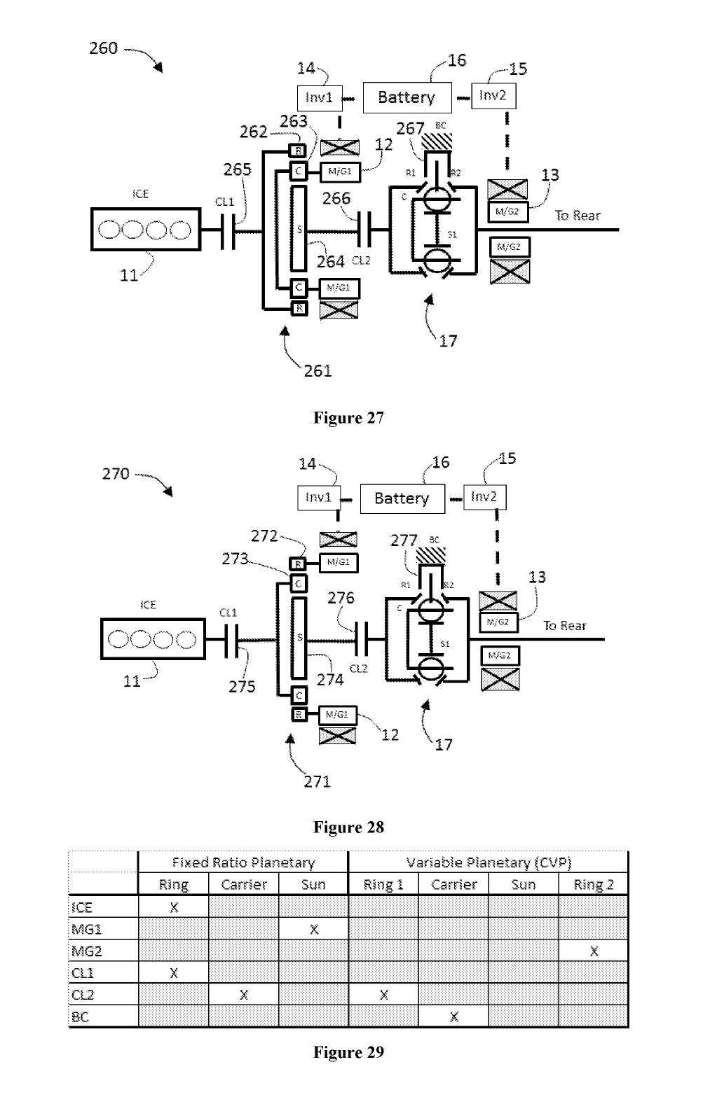

Turning now to FIG. 27; in some embodiments, a hybrid powertrain 260 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 260 include a planetary gear set 261 arranged coaxially with the ICE 11. The planetary gear set 261 includes a ring gear 262, a planet carrier 263, and a sun gear 264. In some embodiments, the hybrid powertrain 260 includes a first clutch 265 operably coupled to the ICE 11 and the ring gear 262. The first motor-generator 12 is operably coupled to the planet carrier 263. The sun gear 264 is coupled to a second clutch 266. The second clutch 266 is coupled to the first traction ring (R1). The second motor-generator 13 is coupled to the second traction (R2). In some embodiments, the hybrid powertrain 260 includes a brake 267 operably coupled to the carrier assembly (C).

During operation of the hybrid powertrain 260, power is transmitted in at least two modes of operation. A first mode of operation is established as the variator 17 is used as a differential element as is the planetary gear set 261 when the carrier assembly (C) is free to rotate. In other words, the first mode of operation corresponds to a disengaged position of the brake 267. A second mode of operation is established as the variator 17 is used as a mechanical transmission when the brake 267 is applied to ground the carrier assembly (C).

Passing now to FIG. 28; in some embodiments, a hybrid powertrain 270 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 270 include a planetary gear set 271 arranged coaxially with the ICE 11. The planetary gear set 271 includes a ring gear 272, a planet carrier 273, and a sun gear 274. In some embodiments, the hybrid powertrain 270 includes a first clutch 275 operably coupled to the ICE 11 and the planet carrier 273. The first motor-generator 12 is operably coupled to the ring gear 272. The sun gear 274 is coupled to a second clutch 276. The second clutch 276 is coupled to the first traction ring (R1). The second motor-generator 13 is coupled to the second traction (R2). In some embodiments, the hybrid powertrain 270 includes a brake 277 operably coupled to the carrier assembly (C).

During operation of the hybrid powertrain 270, power is transmitted in at least two modes of operation. A first mode of operation is established as the variator 17 is used as a differential element as is the planetary gear set 271 when the carrier assembly (C) is free to rotate. In other words, the first mode of operation corresponds to a disengaged position of the brake 277. A second mode of operation is established as the variator 17 is used as a mechanical transmission when the brake 277 is applied to ground the carrier assembly (C).

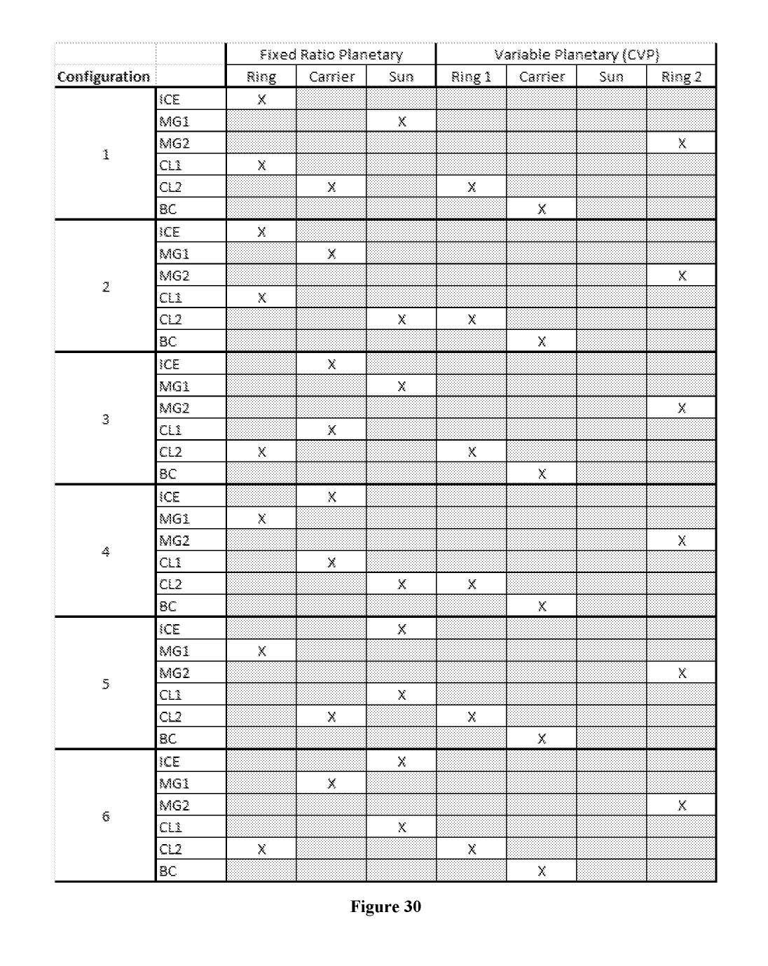

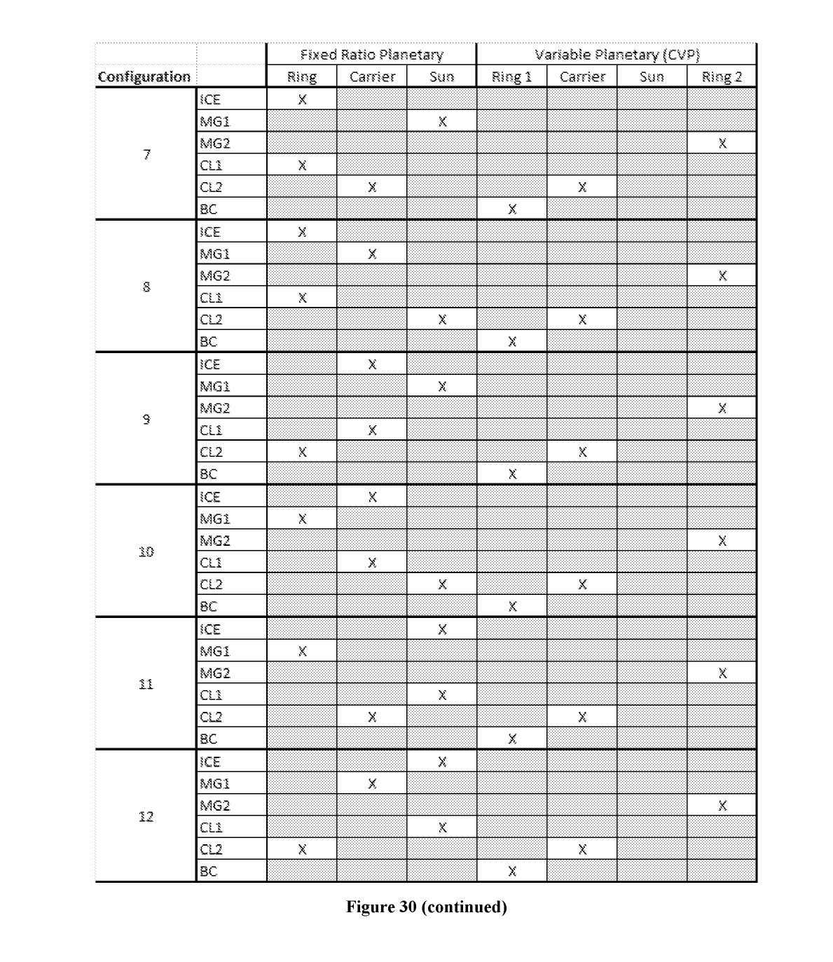

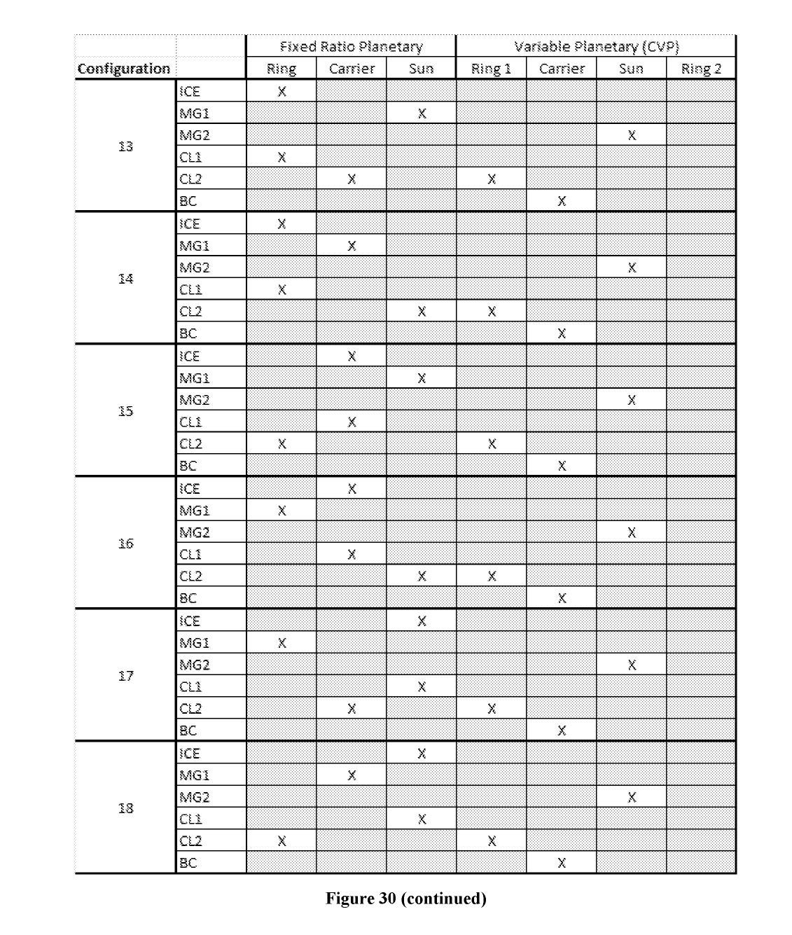

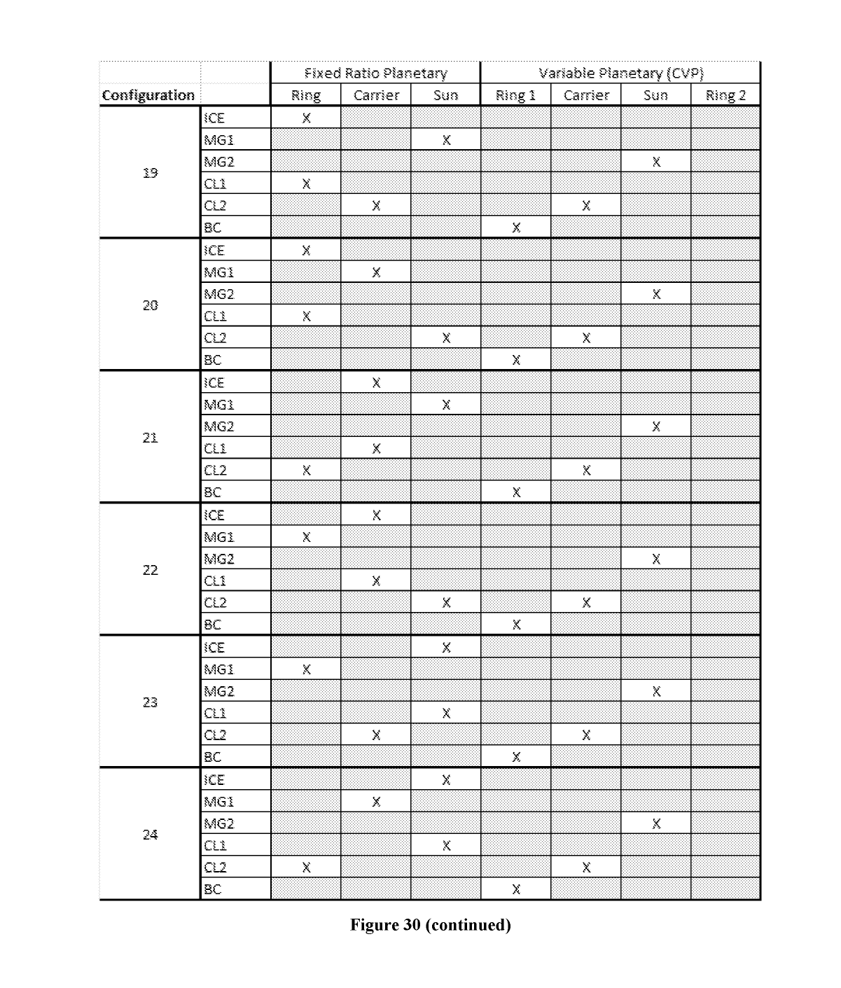

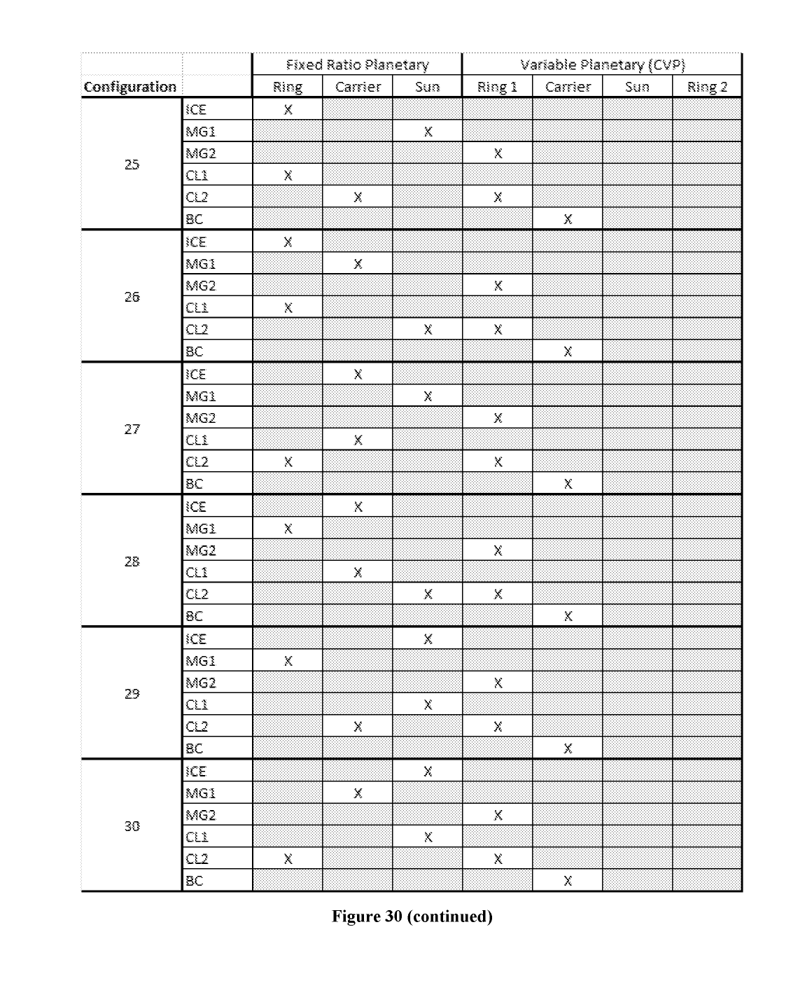

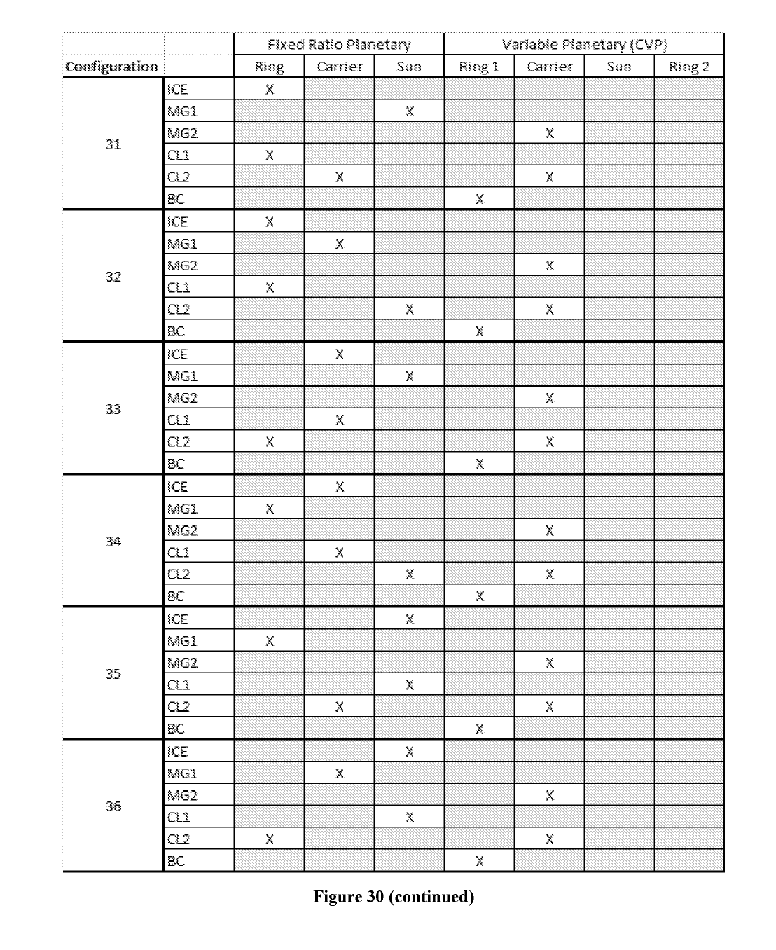

Turning now to FIGS. 29 and 30, and still referring to FIG. 25; the hybrid powertrain 240 can be described in a table as depicted in FIG. 29. The rows of the table include the ICE 11 (“ICE”), the first motor-generator 12 (“MG1”), the second motor-generator 13 (“MG2”), the first clutch 245 (“CL1”), the second clutch 246 (“CL2”), and the brake 247 (“BC”). The columns of the table include components of the planetary gear set 241 and the variator 17. The “X” denotes a coupling between the row component and the column component. For clarity and conciseness, the hybrid powertrain 240 is provided as an illustrative example. It should be appreciated that a number of hybrid powertrain configurations can be configured by coupling the components as indicated in the table provided in FIG. 30.

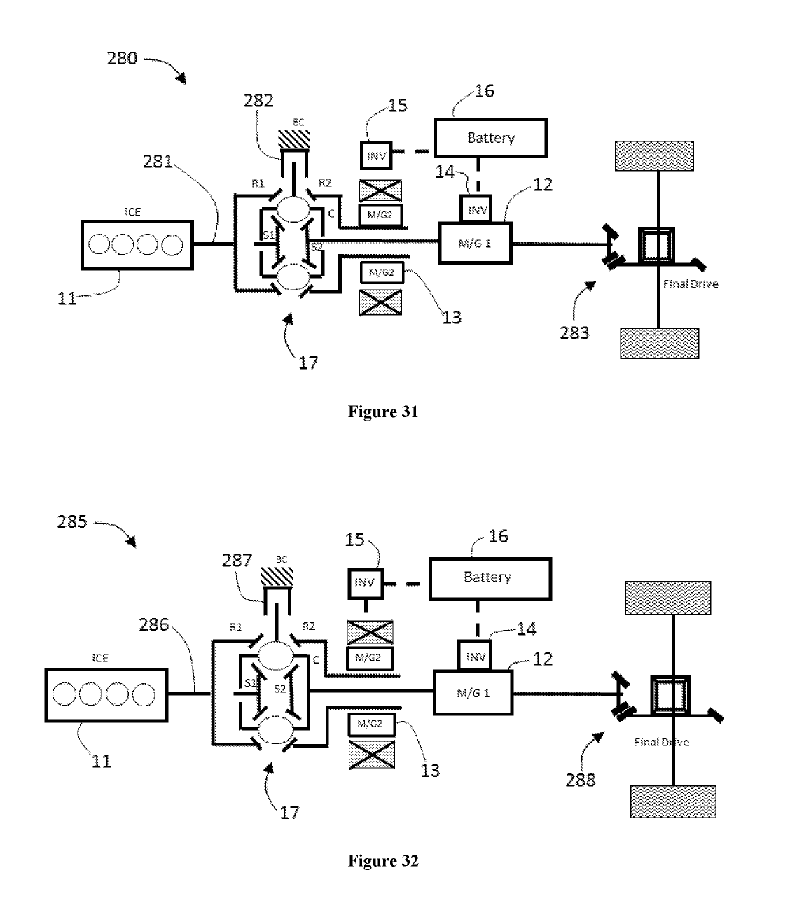

Referring now to FIG. 31; in some embodiments, a hybrid powertrain 280 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 280 has a first rotatable shaft 281 coupled to the ICE 11. The first rotatable shaft 281 forms a main axis of the hybrid powertrain 280. The first rotatable shaft 281 is coupled to the first traction ring (R1). The first motor-generator 12 is operably coupled to the sun assembly (S2) of the variator 17. The second motor-generator 13 is operably coupled to the second traction ring (R2). A brake 282 is coupled to the carrier assembly (C). The first motor-generator 12 is operably coupled to a final drive assembly 283.

Turning now to FIG. 32; in some embodiments, a hybrid powertrain 285 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 285 has a first rotatable shaft 286 coupled to the ICE 11. The first rotatable shaft 286 forms a main axis of the hybrid powertrain 285. The first rotatable shaft 286 is coupled to the first traction ring (R1). The first motor-generator 12 is operably coupled to the sun assembly (S2) of the variator 17. The second motor-generator 13 is operably coupled to the second traction ring (R2). A brake 287 is coupled to the carrier assembly (C). The first motor-generator 12 is operably coupled to a final drive assembly 288.

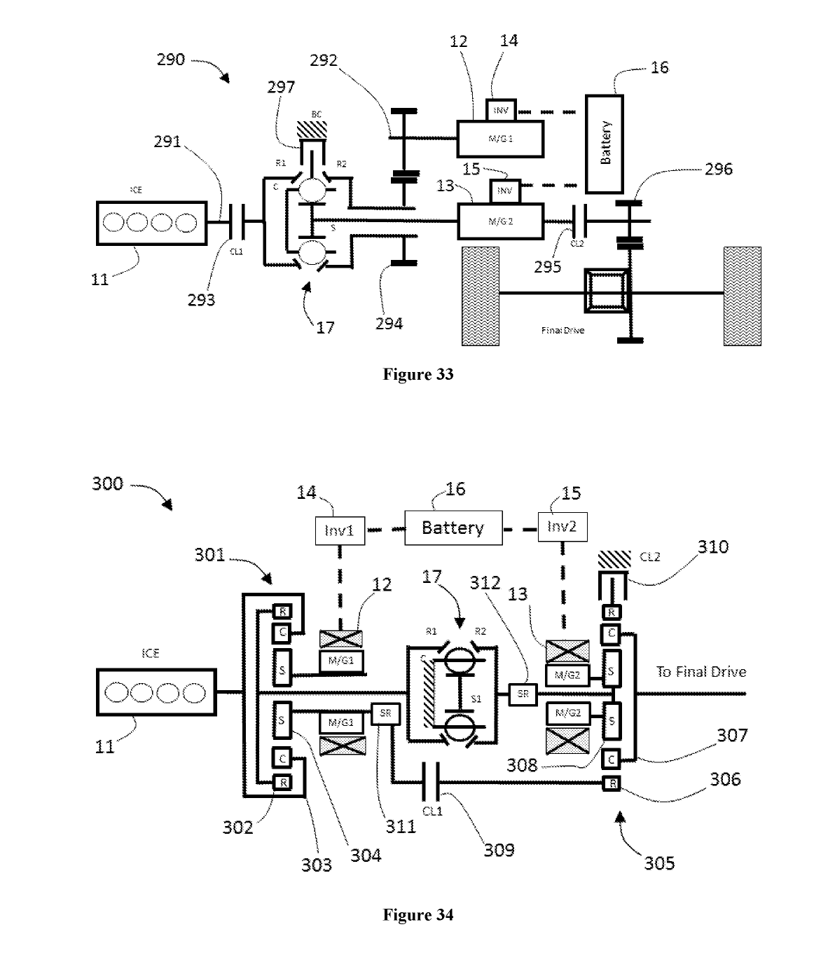

Turning to FIG. 33; in some embodiments, a hybrid powertrain 290 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. The hybrid powertrain 290 includes a first rotatable shaft 291 coupled to the ICE 11. The first rotatable shaft 291 forms a main axis of the hybrid powertrain 290. The hybrid powertrain 290 includes a second rotatable shaft 292 aligned substantially parallel to the main axis, the second rotatable shaft 292 forms a counter axis. The hybrid powertrain 290 includes a first clutch (CL1) 293 coupled to the ICE 11 and the first traction ring (R1). The hybrid powertrain 290 has a first gear set 294 operably coupled to the second traction ring (R2) and the second rotatable shaft 292. The first motor-generator 12 is coaxial with the second rotatable shaft 292 and is operably coupled to the first gear set 294. The second motor-generator 13 is coupled to the sun (S). The second motor-generator 13 is aligned coaxially with the main axis. The hybrid powertrain 290 includes a second clutch (CL2) 295 operably coupled to the second motor-generator 13. The second clutch 295 is configured to couple to a final drive gear set 296. The hybrid powertrain 290 includes a brake 297 coupled to the carrier assembly.

Referring to FIG. 34, in some embodiments, a hybrid powertrain 300 includes the ICE 11, the first motor-generator 12, the second motor-generator 13, and the variator 17. The first motor-generator 12 is configured to be in electrical communication with a first inverter 14. The second motor-generator 13 is configured to be in electrical communication with a second inverter 15. The first inverter 14 and the second inverter 15 are configured to be in electrical communication with a battery 16. In some embodiments, the hybrid powertrain includes a first planetary gear set 301 having a first ring gear 302, a first planet carrier 303, and a first sun gear 304. In some embodiments, the first sun gear 304 is coupled to the first motor-generator 12. The first planet carrier 303 is operably coupled to the ICE 11. The first ring gear 302 is operably coupled to the first traction ring assembly of the variator 17. In some embodiments, the hybrid powertrain 300 includes a second planetary gear set 305 having a second ring gear 306, a second planet carrier 307, and a second sun gear 308. In some embodiments, the second sun gear 308 is operably coupled to the second motor-generator 13. The second planet carrier 307 is configured to operably couple to a final drive gear (not shown). The second sun gear 308 is operably coupled to the second traction ring assembly of the variator 17. In some embodiments, the hybrid powertrain 300 is provided with a first clutch 309 coupled to the first sun gear 302 and the second ring gear 306. The hybrid powertrain 300 includes a second clutch 310 operably coupled to the second ring gear 307. The second clutch 310 selectively couples the second ring gear 307 to ground. In some embodiments, the second clutch 310 is configured as a brake. In some embodiments, the hybrid powertrain 300 is optionally configured with a first step gear 311 arranged to operably couple first sun gear 302 to the first clutch 309. In some embodiments, the hybrid powertrain 300 is optionally configured with a second step gear 312 arranged to operably couple the second sun gear 308 to the second traction ring assembly of the variator 17. It should be appreciated that a designer has within his means to configure and adapt the first step gear 311 and second step gear 312 as needed to implement couplings of shafts and devices.

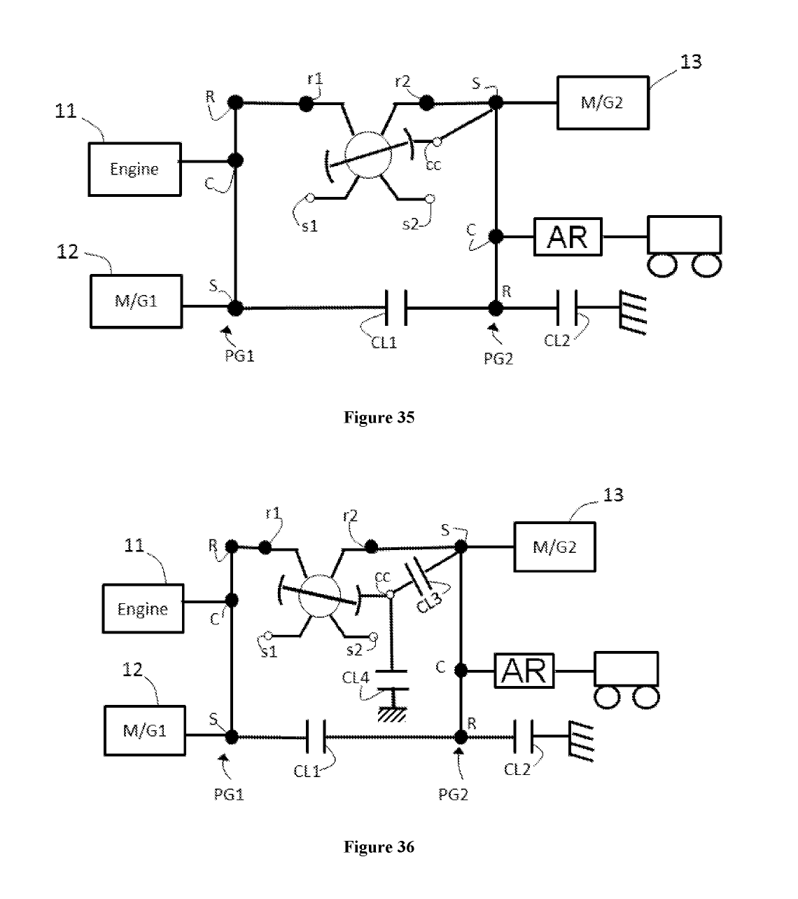

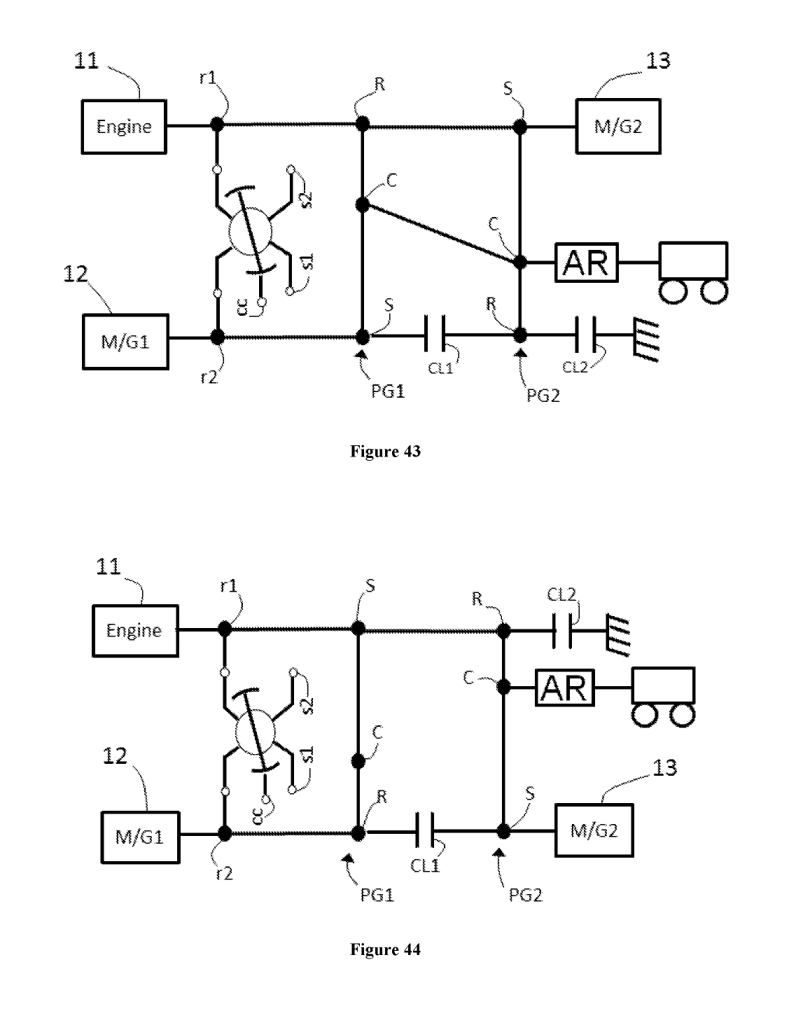

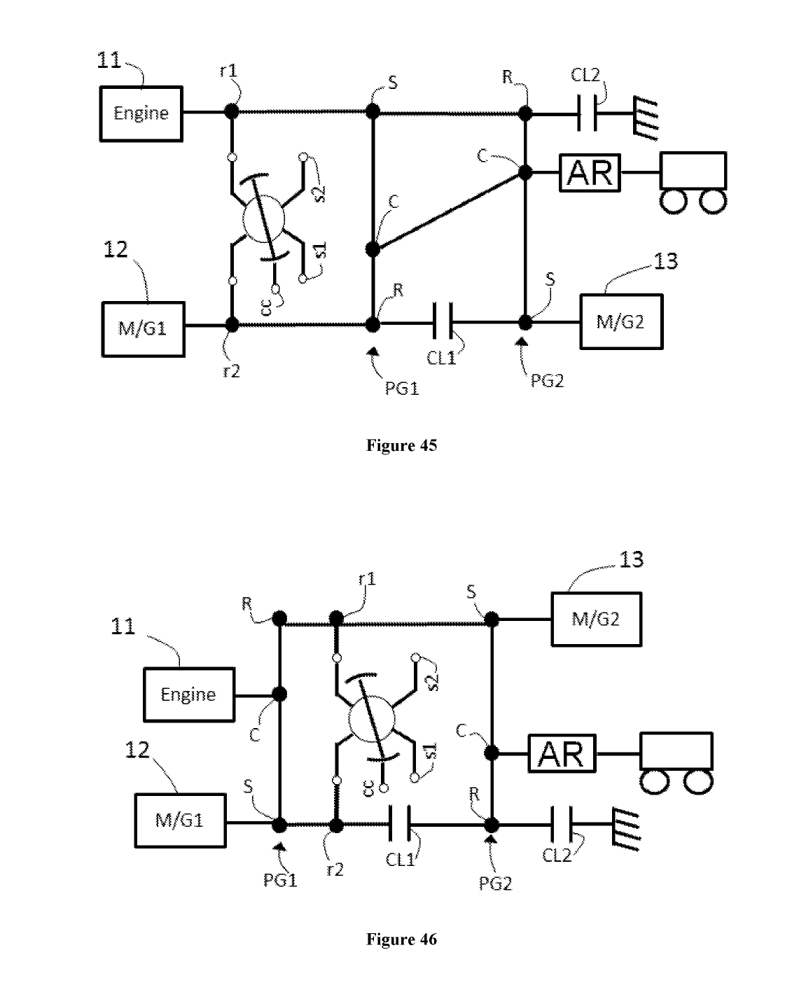

Passing now to FIGS. 35-49; a number of embodiments of hybrid powertrains incorporating two planetary gear sets and a variator (CVP) will be described. For purposes of description, schematics referred to as lever diagrams are used herein. A lever diagram, also known as a lever analogy diagram, is a translational-system representation of rotating parts for a planetary gear system. In certain embodiments, a lever diagram is provided as a visual aid in describing the functions of the transmission. In a lever diagram, a compound planetary gear set is often represented by a single vertical line (“lever”). The input, output, and reaction torques are represented by horizontal forces on the lever. The lever motion, relative to the reaction point, represents direction of rotational velocities.

Referring now to FIG. 35; a lever diagram representing the hybrid powertrain 300 is depicted. As used herein, the label “Engine” refers to an ICE such as the ICE 11; the label “M/G1” refers to a first motor-generator such as the first motor-generator 12; the label “M/G2” refers to a second motor-generator such as the second motor-generator 13. A first vertical line labeled “PG1” refers to a first planetary gear set such as the first planetary gear set 301. Solid dots arranged on the vertical line are labeled “R”, “C”, and “S” to indicate a ring node, a carrier node, and a sun node of the first planetary gear set. A second vertical line labeled “PG2” refers to a second planetary gear set such as the second planetary gear set 302. Solid dots arranged on the vertical line are labeled “R”, “C”, and “S” to indicate a ring node, a carrier node, and a sun node of the second planetary gear set. The label “AR” refers to a final drive ratio to the wheels of a vehicle equipped with the hybrid powertrain. A variator device is represented schematically in the lever diagram having nodes labeled “r1”, “r2”, “cc”, “s1”, and “s2” representing the first traction ring assembly, the second traction ring assembly, the carrier assembly, the first sun member, and the second sun member, respectively. It should be noted that the variator depicted in the lever diagrams of FIG. 35-49 is substantially similar to the variator 17. The label “CL1” refers to a first clutch device such as a first clutch 309. The label “CL2” refers to a second clutch device such as a second clutch 310.

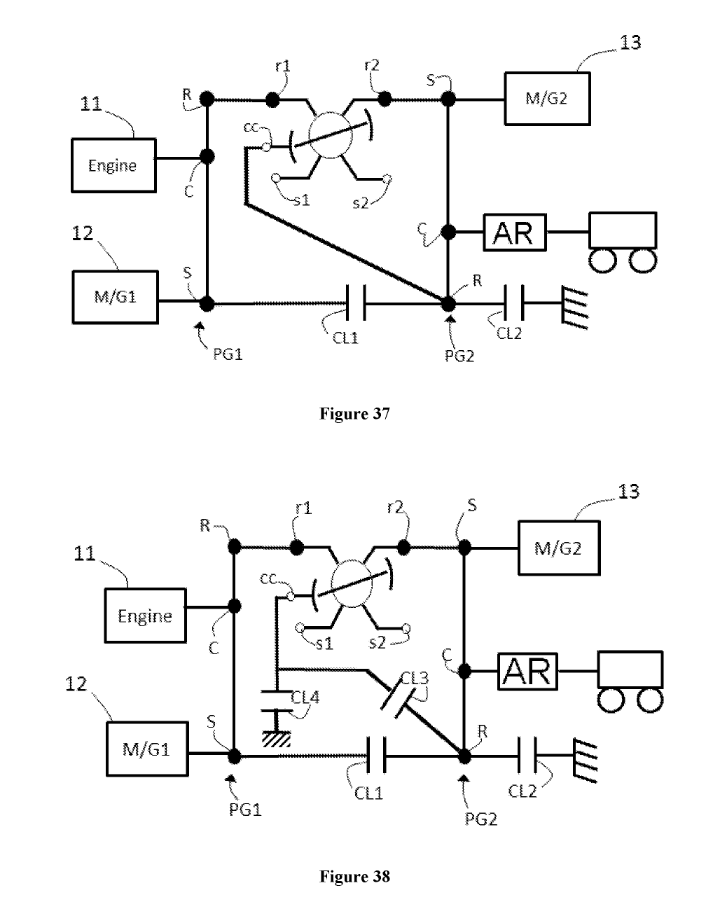

Referring now to FIGS. 36 and 37; in some embodiments, a hybrid powertrain is provided with a third clutch (CL3) configured to couple the carrier assembly of the variator to the sun gear of the second planetary gear set. Additionally, the hybrid powertrain is provided with a fourth clutch (CL4) configured to selectively ground the carrier assembly of the variator. Multiple operating modes of the hybrid powertrain are achieved through the selective engagement of the clutch devices. For example, the lever diagram depicted in FIG. 37 represents an operating mode corresponding to engagement of the third clutch (CL3) and the disengagement of the fourth clutch (CL4) to thereby couple the carrier assembly of the variator to the sun gear of the second planetary gear set. When the third clutch (CL3) is disengaged, and the fourth clutch (CL4) is engaged to ground the carrier assembly of the variator, the hybrid powertrain operates in a mode depicted in the lever diagram of FIG. 35.

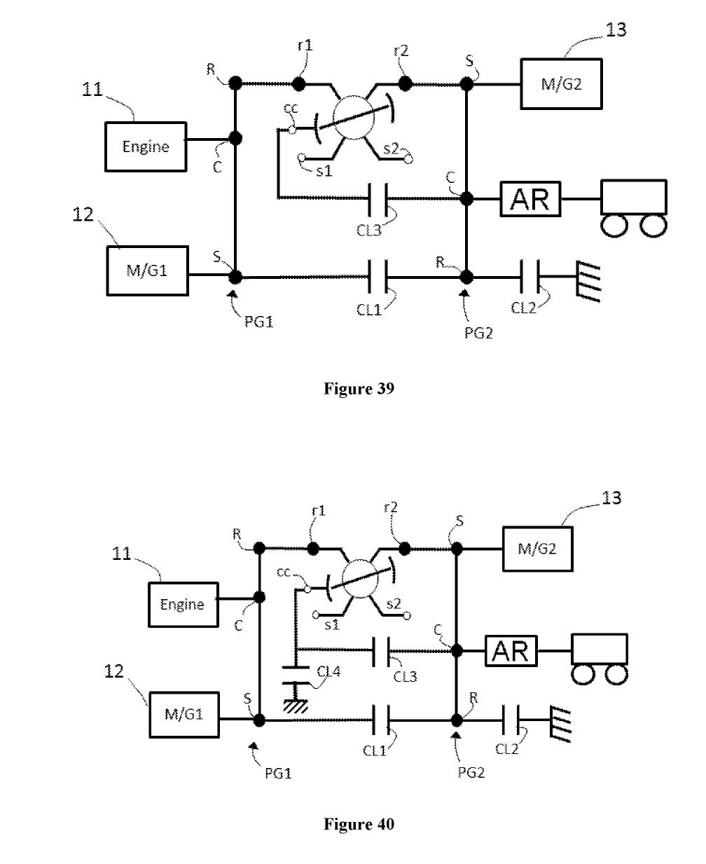

Referring now to FIGS. 38 and 39; in some embodiments, a hybrid powertrain is provided with a third clutch (CL3) configured to couple the carrier assembly of the variator to the ring gear of the second planetary gear set. Additionally, the hybrid powertrain is provided with a fourth clutch (CL4) configured to selectively ground the carrier assembly of the variator. Multiple operating modes of the hybrid powertrain are achieved through the selective engagement of the clutch devices. For example, the lever diagram depicted in FIG. 39 represents an operating mode corresponding to engagement of the third clutch (CL3) and the disengagement of the fourth clutch (CL4) to thereby couple the carrier assembly of the variator to the ring gear of the second planetary gear set. When the third clutch (CL3) is disengaged, and the fourth clutch (CL4) is engaged to ground the carrier assembly of the variator, the hybrid powertrain operates in a mode depicted in the lever diagram of FIG. 35.

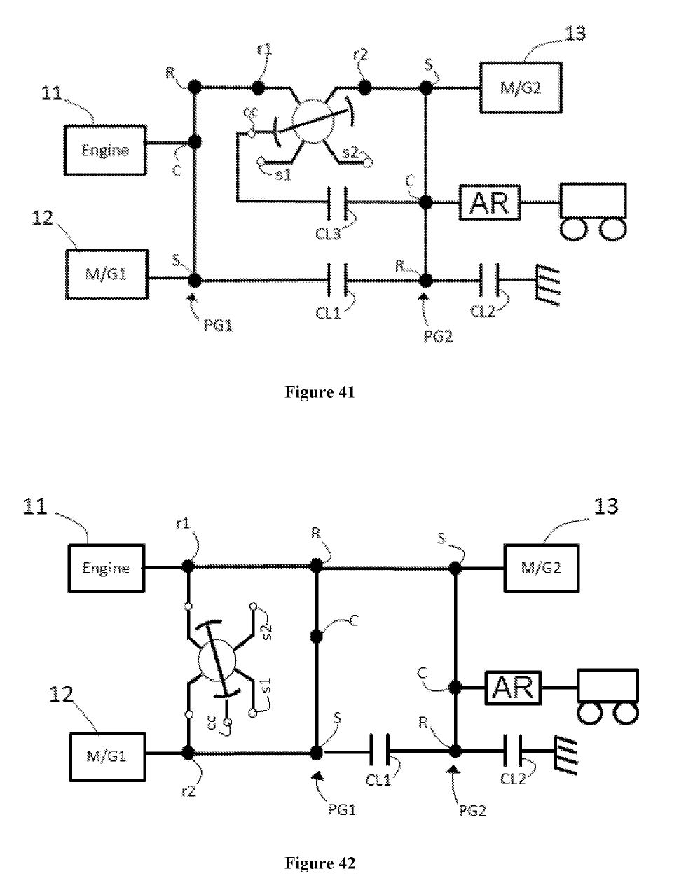

Referring now to FIGS. 40 and 41; in some embodiments, a hybrid powertrain is provided with a third clutch (CL3) configured to couple the carrier assembly of the variator to the planet carrier of the second planetary gear set. Additionally, the hybrid powertrain is provided with a fourth clutch (CL4) configured to selectively ground the carrier assembly of the variator. Multiple operating modes of the hybrid powertrain are achieved through the selective engagement of the clutch devices. For example, the lever diagram depicted in FIG. 41 represents an operating mode corresponding to engagement of the third clutch (CL3) and the disengagement of the fourth clutch (CL4) to thereby couple the carrier assembly of the variator to the planet carrier of the second planetary gear set. When the third clutch (CL3) is disengaged, and the fourth clutch (CL4) is engaged to ground the carrier assembly of the variator, the hybrid powertrain operates in a mode depicted in the lever diagram of FIG. 35.

Referring now to FIGS. 42-45; a number of lever diagrams depicting hybrid powertrain configurations having two planetary gear sets and a variator are depicted. The configurations depicted in FIGS. 42-45 are arranged in such a way as to route all power from the engine to the variator.

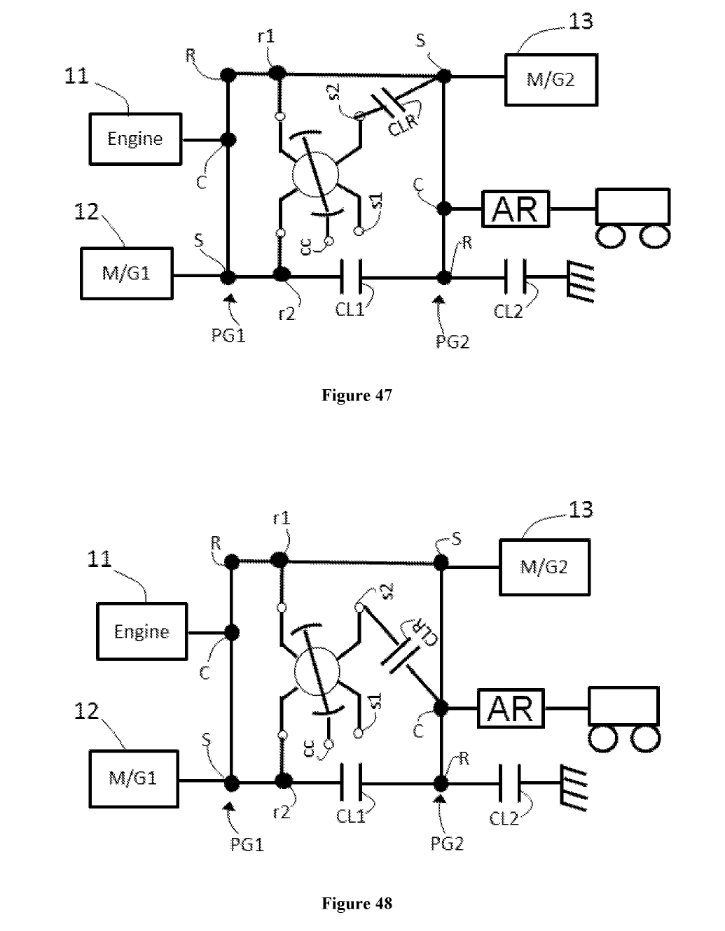

Referring now to FIGS. 46-48; a number of lever diagrams depicting hybrid powertrain configurations having two planetary gear sets and a variator are depicted. The configurations depicted in FIGS. 46-48 are arranged in such a way as to split power from the engine between the variator and the planetary gear sets. A reverse clutch (CLR) is depicted in FIGS. 47 and 48. In some embodiments, the reverse clutch is operably coupled to a sun node of the variator and the sun gear of the second planetary gear set. In some embodiments, the reverse clutch is operably coupled to the sun node of the variator and the planet carrier of the second planetary gear set.

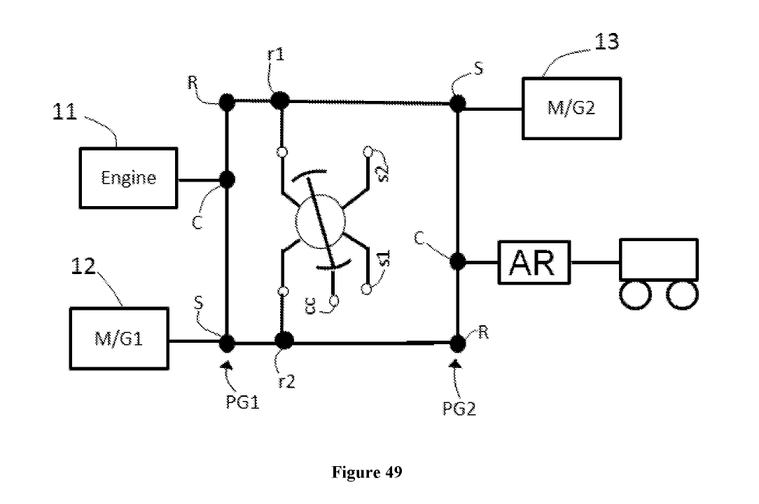

Referring now to FIG. 49; a lever diagram of a hybrid powertrain configuration having two planetary gear sets and a variator is depicted. The first planetary gear set is labeled “PG1” and includes a first ring node (R), a first carrier node (C), and a first sun node (S). In some embodiments, the hybrid powertrain includes an engine coupled to a first carrier node (C). A first motor-generator is coupled to the first sun node (S). The variator includes a first traction ring node (r1), a second traction ring node (r2), a variator carrier node (c), and variator sun nodes (s1 and s2). The first traction ring node r1 is operably coupled to the first sun node. The second traction ring node r2 is operably coupled to the first ring node R. In some embodiments, the hybrid powertrain includes a second planetary gear set labeled “PG2”. The second planetary gear set (PG2) includes a second ring node (R), a second carrier node (C), and a second sun node (S). In some embodiments, an output power is transmitting from the second carrier node to an axle of a vehicle. The second ring node is operably coupled to the first traction ring node. In some embodiments, the second sun node is operably coupled to a second motor-generator. In some embodiments, the variator carrier node and one of the variator sun nodes are optionally coupled to nodes of the first planetary gear set or the second planetary gear set. For example, one of the variator sun nodes (for example, “s1”) is optionally coupled to the second planet carrier. In some embodiments, the s1 node is optionally coupled to the second sun gear.

It should be noted that in any of the embodiments presented herein, the first motor-generator (MG1) or the second motor-generator (MG2) are optionally coupled to any of the variator nodes or planetary gear set nodes. It should be appreciated that the first planetary gear set (PG1) and the second planetary gear set (PG2) are optionally configured as any epicyclic gear set such as, but not limited to, a simple planetary, compound, or compound split. It should be further noted that the addition of clutches or brakes to any of the embodiments disclosed herein is within a designer's means to provide additional modes of operation to the hybrid powertrains. Likewise, the addition of stepped gears, belt-and-pulley devices, or chain drive devices to route power to the engine, motor-generators, or other devices incorporated into the hybrid powertrain are within the designer's choice.

Embodiments of hybrid powertrains disclosed herein are optionally configured as compound split systems with a variator such as the ones described having nodes connected in any combination to the planetary gear sets, or the epicyclic gears, to create a compound split system such that the combined lever (involving variator and two epicyclic gears) has a variable total number of nodes (depending on how the system is connected) to which one or more powerplant devices such as the ICE, or other powerplant, and two or more electric machines can be tied to. It should be appreciated that the use of variator in such combinations to create a compound split multi-node with all permutations of connections with or without additional clutches and speed ratios are disclosed herein.

It should be noted that where an ICE is described, the ICE is optionally an internal combustion engine (diesel, gasoline, hydrogen) or any powerplant such as a fuel cell system, or any hydraulic/pneumatic powerplant like an air-hybrid system. Along the same lines, the battery is optionally not just a high voltage pack such as lithium ion or lead-acid batteries, but also ultracapacitors or other pneumatic/hydraulic systems such as accumulators, or other forms of energy storage systems. MG1 and MG2 optionally represent hydromotors actuated by variable displacement pumps, electric machines, or any other form of rotary power such as pneumatic motors driven by pneumatic pumps. The eCVT architectures depicted in the figures and described in text are optionally extended to create a hydro-mechanical CVT architectures as well for hydraulic hybrid systems. It should be appreciated that the hybrid architectures disclosed herein optionally also include additional clutches, brakes, and couplings to three nodes of the CVP.

It should be noted that the description above has provided dimensions for certain components or subassemblies. The mentioned dimensions, or ranges of dimensions, are provided in order to comply as best as possible with certain legal requirements, such as best mode. However, the scope of the inventions described herein are to be determined solely by the language of the claims, and consequently, none of the mentioned dimensions is to be considered limiting on the inventive embodiments, except in so far as any one claim makes a specified dimension, or range of thereof, a feature of the claim.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein are optionally employed in practicing the invention. It is intended that the following claims define the scope of the invention and that methods and structures within the scope of these claims and their equivalents be covered thereby.

Various embodiments as described herein are provided in the Aspects below:

Aspect 1: A hybrid powertrain comprising:
a first rotatable shaft operably coupleable to a source of rotational power;
a second rotatable shaft coaxial to the first rotatable shaft, the first rotatable shaft and the second rotatable shaft forming a main axis;
a third rotatable shaft parallel to the main axis;
a fourth rotatable shaft coaxial with the third rotatable shaft;
a fifth rotatable shaft parallel to the main axis;
a variator assembly having a first traction ring and a second traction ring in contact with a plurality of traction planets, each traction planet having a tiltable axis of rotation, each traction planet supported in a carrier assembly, each traction planet in contact with a sun assembly;
wherein the variator assembly is coaxial with the third rotatable shaft;
wherein the first traction ring is operably coupled to the third rotatable shaft;
wherein the sun assembly is coupled to the fourth rotatable shaft;
a planetary gearset having a planet carrier, a sun gear, and a ring gear, the planetary gearset coaxial with the second rotatable shaft, the second rotatable shaft coupled to the sun gear;
a first motor-generator positioned coaxially with the second rotatable shaft;
a second motor-generator coaxial with the fifth rotatable shaft, the second motor-generator operably coupled to the second traction ring;
a first clutch operably coupled to the first rotatable shaft, the first clutch coupled to the ring gear;
a second clutch coupled to the fourth rotatable shaft, the second clutch operably coupled to the first motor-generator; and
a brake clutch operably coupled to the carrier assembly.

Aspect 2: The hybrid powertrain of Aspect 1, further comprising a first gear set configured to couple the planet carrier to the third rotatable shaft.

Aspect 3: The hybrid powertrain of one of Aspects 1 or 2, further comprising a second gear set configured to couple the first motor-generator to the second clutch.

Aspect 4: The hybrid powertrain of one of Aspects 1, 2, or 3, further comprising a third gear set configured to couple the second traction ring to the fifth rotatable shaft.

Aspect 5: The hybrid powertrain of one of Aspects 1-4, further comprising a first inverter in electrical communication with the first motor-generator.

Aspect 6: The hybrid powertrain of one of Aspects 1-5, further comprising a second inverter in electrical communication with the second motor-generator.

Aspect 7: The hybrid powertrain of one of Aspects 1-6, further comprising a battery in electrical communication with the first inverter and the second inverter.

Aspect 8: The hybrid powertrain of one of Aspects 1-7, further comprising a final drive gear operably coupled to the second motor-generator.

Aspect 9: A hybrid powertrain comprising:
a first rotatable shaft operably coupleable to a source of rotational power;
a second rotatable shaft coaxial to the first rotatable shaft, the first rotatable shaft and the second rotatable shaft forming a main axis;
a third rotatable shaft parallel to the main axis;
a fourth rotatable shaft coaxial with the third rotatable shaft;
a fifth rotatable shaft parallel to the main axis;
a variator assembly having a first traction ring and a second traction ring in contact with a plurality of traction planets, each traction planet having a tiltable axis of rotation, each traction planet supported in a carrier assembly, each traction planet in contact with a sun assembly;
wherein the variator assembly is coaxial with the third rotatable shaft;
wherein the first traction ring is operably coupled to the third rotatable shaft;
wherein the carrier assembly is coupled to the fourth rotatable shaft;
a planetary gearset having a planet carrier, a sun gear, and a ring gear, the planetary gearset coaxial with the second rotatable shaft, the second rotatable shaft coupled to the sun gear;
a first motor-generator coaxial with the second rotatable shaft;
a second motor-generator coaxial with the fifth rotatable shaft, the second motor-generator operably coupled to the second traction ring;
a first clutch operably coupled to the first rotatable shaft, the first clutch coupled to the ring gear;
a second clutch coupled to the fourth rotatable shaft, the second clutch operably coupled to the first motor-generator; and
a brake clutch operably coupled to the carrier assembly.

Aspect 10: The hybrid powertrain of Aspect 9, further comprising a first gear set configured to couple the planet carrier to the third rotatable shaft.

Aspect 11: The hybrid powertrain of one of Aspects 9 or 10, further comprising a second gear set configured to couple the second rotatable shaft to the second clutch.

Aspect 12: The hybrid powertrain of one of Aspects 9. 10, or 11, further comprising a third gear set configured to couple the second traction ring to the fifth rotatable shaft.

Aspect 13: The hybrid powertrain of one of Aspects 9-12, further comprising a first inverter in electrical communication with the first motor-generator.

Aspect 14: The hybrid powertrain of one of Aspects 9-13, further comprising a second inverter in electrical communication with the second motor-generator.

Aspect 15: The hybrid powertrain of one of Aspects 9-14, further comprising a battery in electrical communication with the first inverter and the second inverter.

Aspect 16: The hybrid powertrain of one of Aspects 9-15, further comprising a final drive gear operably coupled to the second motor-generator.

Aspect 17: A hybrid powertrain comprising:
a first rotatable shaft operably coupleable to a source of rotational power;
a second rotatable shaft coaxial to the first rotatable shaft, the first rotatable shaft and the second rotatable shaft forming a main axis;
a third rotatable shaft parallel to the main axis;
a variator assembly having a first traction ring and a second traction ring in contact with a plurality of traction planets, each traction planet having a tiltable axis of rotation, each traction planet supported in a carrier assembly, each traction planet in contact with a sun assembly;
wherein the variator assembly is coaxial with the main axis;
wherein the second traction ring is operably coupled to the third rotatable shaft;
wherein the sun assembly is coupled to the second rotatable shaft;
a first motor-generator coaxial with the second rotatable shaft;
a second motor-generator coaxial with the third rotatable shaft;
a first clutch operably coupled to the first rotatable shaft, the first clutch coupled to the first traction ring;
a second clutch coupled to the second rotatable shaft, the second clutch coupled to the first motor-generator; and
a first brake clutch operably coupled to the carrier assembly.

Aspect 18: The hybrid powertrain of Aspect 17, further comprising a gear set configured to couple the second traction ring to the third rotatable shaft.

Aspect 19: The hybrid powertrain of one of Aspects 18 or 19, further comprising a first inverter in electrical communication with the first motor-generator.

Aspect 20: The hybrid powertrain of one of Aspects 18 or 19, further comprising a second inverter in electrical communication with the second motor-generator.

Aspect 21: The hybrid powertrain of one of Aspects 18, 19 or 20, further comprising a battery in electrical communication with the first inverter and the second inverter.

Aspect 22: The hybrid powertrain of one of Aspects 17-21, further comprising a final drive gear operably coupled to the second motor-generator.

Aspect 23: The hybrid powertrain of one of Aspects 17-22, further comprising a one-way clutch configured to couple the first traction ring and the carrier assembly.

Aspect 24: The hybrid powertrain of one of Aspects 17-23, wherein the second clutch is a two position clutch configured to selectively couple to the carrier assembly and the sun assembly to the second rotatable shaft.

Aspect 25: The hybrid powertrain of one of Aspects 17-24, further comprising a second brake operably coupled to the second rotatable shaft.

Aspect 26: They hybrid powertrain of one of Aspects 17-25, further comprising a one-way clutch configured to couple the first traction ring to the sun assembly.

Aspect 27: The hybrid powertrain of one of Aspects 17-24, further comprising a one-way clutch configured to couple the first traction ring to the carrier assembly.

Aspect 28: They hybrid powertrain of one of Aspects 17-24, further comprising a one-way clutch configured to couple the first traction ring to the sun assembly.

Aspect 29: A hybrid powertrain comprising:
a first rotatable shaft operably coupleable to a source of rotational power, the first rotatable shaft forming a main axis;
a variator assembly having a first traction ring and a second traction ring in contact with a plurality of traction planets, each traction planet having a tiltable axis of rotation, each traction planet supported in a carrier assembly, each traction planet in contact with a sun assembly;
wherein the variator assembly is coaxial with the main axis;
a planetary gearset having a planet carrier, a sun gear, and a ring gear, the planetary gearset coaxial with the main axis;
wherein the second traction ring is operably coupled to the sun gear;
a first motor-generator coaxial with the main axis, the first motor/generator operably coupled to the planet carrier;
a second motor-generator coaxial with the main axis, the second motor-generator coupled to the ring gear;
a first clutch operably coupled to the first rotatable shaft, the first clutch coupled to the first traction ring; and
a brake clutch operably coupled to the carrier assembly.

Aspect 30: The hybrid powertrain of Aspect 29, wherein the brake clutch is configured to selectively couple the carrier assembly to a grounded member.

Aspect 31: The hybrid powertrain of one of Aspect 29 or 30, wherein a first mode of operation corresponds to a disengaged position of the brake clutch.

Aspect 32: The hybrid powertrain of one of Aspects 29-31, wherein a second mode of operation corresponds to an engaged position of the brake clutch.

Aspect 33: A hybrid powertrain comprising:
a first rotatable shaft operably coupleable to a source of rotational power, the first rotatable shaft forming a main axis;
a variator assembly having a first traction ring and a second traction ring in contact with a plurality of traction planets, each traction planet having a tiltable axis of rotation, each traction planet supported in a carrier assembly, each traction planet in contact with a sun assembly;
wherein the variator assembly is coaxial with the main axis;
a planetary gearset having a planet carrier, a sun gear, and a ring gear, the planetary gearset coaxial with the main axis;
wherein the carrier assembly is operably coupled to the sun gear;
a first motor-generator coaxial with the main axis, the first motor/generator operably coupled to the planet carrier;
a second motor-generator coaxial with the main axis, the second motor-generator coupled to the ring gear;
a first clutch operably coupled to the first rotatable shaft, the first clutch coupled to the first traction ring; and
a brake clutch operably coupled to the second traction ring.

Aspect 34: The hybrid powertrain of Aspect 33, wherein the brake clutch is configured to selectively couple the carrier assembly to a grounded member.

Aspect 35: The hybrid powertrain of one of Aspects 33 or 34, wherein a first mode of operation corresponds to a disengaged position of the brake clutch.

Aspect 36: The hybrid powertrain of one of Aspects 33-35, wherein a second mode of operation corresponds to an engaged position of the brake clutch.

Aspect 37: A hybrid powertrain comprising:
a first rotatable shaft operably coupleable to a source of rotational power, the first rotatable shaft forming a main axis;
a variator assembly having a first traction ring and a second traction ring in contact with a plurality of traction planets, each traction planet having a tiltable axis of rotation, each traction planet supported in a carrier assembly, each traction planet in contact with a sun assembly;
wherein the variator assembly is coaxial with the main axis;
a planetary gearset having a planet carrier, a sun gear, and a ring gear, the planetary gearset coaxial with the main axis;
wherein the carrier assembly is operably coupled to the sun gear;
a first motor-generator coaxial with the main axis, the first motor/generator operably coupled to the planet carrier;
a second motor-generator coaxial with the main axis, the second motor-generator coupled to the ring gear;
a first clutch operably coupled to the first rotatable shaft, the first clutch coupled to the first traction ring;
a second clutch operably coupled to the sun gear;
a first brake clutch operably coupled to the second traction ring; and
a second brake clutch operably coupled to the carrier assembly.

Aspect 38: The hybrid powertrain of Aspect 37, wherein the second clutch is configured to selectively engage the second traction ring and the carrier assembly.

Aspect 39: A hybrid powertrain comprising:
a first rotatable shaft operably coupleable to a source of rotational power, the first rotatable shaft forming a main axis;
a variator assembly having a first traction ring and a second traction ring in contact with a plurality of traction planets, each traction planet having a tiltable axis of rotation, each traction planet supported in a carrier assembly, each traction planet in contact with a sun assembly;
wherein the variator assembly is coaxial with the main axis;
a first motor-generator coaxial with the main axis, the first motor/generator operably coupled to the sun assembly;
a second rotatable shaft parallel to the main axis;
a second motor-generator coaxial with the second rotatable shaft, the second motor-generator operably coupled to the second traction ring;
a first clutch operably coupled to the first motor-generator;
a second clutch operably coupled to the second motor-generator;
a final drive gear having a first gear, a second gear, and a third gear;
wherein the first clutch is operably coupled to the first gear, the second clutch is operably coupled to the second gear; and
a brake clutch operably coupled to the carrier assembly.

Aspect 40: A hybrid powertrain comprising:
a first rotatable shaft operably coupleable to a source of rotational power, the first rotatable shaft forming a main axis;
a second rotatable shaft parallel to the main axis;
a variator assembly having a first traction ring and a second traction ring in contact with a plurality of traction planets, each traction planet having a tiltable axis of rotation, each traction planet supported in a carrier assembly, each traction planet in contact with a sun assembly;
wherein the variator assembly is coaxial with the main axis;
a first gear set operably coupled to the first rotatable shaft and the second rotatable shaft;
a second gear set operably coupled to the second traction ring and the second rotatable shaft;
a first motor-generator coaxial with the main axis, the first motor/generator operably coupled to the sun assembly;
a second motor-generator coaxial with the second rotatable shaft, the second motor-generator operably coupled to the second traction ring;
a first clutch operably coupled to the source of rotational power and the first traction ring;
a second clutch operably coupled to the second rotatable shaft, the second clutch arranged between the first gear set and the second gear set;
a third clutch operably coupled to the first motor-generator;
a fourth clutch operably coupled to the second motor-generator;
a final drive gear having a first gear, a second gear, and a third gear;
wherein the third clutch is operably coupled to the first gear, the fourth clutch is operably coupled to the second gear; and
a brake clutch operably coupled to the carrier assembly.

Aspect 41: A hybrid powertrain comprising:
a first rotatable shaft operably coupleable to a source of rotational power, the first rotatable shaft forming a main axis;
a variator assembly having a first traction ring and a second traction ring in contact with a plurality of traction planets, each traction planet having a tiltable axis of rotation, each traction planet supported in a carrier assembly, each traction planet in contact with a sun assembly;
wherein the variator assembly is coaxial with the main axis;
a planetary gear set having a ring gear, a planet carrier, and a sun gear;
wherein the planetary gear set is coaxial with the main axis;
a first motor-generator operably coupled to the planetary gear set;
a second motor-generator operably coupled to the variator;
a first clutch operably coupled to the first rotatable shaft and the planetary gear set; and
a brake operably coupled to the carrier assembly.

Aspect 42: The hybrid powertrain of Aspect 41, further comprising a second clutch operably coupled to the planetary gear set and the first traction ring.

Aspect 43: The hybrid powertrain of Aspect 41, wherein the second motor-generator is operably coupled to the second traction ring.

Aspect 44: They hybrid powertrain of Aspect 43, wherein the first clutch is coupled to the sun gear, the ring gear is coupled to the first traction ring, the first motor-generator is coupled to the planet carrier, and the second motor-generator is operably coupled to the second traction ring.

Aspect 45: The hybrid powertrain of Aspect 42, wherein the first clutch is coupled to the sun gear, the ring gear is coupled to the first traction ring, the first motor-generator is coupled to the planet carrier, and the second motor-generator is operably coupled to the second traction ring.

Aspect 46: The hybrid powertrain of Aspect 42, wherein the first clutch is coupled to the ring gear, the planet carrier is coupled to the second clutch, the first motor-generator is coupled to the sun gear, and the second motor-generator is operably coupled to the second traction ring.

Aspect 47: The hybrid powertrain of Aspect 42, wherein the first clutch is coupled to the planet carrier, the second clutch is coupled to the ring gear, the first motor-generator is coupled to the sun gear, and the second motor-generator is operably coupled to the second traction ring.

Aspect 48: The hybrid powertrain of Aspect 42, wherein the first clutch is coupled to the ring gear, the second clutch is coupled to the sun gear, the first motor-generator is coupled to the planet carrier, and the second motor-generator is operably coupled to the second traction ring.

Aspect 49: The hybrid powertrain of Aspect 42, wherein the first clutch is coupled to the planet carrier, the second clutch is coupled to the sun gear, the first motor-generator is coupled to the ring gear, and the second motor-generator is operably coupled to the second traction ring.

Aspect 50: A hybrid powertrain comprising:
a first rotatable shaft operably coupleable to a source of rotational power, the first rotatable shaft forming a main axis;
a variator assembly having a first traction ring and a second traction ring in contact with a plurality of traction planets, each traction planet having a tiltable axis of rotation, each traction planet supported in a carrier assembly, each traction planet in contact with a sun assembly;
wherein the variator assembly is coaxial with the main axis;
a first motor-generator operably coupled to the variator assembly;
a second motor-generator operably coupled to the second traction ring;
a brake operably coupled to the carrier assembly; and
a final drive assembly operably coupled to the first motor-generator.

Aspect 51: The hybrid powertrain of Aspect 50, wherein the first motor-generator is coupled to the sun assembly.

Aspect 52: The hybrid powertrain of Aspect 51, wherein the second motor-generator is coupled to the carrier assembly.

Aspect 53: A hybrid powertrain comprising:
a first rotatable shaft operably coupleable to a source of rotational power, the first rotatable shaft forming a main axis;
a second rotatable shaft parallel to the first rotatable shaft;
a variator assembly having a first traction ring and a second traction ring in contact with a plurality of traction planets, each traction planet having a tiltable axis of rotation, each traction planet supported in a carrier assembly, each traction planet in contact with a sun assembly;
wherein the variator assembly is coaxial with the main axis;
a first motor-generator coaxial with the second rotatable shaft;
a second motor-generator operably coupled to the sun assembly;
a first gear set operably coupled to the second traction ring and the second rotatable shaft;
a first clutch operably coupled to the first traction ring and the source of rotational power;
a second clutch operably coupled to the second motor-generator assembly; and
a brake operably coupled to the carrier assembly.

Aspect 54: The hybrid powertrain of Aspect 53, further comprising a final drive gear set operably coupled to the second clutch.

Aspect 55: A hybrid powertrain comprising:
a source of rotational power;
a first planetary gear set having a first ring gear, a first planet carrier operably coupled to the source of rotational power, and a first sun gear;
a variator assembly having a first traction ring and a second traction ring in contact with a plurality of traction planets, each traction planet having a tiltable axis of rotation, each traction planet supported in a carrier assembly, each traction planet in contact with a sun assembly;
wherein the first traction ring is operably coupled to the first ring gear;
a first motor-generator operably coupled to the first sun gear;
a second planetary gear set having a second ring gear, a second planet carrier, and a second sun gear operably coupled to the second traction ring;
a second motor-generator operably coupled to the second sun gear;
a first clutch operably coupled to the first sun gear and the second ring gear; and
a second clutch operably coupled to the second ring gear.

Aspect 56: The hybrid powertrain of Aspect 55, further comprising a first step gear arranged to operably couple the first clutch to the first sun gear.

Aspect 57: The hybrid powertrain of Aspect 56, further comprising a second step gear arranged to operably couple the second traction ring to the second sun gear.

Aspect 58: The hybrid powertrain of Aspect 57, wherein the second planet carrier is configured to transmit a power output.

Aspect 59: The hybrid powertrain of Aspect 58, wherein the carrier assembly is selectively grounded.

Aspect 60: A hybrid powertrain comprising:
a source of rotational power;
a first planetary gear set having a first ring gear, a first planet carrier, and a first sun gear;
a variator assembly having a first traction ring and a second traction ring in contact with a plurality of traction planets, each traction planet having a tiltable axis of rotation, each traction planet supported in a carrier assembly, each traction planet in contact with a sun assembly;
wherein the first traction ring is operably coupled to the first ring gear and the source of rotational power;
wherein the second traction ring is operably coupled to the first sun gear;
a first motor-generator operably coupled to the second traction ring;
a second planetary gear set having a second ring gear, a second planet carrier, and a second sun gear operably coupled to the first ring gear;
a second motor-generator operably coupled to the second sun gear;
a first clutch operably coupled to the first sun gear and the second ring gear; and
a second clutch operably coupled to the second ring gear.

Aspect 61: The hybrid powertrain of Aspect 60, wherein the first planet carrier is operably coupled to the second planet carrier.

Aspect 62: A hybrid powertrain comprising:
a source of rotational power;
a first planetary gear set having a first ring gear, a first planet carrier, and a first sun gear;
a variator assembly having a first traction ring and a second traction ring in contact with a plurality of traction planets, each traction planet having a tiltable axis of rotation, each traction planet supported in a carrier assembly, each traction planet in contact with a sun assembly;
wherein the first traction ring is operably coupled to the first sun gear and the source of rotational power;
wherein the second traction ring is operably coupled to the first ring gear;
a first motor-generator operably coupled to the second traction ring;
a second planetary gear set having a second ring gear, a second planet carrier, and a second sun gear operably coupled to the first ring gear;
a second motor-generator operably coupled to the second sun gear;
a first clutch operably coupled to the first sun gear and the second ring gear; and
a second clutch operably coupled to the second ring gear.

Aspect 63: The hybrid powertrain of Aspect 62, wherein the first planet carrier is operably coupled to the second planet carrier.

Aspect 64: A hybrid powertrain comprising:
a source of rotational power;
a first planetary gear set having a first ring gear, a first planet carrier operably coupled to the source of rotational power, and a first sun gear;
a variator assembly having a first traction ring and a second traction ring in contact with a plurality of traction planets, each traction planet having a tiltable axis of rotation, each traction planet supported in a carrier assembly, each traction planet in contact with a sun assembly;
wherein the first traction ring is operably coupled to the first ring gear;
wherein the second traction ring is operably coupled to the first sun gear;
a first motor-generator operably coupled to the first sun gear;
a second planetary gear set having a second ring gear, a second planet carrier, and a second sun gear operably coupled to the first traction ring;
a second motor-generator operably coupled to the second sun gear;
a first clutch operably coupled to the first sun gear and the second ring gear; and
a second clutch operably coupled to the second ring gear.

Aspect 65: The hybrid powertrain of Aspect 64, further comprising a reverse clutch operably coupled to the second sun gear and the sun assembly.

Aspect 66: The hybrid powertrain of Aspect 64, further comprising a reverse clutch operably coupled to the second planet carrier and the sun assembly.

Aspect 67: A hybrid powertrain comprising:
a source of rotational power;
a first planetary gear set having a first ring gear, a first planet carrier operably coupled to the source of rotational power, and a first sun gear;
a variator assembly having a first traction ring and a second traction ring in contact with a plurality of traction planets, each traction planet having a tiltable axis of rotation, each traction planet supported in a carrier assembly, each traction planet in contact with a sun assembly;
wherein the first traction ring is operably coupled to the first ring gear;
wherein the second traction ring is operably coupled to the first sun gear;
a first motor-generator operably coupled to the first sun gear;
a second planetary gear set having a second ring gear, a second planet carrier, and a second sun gear operably coupled to the first traction ring; and
a second motor-generator operably coupled to the second sun gear.

Aspect 68: The hybrid powertrain of one of Aspects 1-67 wherein the variator comprises a traction fluid.

Aspect 69: A vehicle comprising the hybrid powertrain of any of Aspects 1-67.

Aspect 70: A method comprising providing a hybrid powertrain of any of Aspects 1-67.

Aspect 71: A method comprising providing a vehicle of Aspect 69.

1-16. (canceled)

17. A hybrid powertrain comprising:
a first rotatable shaft operably coupleable to a source of rotational power;
a second rotatable shaft coaxial to the first rotatable shaft, the first rotatable shaft and the second rotatable shaft forming a main axis;
a third rotatable shaft parallel to the main axis;
a variator assembly having a first traction ring and a second traction ring in contact with a plurality of traction planets, each traction planet having a tiltable axis of rotation, each traction planet supported in a carrier assembly, each traction planet in contact with a sun assembly, wherein the variator assembly is coaxial with the main axis, wherein the second traction ring is operably coupled to the third rotatable shaft, and wherein the sun assembly is coupled to the second rotatable shaft;
a planetary gearset having a planet carrier, a sun gear, and a ring gear, the planetary gearset coaxial with the third rotatable shaft, the third rotatable shaft coupled to the planet carrier;
a first motor-generator coaxial with the third rotatable shaft, the first motor/generator operably coupled to the sun gear;
a second motor-generator coaxial with the third rotatable shaft, the second motor-generator coupled to the ring gear;
a first clutch operably coupled to the first rotatable shaft, the first clutch coupled to the first traction ring;
a second clutch coaxial with the third rotatable shaft, the second clutch coupled to the first motor-generator; and
a brake clutch operably coupled to the carrier assembly.

18. The hybrid powertrain of claim 17, further comprising a gear set configured to couple the second traction ring to the third rotatable shaft.

19. The hybrid powertrain of claim 17, further comprising a chain configured to couple the second rotatable shaft to the second clutch.

20. The hybrid powertrain of claim 17, further comprising a first inverter in electrical communication with the first motor-generator.

21. The hybrid powertrain of claim 20, further comprising a second inverter in electrical communication with the second motor-generator.

22. The hybrid powertrain of claim 21, further comprising a battery in electrical communication with the first inverter and the second inverter.

23. The hybrid powertrain of claim 17, further comprising a step gear connection configured to couple the second rotatable shaft to the second clutch.

24. The hybrid powertrain of claim 23, wherein the second clutch is configured to selectively engage the sun assembly and the second traction ring.

25. A hybrid powertrain comprising:
a first rotatable shaft operably coupleable to a source of rotational power;
a second rotatable shaft coaxial to the first rotatable shaft, the first rotatable shaft and the second rotatable shaft forming a main axis;
a third rotatable shaft parallel to the main axis;
a variator assembly having a first traction ring and a second traction ring in contact with a plurality of traction planets, each traction planet having a tiltable axis of rotation, each traction planet supported in a carrier assembly, each traction planet in contact with a sun assembly, wherein the variator assembly is coaxial with the main axis, wherein the second traction ring is operably coupled to the third rotatable shaft, and wherein the carrier assembly is coupled to the second rotatable shaft;
a planetary gearset having a planet carrier, a sun gear, and a ring gear, the planetary gearset coaxial with the third rotatable shaft, the third rotatable shaft coupled to the planet carrier;
a first motor-generator coaxial with the third rotatable shaft, the first motor/generator operably coupled to the sun gear;
a second motor-generator coaxial with the third rotatable shaft, the second motor-generator coupled to the ring gear;
a first clutch operably coupled to the first rotatable shaft, the first clutch coupled to the first traction ring;
a second clutch coupled to the third rotatable shaft, the second clutch coupled to the first motor-generator; and
a brake clutch operably coupled to the second rotatable shaft.

26. The hybrid powertrain of claim 25, further comprising a gear set configured to couple the second traction ring to the third rotatable shaft.

27. The hybrid powertrain of claim 25, further comprising a chain connection configured to couple the second rotatable shaft to the second clutch.

28. The hybrid powertrain of claim 25, further comprising a step gear connection configured to couple the second rotatable shaft to the second clutch.

29. The hybrid powertrain of claim 25, further comprising a first inverter in electrical communication with the first motor-generator.

30. The hybrid powertrain of claim 29, further comprising a second inverter in electrical communication with the second motor-generator.

31. The hybrid powertrain of claim 30, further comprising a battery in electrical communication with the first inverter and the second inverter.

32. The hybrid powertrain of claim 25, wherein the second clutch is configured to selectively engage the sun assembly and the second traction ring.

33. A hybrid powertrain comprising:
a source of rotational power;
a first planetary gear set having a first ring gear, a first planet carrier operably coupled to the source of rotational power, and a first sun gear;
a variator assembly having a first traction ring and a second traction ring in contact with a plurality of traction planets, each traction planet having a tiltable axis of rotation, each traction planet supported in a carrier assembly, each traction planet in contact with a sun assembly, wherein the first traction ring is operably coupled to the first ring gear;
a first motor-generator operably coupled to the first sun gear;
a second planetary gear set having a second ring gear, a second planet carrier, and a second sun gear operably coupled to the second traction ring;
a second motor-generator operably coupled to the second sun gear;
a first clutch operably coupled to the first sun gear and the second ring gear; and
a second clutch operably coupled to the second ring gear.

34. The hybrid powertrain of claim 33, further comprising a first step gear arranged to operably couple the first clutch to the first sun gear.

35. The hybrid powertrain of claim 34, further comprising a second step gear arranged to operably couple the second traction ring to the second sun gear.

36. The hybrid powertrain of claim 33, wherein the second planet carrier is configured to transmit a power output.

37. The hybrid powertrain claim 33, wherein the carrier assembly is selectively grounded.
